(19) United States
(12) Patent Application Publication
(10) Pub. No.: US 2024/0253293 A1
(43) Pub. Date: Aug. 1, 2024

(54) CONTINUOUS STRETCH BLOW MOULDING SYSTEM APPLIED TO SPECIFIED INTEGRAL HANDLE PET PREFORM AND CONTAINER STRUCTURES

(71) Applicant: INTEGRATED PLASTICS PTY LIMITED, New South Wales (AU)

(72) Inventor: Nick MELLEN, Villawood (AU)

(21) Appl. No.: 18/552,581

(22) PCT Filed: Mar. 28, 2022
(86) PCT No.: PCT/AU2022/050280

§ 371 Date: Nov. 6, 2023

(30) Foreign Application Priority Data
Mar. 26, 2021 (AU) 2021900907
May 12, 2021 (AU) 2021901404
May 12, 2021 (AU) 2021901405
May 12, 2021 (AU) 2021901414
Nov. 10, 2021 (AU) 2021903599

(51) Int. Cl. B29C 49/42; B29C 49/08; B29L 31/00

(52) U.S. Cl. CPC B29C 49/42101; B29C 49/08; B29C 49/42802; B29C 49/4281; B29L 2031/7158

(57) ABSTRACT

A stretch blow moulding, filling and capping system for containers with integral handles; the containers blown from injection moulded preforms; each preform having the integral handle projecting from a junction point on a body portion of the preform; containers blown in a continuously rotating stretch blow moulding machine of the system transferred automatically to a continuous container filling and capping machine. In a preferred form the preforms are progressed continuously at a substantially constant speed; the containers blown therefrom progress at the same substantially constant speed through to the filling and capping machine; and wherein the containers progress continuously through the filling and capping machine at the same substantially constant speed. Also described is a continuous stretch blow moulding system applied to specified integral handle PET preform and PET blown container structures stretch blown from the preforms.

### TECHNICAL FIELD

The present invention relates to the equipment and method for the production of stretch-blow-moulded PET containers from injection-moulded preforms.

More particularly the present invention relates to a continuous stretch blow moulding system for production of PET containers from PET preforms in a continuous stretch blow moulding process.

More particularly but not exclusively there are disclosed additional processes and improvement processes for the system.

### BACKGROUND

The process of stretch-blow-moulding polymer containers from a prior injection moulded preform is long established in the art. Generally, preforms, as injection moulded, comprise an elongate cylindrical body portion and a neck. In the stretch blow-moulding process, the preform enters a die, held by the neck which retains its injection moulded shape, and the body is firstly mechanically stretched in at least one direction followed by the injection of air to force the polymer material into the desired shape as defined by the die cavity and also stretching the polymer material in at least one other direction—termed biaxial orientation. Where time has elapsed between the injection moulding of the preforms and their entry into the blow moulding process so that the preforms have cooled to ambient temperature, a preheating process is applied before preforms enter the blow mould die. In the latter case, because the handle of the preform should not be affected by the stretch-blow moulding process, the handle must be inserted into a handle cavity of the mould.

The process is considerably more complicated if the preform is rotationally non-symmetric and, as in the present case, is injection moulded with an integrally attached handle, and more particularly if the handle is in the form of a loop, integrally attached at two points on the body of the preform. The complication arises primarily from the need to control the orientation of the handle and to correctly preheat the body of the preform while protecting the handle from excessive heat absorption, as well as the correct insertion of the preform into the stretch-blow-moulding die. In the latter case, because the handle of the preform is not affected by the stretch blow-moulding process, the handle must be inserted into the mould to nest into a handle cavity of the mould.

Such a preform and systems for its transformation into a container with integral handle are disclosed in WO2007101309. The entire disclosure of WO2007101309 is incorporated herein by cross reference. In that disclosure, preforms enter a production machine such as schematically shown in FIGS. 55 and 72 of that document after orientation of the handle, which orientation is then maintained, through the preheating stage and into the stretch-blow-moulding die.

In the systems disclosed in WO2007101309 however, the process of production is discontinuous or ‘batch’; that is, the production machines progress preforms incrementally, pausing at each index to allow for pick and place loading of preforms, their insertion into a supporting mandrel and the entry into and exit from the stretch blow-moulding cavities, while the preforms are stopped for each moulding cycle. A disadvantage of this incremental processing is that it is clearly less efficient than a continuous process.

The present invention relates to a machine and process for the stretch blow moulding of preforms with an integral handle in a continuous feed, thus non-incrementing system. Because of the several stages in the process, the requirements of establishing handle orientation, the preheating stage and the stretch-blow-moulding stage as well as the removal of finished containers, requires the transfer of preforms between rotating in-feed, preheating, moulding and transport elements of the system. A continuous process makes these processes and transfers for a preform with integral handle, considerably more complex.

A system for handling a non-rotationally symmetric preform requiring a known orientation for selective preheating and prior to loading into a stretch-blow-moulding die was disclosed in U.S. Pat. No. 8,632,333 B2. In the arrangement of this patent, orientation is established with reference to a small reference tab or notch, but this preform not having a handle there is no need for orientation relative a heat shield.

US 2012/0048683 also discloses a continuously rotating blow moulding system in which special precautions are taken against deformation of preforms due to centrifugal forces by specific orientation of the preforms passing through the system. Although it is noted that such orientation may be of benefit for non-symmetric preforms, for example those with a handle, there is no disclosure of orientation of a preform for entry into a handle heat shield.

U.S. Pat. No. 6,779,651 specifically teaches the importance of orientation of preforms with handles prior to introduction of the preform into the stretch-blow-moulding die. There is however no suggestion that the handle requires shielding by means of a heat shield so that there is no arrangement in this patent of the control of orientation to marry the handle with a heat shield.

A suite of patents and applications to Thibodeau, U.S. D746,142 S; U.S. Pat. No. 8,524,143 B2; U.S. Pat. No. 9,499,302 B2 and WO2015/112440 A1 are drawn to the production of containers with integral handle container stretch-blow-moulded from injection moulded preforms with integral handles. However, in contrast with the arrangement of the present application as set out below, the handle of a container according to Thibodeau is of radically different shape to the handle as injection moulded with the preform, being subjected to a sort of uncurling during the stretch-blow-moulding phase.

Another continuously rotating blow-moulding system is disclosed in U.S. Pat. No. 5,683,729 in which mechanisms for the transfer of preforms between various stages of the system are described. There is however no disclosure of preforms with integral handles and thus no treatment of special orientation of the preforms.

International Patent Application PCT/AU2018/051285 to the present applicant discloses a continuous stretch blow moulding system for integral handle PET containers.

In order to render the process described in that application it would be advantageous if the process described therein could be improved to require more economical use of plastic, to permit high throughput notwithstanding distortion that may occur during the reheating of the preforms and efficient accommodation of downstream processes.

In a production arrangement in which containers are stretch blow moulded and then stored for later filling and capping, or where there is at least a considerable time delay prior to feeding the containers into a filling and capping machine, there is a risk of contamination since the containers are inevitably open.

It is an object of the present invention to address or at least ameliorate some of the above disadvantages.

### Notes

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### Definitions

Continuous preform feed: In this specification, continuous preform feed occurs where preforms are advanced at constant velocity from an entry location to an exit location along a path. This is to be distinguished from a batch mode operation where the preform feed advances and then stops whilst a blow mould operation takes place.

Non-symmetric preform: In this specification, a non-symmetric preform is a preform which is not symmetric about its longitudinal axis. The primary source of non-symmetry occurs where the preform incorporates an integral handle. In certain embodiments the preform walls are also a source of non-symmetry.

Integral handle preform: In this specification, an integral handle preform is a non-symmetric preform which has a handle portion extending from a body of the preform and wherein the handle is integrally moulded with the body of the preform.

Stretch blow moulding die: In this specification, a stretch blow moulding die comprises an openable cavity adapted to receive a preheated preform for subsequent stretch blow moulding of the preheated preform within the cavity of the die.

### SUMMARY OF INVENTION

Blow and Fill System for Containers with Integral Handles

Accordingly in one broad form of the invention there is provided a stretch blow moulding, filling and capping system for containers with integral handles; the containers blown from injection moulded preforms; each preform having the integral handle projecting from a junction point on a body portion of the preform; containers blown in a continuously rotating stretch blow moulding machine of the system transferred automatically to a continuous container filling and capping machine. Preferably the preforms are progressed continuously at a substantially constant speed; the containers blown therefrom progress at the same substantially constant speed through to the filling and capping machine; and wherein the containers progress continuously through the filling and capping machine at the same substantially constant speed.

Preferably a known orientation of the handle is established at an orientation mechanism prior to preforms entering the continuously rotating stretch blow moulding machine; the known orientation of the preform and the container blown from the preform controlled through all stages of the preform and the blown container passing through the stretch blow moulding machine.

Preferably the known orientation of the blown container is controlled during transfer of the blown container from the continuously rotating stretch blow moulding machine and through the automatic container filling and capping machine.

Preferably the stretch blow moulding machine and the container filling and capping machine are arranged so that a discharge channel of the stretch blow moulding machine is in line with and at the same level as an infeed conveyor of the container filling and capping machine.

Preferably the cycle time of the container filling and capping machine is synchronized with the cycle time of the stretch blow moulding machine.

Preferably an escapement mechanism disposed along the infeed conveyor of the container filling and capping machine ensures spacing of containers conforms to spacing of filling nozzles and capping mechanisms of the container filling and capping machine.

Preferably a walking beam container transport system of the container filling and capping machine overlaps a discharge channel of the stretch blow moulding machine; a first nest of the walking beam transport system capturing each successive leading container from the discharge channel.

Preferably an industrial robot is positioned between a discharge channel of the stretch blow moulding machine and an infeed conveyor of the container filling and capping machine; the robot taking successive leading blown containers from an end of a discharge channel of the stretch blow moulding machine for placement on the infeed conveyor; placement by the robot ensuring spacing of the blown container and orientation of the handle adapted for movement of the container through the container filling and capping machine.

Preferably preforms are in continuous motion from an initial preform pick off point through stretch blow moulding and ejection from stretch blow moulding dies as stretch blow moulded containers with integral handle.

Preferably the integral handle retains a shape of the handle as injection moulded through all stages of the stretch blow moulding machine and through the filling and capping machine.

Accordingly in a further broad form of the invention there is provided a continuous process from injection moulded preforms with integral handles to filled and capped containers with integral handles in which an orientation of the integral handle of the preform is controlled from entry into a stretch blow moulding machine; the orientation of the handle controlled throughout the processes of preform preparation, stretch blow moulding of the containers from the preforms and filling and capping of the blown containers.

Preferably back pressure of blown containers at a discharge channel of the stretch blow moulding machine forces successive blown containers onto an infeed conveyor of a filling and capping machine.

Preferably a walking beam transport system of a filling and capping machine overlaps a discharge channel of the stretch blow moulding machine; an end nest of the walking beam transport system capturing successive leading blown containers from the discharge channel for transport through the filling and capping machine.

Preferably a robot positioned in and intermediate area between the stretch blow moulding machine and an automatic filling and capping machine picks successive leading blown containers from a discharge channel of the stretch blow moulding machine for placement on an infeed conveyor of the filling and capping machine.

Accordingly in a further broad form of the invention there is provided a continuous transfer system wherein containers stretch blow moulded from injection moulded preforms with integral handles in a continuously rotating stretch blow moulding machine are fed to a filling and capping machine; an orientation of the integral handle controlled from entry of a preform into the stretch blow moulding machine to the emergence of filled and capped containers from the filling and capping machine.

Preferably a discharge channel for blown containers of the stretch blow moulding machine is in line with and at a same level as an infeed conveyor of the filling and capping machine.

Preferably back pressure of blown containers in the discharge channel forces successive leading blown containers onto the infeed conveyor of the filling and capping machine.

Preferably a walking beam transport system of the filling and capping machine overlaps a discharge channel of the stretch blow moulding machine; an end nest of the walking beam transport system capturing successive leading blown containers from the discharge channel for transport through the filling and capping machine.

Preferably a robot is positioned in and intermediate area between the stretch blow moulding machine and an automatic filling and capping machine picks successive leading blown containers from a discharge channel of the stretch blow moulding machine for placement on an infeed conveyor of the filling and capping machine.

Accordingly in a further broad form of the invention there is provided a continuous transfer system for containers with integral handles stretch blow-moulded from injection moulded preforms with integral handles; the transfer system transferring the containers with a known orientation of the integral handle from a continuously rotating stretch blow-moulding machine to an automatic continuously filling and capping machine; a re-orientation device intermediate a discharge channel of the stretch blow-moulding machine and the automatic continuously filling and capping machine adapted to optionally reorient the containers from the known orientation to another desired orientation prior to entry into the automatic continuously filling and capping machine.

### Single Connect Integral Handle of Pet Container and Method of Production

Accordingly in a further broad form of the invention there is provided an integral handle of a stretch blow-moulded container and injection moulded preform; the integral handle respectively connected at a single connection region on a body portion of the preform and at a single connection region of a body of the container, wherein the wall thickness of the body portion of the preform and of the container in a region extending below the handle connection region on the body of the container is substantially equal to thickness of adjoining wall regions.

Preferably the handle extends from the single region on the preform and on the container proximate a neck portion common to both the preform and the container.

Preferably the handle includes an upper arcuate portion extending from the single connection region; the arcuate upper portion transitioning into a substantially straight, downwardly projecting portion.

Preferably the handle includes a central web lying in a central plane passing through a centre line of the body portion of the preform and a plane bisecting the body portion of the container.

Preferably the central web is bounded by an edge; the edge extending continuously around a periphery of the web from an upper junction point to a lower junction point on both the preform body portion and on the body of the container.

Preferably a rib normal to the web extends along the edge; the rib projecting outwardly and symmetrically from both sides of the plane; the rib and central web forming an I-beam like cross section.

Preferably the upper and lower connection cross sections of the rib meld with surfaces of both the preform body portion and the body of the container.

Preferably inward facing sections of both the web and the rib is provided with one or more scalloped configurations; the scalloped configurations aiding in gripping the handle in use.

Preferably a thumb support is provided projecting from an upper portion of the rib.

Accordingly in a further broad form of the invention there is provided a method of reducing volume of PET polymer in a container stretch blow-moulded from an injection moulded preform with an integral handle; the handle formed as a loop extending between first and second connection points on the body of the preform; the method including the steps of:
changing the integral handle of the preform from the integral handle formed as a loop to a single connect handle extending from a single connection region on the body portion of the preform,
reducing wall thickness of the body portion of the preform in a region below the connection region of the single connect handle from a reinforced thickened wall to a thickness equal to wall thickness of adjoining regions of the preform.

Preferably the handle extends from the single connection region on the preform and on the container proximate a neck portion common to both the preform and the container.

Preferably the handle includes an upper arcuate portion extending from the single region; the arcuate upper portion transitioning into a substantially straight, downwardly projecting portion.

Preferably the handle includes a central web lying in a plane passing through a centre line of the body portion of the preform and a plane bisecting the body portion of the container.

Preferably the central web is bounded by an edge; the edge extending continuously around a periphery of the web from an upper junction point to a lower junction point on both the preform body portion and on the body of the container.

Preferably a rib normal to the edge extends along the edge; the rib projecting outwardly and symmetrically from both sides of the web; the rib and central web forming an I-beam like cross section.

Accordingly in a further broad form of the invention there is provided a single connect handle of a stretch blow-moulded container; the container stretch blow-moulded from an injection moulded preform; the preform including an integral handle connected at a single connection region of the preform; the handle extending outward from, and generally parallel, for a section of a body portion of the preform and, wherein wall thickness of the preform in the section of the body portion is equal to wall thickness of adjacent regions of the preform.

Accordingly in a further broad form of the invention there is provided an injection moulded preform with integral handle for stretch blow-moulding a container with an integral handle; the preform having a cylindrical body portion extending from below a neck of the preform and a curved closure at a base of the body portion; walls of the cylindrical body portion of the preform being of constant thickness.

Preferably the integral handle is connected to the preform at a single connection region; the handle extending outwardly and generally parallel for a section of the body portion of the preform.

### Preform Distortion Control and Method

Accordingly in a further broad form of the invention there is provided a method of
determining the form of a cavity in a stretch blow-moulding die for accommodating an integrally connected handle connected to a body portion of the preform; the method including the steps of:
designing the preform with the integrally connected handle injection moulding the preform,
passing the preform through a preform conditioning stage under controlled parameters,
noting distortion of the handle from the design resulting from heating during the preform preconditioning stage,
repeating trial conditioning stages until a stable acceptable degree of distortion is established under recorded parameters,
forming the handle cavity in the stretch blow-moulding die according to the established distortion.

Preferably the preform comprises a neck and a cylindrical body portion extending below the neck; the cylindrical body portion ending in a curved closure.

Preferably the integrally connected handle forms a loop of material extending from a first upper connection point on a body portion of the preform to a second lower connection point on the body portion of the preform.

Preferably the integrally connected handle extends from a single connection region on the body portion of the preform.

Preferably parameters of a preheating stage of a stretch blow-moulding machines are adjusted to introduce a minimum range of distortion of the integrally connected handle.

Preferably the design of the integrally connected handle and cavities in the injection moulding die are adjusted so that the minimum range of distortion restores the handle to approximately an original desired design configuration of the integrally connected handle.

Preferably heat shields of a preheating stage of a stretch blow-moulding machine are designed to accommodate a maximum distortion within the minimum range.

Preferably stretch blow-moulding cavities of stretch blow-moulding dies are prepared according to designs for stretch blown-moulded containers; pockets in the cavities for accommodating the integrally connected handle formed according to a median of the range of distortion.

Preferably the pockets are provided with angled lead-in surfaces; outer edges of the lead-in surfaces define a maximum distortion of the range of distortions sufficient to receive a maximum distortion of the integrally connected handles.

Accordingly in a further broad form of the invention there is provided a method of controlling configuration of an integrally connected handle of a container stretch blow-moulded from an injection moulded preform with the integrally connected handle; the method including the steps of:
determining a minimum range of distortions of the integrally connected handle caused by passing the preform through a preheating stage of a stretch blow-moulding machine,
providing angled lead-in surfaces around pockets for accommodating the integrally connected handle within cavities of stretch blow-moulding dies of a stretch blow-moulding machine.

Preferably the minimum range of distortions is determined by repeated trials of the preheating stage under controlled parameter conditions.

Preferably outer edges of the angled lead-in surfaces define an area at least coextensive with a maximum distortion of the minimum range of distortions.

Accordingly in a further broad form of the invention there is provided opposing cavities in halves of a stretch blow-moulding die of a stretch blow-moulding machine; each cavity including a pocket for accommodating an integrally connected handle of a preform inserted into the die; the pocket provided with elements adapted to constrain a distorted integrally connected handle into a desired handle configuration.

Preferably the integrally connected handle of the preform comprises a loop of material extending from a first, upper connection region to a second, lower connection region on a cylindrical body portion of the preform.

Preferably the integrally connected handle of the preform comprises a web bounded by a rib extending along an outer edge of the web; the handle extending from a single connection region on the cylindrical body portion of the preform.

Preferably distortion of the integrally connected handle is caused by application of heat during a preform conditioning stage in the stretch blow-moulding machine.

Preferably a minimum range of distortions is established by repeated conditioning test runs of the conditioning stage under controlled parameters.

Preferably the elements adapted to constrain distorted integrally connected handles comprise angled lead-in surfaces around a perimeter of the pocket.

Preferably outer edges of the angled lead-in surfaces define an area at least coextensive with a maximum distortion of the minimum range of distortions.

### Differential Wall Thickness System

Accordingly in a further broad form of the invention there is provided a PET container stretch blow-moulded from a preform; the preform and the container having a neck portion and a body portion to which is integrally connected a PET handle; the PET handle comprising an elongate portion of PET material integrally connected at least at a first connection point on a body portion of the preform and on the container and wherein perform wall thickness is controlled so that the wall thickness of corresponding locations on the blown container 1428 is such that the wall thickness 1421B in the region of the container 1420B located beneath the handle 1426 and on the side of the container closest to the handle 1426 may be differentiated from the wall thickness 1441B in a region 1440B located on an opposite side of the container 1428 from the region 1420B.

Preferably the handle and the narrow strip form a substantially planar region thereby to maintain the integral connection between the handle and the blown container.

Preferably the elongate portion of PET material comprises a stem.

Preferably the PET handle is connected at a second connection point to the container.

Preferably the first connection point is an upper connection point.

Preferably the second connection point is a lower connection point.

Preferably the preform has an expandable portion located below the neck portion.

Preferably the region of the preform body defined by the strip between the two attachment points remains substantially stable during the stretching and blowing of the container.

Preferably both the regions of the outer and inner surface layers laterally away from the narrow trip are subjected to biaxial stretching.

Preferably the outer surface of the narrow strip remains substantially stable but the wall of the container at the strip and the inner layers between the handle attachment points undergo a degree of flow and thinning together with surrounding regions as the PET material comes under the influence of stretching and blowing forces.

Preferably the PET handle is formed in the same mould as and at the same time as the preform is moulded.

Preferably loading of plastics material in the region of the wall subtended between the first location and the second location is differentially controlled as a function of location on the circumference of the wall in this region; the region designated the differential loading region.

Preferably there is an increased loading of material in the region immediately between the first location and the second location points whilst, an opposite region located diametrically opposite the differential loading region is reduced in material thickness.

Preferably differential material loading as a function of circumferential position on walls of the preform aids in providing control over the wall thickness of the blown container.

Preferably the stretch blow molding process is a two stage stretch blow molding process.

Preferably the differential loading region subtended between the first location and the second location remains substantially unchanged during the blowing process.

Preferably the differential loading region is an extension of and part of the neck portion of the preform.

Preferably the preform includes a symmetrical thickening of the wall of the preform in the lower region of the body portion which extends from immediately below the point of connection of the lower end of handle.

Preferably at a second, intermediate region located between the first connection point and the second connection point of handle, the wall thickening of the preform tapers gradually from a first thickness to a second thinner thickness.

Preferably the thickening is symmetrical about the longitudinal axis of the preform.

Preferably the thickening results in a controllable increase in the thickness of material in the blown container in the intermediate region, and in a sub-region immediately below the second connection point of the lower end of handle.

### Bifurcated Strengthening System

Accordingly in a further broad form of the invention there is provided a method of controlling a preform for stretch blow-moulding a container with an integrally formed handle; the preform comprising a body portion and the integrally formed handle; the preform transferred from a perform supply source to a blow moulding die for blowing the container; the method including the steps of
passing the preform through a preform handle orientating apparatus,
transferring the preform to a preform transportation system,
maintaining orientation of the preform handle imposed by the perform handle orientating apparatus during transfer to the perform transportation system and transfer to the blow moulding die,
rotating the preforms during transport along the transportation system past an array of preform heating elements while shielding the integrally formed handle from excessive exposure to the heating elements,
transferring the preform from the transportation system to the blow moulding die, and
wherein the handle comprises orientable plastic material extending from at least an upper connection region on the body portion of the preform; characterised in that the handle includes a curved strengthening element at a lower end of the handle; the orientable plastic material bifurcating to form an enclosed generally triangular element.

Preferably the handle extends from the upper connection region to a lower connection region on the body portion of the preform.

Preferably the curved strengthening element abuts the body portion of the preform and the body of the blow moulded container.

Preferably the curved strengthening element conforms generally in width and cross section to width and cross section of the handle.

Preferably the handle has a gradually widening cross section approaching the upper connection region; the cross section reaching and maintaining a maximum width proximate the upper connection region cross section of the handle.

Preferably the cross section extends from opposing outer edges towards a central line; the cross section increasing in thickness progressively from the outer edges to a maximum thickness at the central line.

Preferably the handle includes a straight section angling downwardly from a lower connection region and an arcuate section extending from an end of the straight section to the upper connection region.

Preferably integrally moulded first, second and third strengthening elements are provided respectively at each of the upper connection region and the lower connection region and at the junction between the straight section and the arcuate section.

Preferably the first strengthening element at the upper connection region comprises a first curved element conforming in width and in cross section to the width and cross section of the handle proximate the upper connection region; the first curved element extending from a first separate connection region below the upper connection region to merge with the handle proximate to a first end of the maximum width of the handle.

Preferably the second strengthening element at the lower connection region comprises a straight element conforming in width and cross section with the width and cross section of the straight section of the handle; the straight element extending from a second separate connection region above the lower connection region to a merge with the straight section of the handle proximate the lower connection region.

Preferably the third strengthening element at the junction of the straight and arcuate sections of the handle comprises a further curved element conforming in width and cross section with the width and cross section of the handle adjacent the junction of the straight and arcuate sections of the handle; respective outer ends of the curved element merging with the straight and arcuate sections of the handle.

Preferably each strengthening element includes a web of orientable plastic material within boundaries formed respectively between the body of the preform and the first and second strengthening elements, and between the third strengthening element and the straight and arcuate sections; each web of orientable plastic material aligned with and extending equally in both directions from the central line.

Accordingly in a further broad form of the invention there is provided a method of reducing strain on a supporting finger of a hand lifting a blow-moulded container; the container provided with an integral handle; the method including:
stretch blow-moulding the container from a preform which includes an orientable plastic material forming the handle; the orientable plastic material extending from at least an upper connection region, and
wherein the handle includes a curved strengthening element at a lower end of the handle; the orientable plastic material bifurcating to form an enclosed generally triangular element.

Preferably the handle extends from the upper connection region to a lower connection region on the body portion of the preform.

Preferably the curved strengthening element abuts the body portion of the preform and the body of the blow moulded container.

Preferably the curved strengthening element conforms generally in width and cross section to width and cross section of the handle.

Preferably a strengthening element proximate the upper connection region; the strengthening element comprises a first curved element conforming generally in width and in cross section to a width and cross section of the handle proximate the upper connection region; the first curved element extending from a first separate connection region below the upper connection region to merge with the handle proximate to a first end of a maximum width of the handle.

Accordingly in a further broad form of the invention there is provided a handle of a stretch blow moulded container; the container blown from a preform including the handle extending from at least an upper connection region; the handle including a curved strengthening element at a lower end of the handle; the curved strengthening element conforming generally in width and cross section to width and cross section of the handle; the orientable plastic material bifurcating to form an enclosed generally triangular element.

Preferably the handle extends from the upper connection region to a lower connection region on the body portion of the preform.

Preferably the curved strengthening element abuts the body portion of the preform and the body of the blow moulded container.

Preferably the curved strengthening element conforms generally in width and cross section to width and cross section of the handle.

Preferably the handle further includes a straight lower section and an arcuate section extending from an end of the straight lower section to the upper connection region; the handle having a gradually widening cross section approaching the upper connection region; the cross section reaching and maintaining a maximum width proximate the upper connection region.

Accordingly in a further broad form of the invention there is provided a blown container formed according to any of the above methods.

Accordingly in a further broad form of the invention there is provided a blown container incorporating the handle as described above.

Accordingly in a further broad form of the invention there is provided a preform having a handle: the preform being formed in a first production step of a stretch blow moulded container; the container blown from the preform including the handle extending from at least an upper connection region; the handle including a straight lower section and includes a curved strengthening element at a lower end of the handle; the orientable plastic material bifurcating to form an enclosed generally triangular element.

Preferably the handle extends from the upper connection region to a lower connection region on the body portion of the preform.

Preferably the curved strengthening element abuts the body portion of the preform and the body of the blow moulded container.

Preferably the curved strengthening element conforms generally in width and cross section to width and cross section of the handle.

### ****************

### Continuous Stretch Blow Moulding System Applied to Specified Integral Handle Pet Preform and Container Structures

In preferred forms, all of the above cavities, systems, preforms, processes, containers, handles, features and methods are effected in a continuously rotating, non-symmetric preform feed, stretch-blow-moulding machine dedicated to the stretch-blow-moulding of containers from non-symmetric injection moulded preforms; the non-symmetric preforms including an integral handle extending from a junction point on a body of the preform; the body of the preform and the integral handle constituted from the same material.

Additional features of the machine in preferred forms are outlined immediately below:

Accordingly, in one broad form of the continuously rotating, non-symmetric preform feed, stretch-blow-moulding machine there is provided a continuously rotating, non-symmetric preform feed, stretch-blow-moulding machine dedicated to the stretch-blow-moulding of containers from non-symmetric injection moulded preforms; the non-symmetric preforms including an integral handle extending from a junction point on a body of the preform; the body of the preform and the integral handle constituted from the same material.

In a further broad form of the continuously rotating, non-symmetric preform feed, stretch-blow-moulding machine there is provided a method of controlling paths of grippers of pick and place apparatuses of rotating transfer systems; the rotating transfer systems operating in a continuous non-symmetric preform feed stretch-blow-moulding machine; the paths of the grippers following respective loci of non-symmetrical preforms as preforms are transferred by the rotating transfer systems from a preform pick off position, inserted into and extracted from a preform support mandrel of a preheating stage and inserted into and extracted as a stretch-blow-moulded containers from rotating stretch-blow-moulding dies; the non-symmetrical preforms comprising a body portion and an integral handle extending from the body portion; the method including the step of rotationally mounting each of the pick and place apparatuses on a rotating arm of a respective rotating transfer system.

In a further broad form of the continuously rotating, non-symmetric preform feed, stretch-blow-moulding machine there is provided a method of transferring a non-symmetric preform between stages of a continuous non-symmetric preform feed rotating stretch-blow-moulding machine; the non-symmetric preform being transformed into a stretch-blow-moulded container by a step of stretching and blowing the non-symmetric preform in a cavity of the stretch-blow-moulding die; the method including the step of orienting the non-symmetrical preform so that an integral handle of the preform has a known orientation at arrival at a pick off position in the machine.

In a further broad form of the continuously rotating, non-symmetric preform feed, stretch-blow-moulding machine there is provided a method of manipulating a non-symmetrical injection moulded preform into a stretch-blow-moulding die of a continuous preform feed stretch-blow-moulding machine; the method including the step of extracting a preform from a preform preheating stage with a pick and place apparatus of a continuously rotating transfer system such that an integral handle of the preform has a predetermined orientation.

In a further broad form of the continuously rotating, non-symmetric preform feed, stretch-blow-moulding machine there is provided a method of controllably heating a pre-form to a die introduction temperature; the pre-form having a neck portion extending from a body portion; said pre-form further having a handle portion extending radially; said method comprising controllably transferring an integral handle PET pre-form onto a continuously moving conveyor; securing the preform by its neck portion to the conveyor whereby the preform is transported by the conveyor at substantially constant velocity along a reheating path from a pre-form entry location to a pre-form exit location.

Preferably at least portions of the pre-form controllably heated to the die introduction temperature by the time it reaches the pre-form exit location.

Preferably a controllable heater array distributed along the path arranged to direct heat to selected portions of the pre-form.

Preferably the pre-form controllably transferred from the preform exit location into a die for stretch blow moulding of the pre-form thereby to form a blown container.

In a further broad form of the continuously rotating, non-symmetric preform feed, stretch-blow-moulding machine there is provided a method of orienting a non-symmetrical preform for entry to stages of a stretch blow-moulding machine; the none symmetrical preform including an integral handle extending from a first junction point below a neck of the preform to a second junction point on the body of the preform; the method including the step of providing preforms to slide down inclined rails towards an orientation mechanism while supported by the necks of the preforms along upper rails of the inclined rails.

In a further broad form of the continuously rotating, non-symmetric preform feed, stretch-blow-moulding machine there is provided a continuously rotating, non-symmetric preform feed, stretch-blow-moulding machine in which injection-moulded preforms with integral handles are transferred from a first transfer system to a preheating stage; the transfer of a preform from a gripper of the first transfer system to a preform supporting mandrel achieved in one fluid motion as a vertical axis of the preform is brought into alignment with a vertical axis of the preform supporting mandrel and the handle of the preform is slid into a heat shield provided on the mandrel.

Accordingly in further broad form of the continuously rotating, non-symmetric preform feed, stretch-blow-moulding machine there is provided a continuous non-symmetric preform feed stretch-blow-moulding machine dedicated to the stretch-blow-moulding of containers from non-symmetric injection moulded preforms; the non-symmetrical preforms including an integral handle extending from a first junction point to a second junction point on a body of the preform; the body of the preform and the integral handle constituted from the same material; the machine including a preform orientation system to orient the handle of the preform into a known orientation at arrival at a pick off position.

Preferably the preforms are in continuous motion from an initial preform pick off point through stretch-blow-moulding into the containers and ejection from the machine as stretch-blow-moulded containers.

Preferably the integral handle retains a shape of the handle as injection moulded through all stages of the stretch-blow-moulding machine to forming a handle on the stretch-blow-moulded container.

Preferably the stages of the stretch-blow-moulding machine include a handle orientation stage; all preforms arriving at the pick off point having the integral handle oriented in a predetermined direction relative to motion of the preform approaching the pick off position.

Preferably the stages of the stretch-blow-moulding machine include a continuously rotating first transfer system transferring preforms from a continuously rotating preform feeder wheel at the preform pick off position to a transfer to preheating position at a continuously rotating preheating stage.

Preferably a first pick and place apparatus of the first transfer system includes a preform grasping gripper; reciprocating rotation and linear displacement of the grasping gripper induced by a combination of a rotating carrier of the pick and place apparatus and two cam loci.

Preferably the rotating carrier is an arm of four radially extending support arms rotating about a common centre of rotation; an outer end of each support arm rotationally supporting a pick and place apparatus.

Preferably the support arms rotate above a fixed cam plate; the cam plate provided with an inboard cam channel for a first locus of the two cam loci and a periphery of the cam plate providing an outer cam surface for a second locus of the two cam loci.

Preferably a housing of a linear guide of the pick and place apparatus is rotationally mounted at the outer end of the supporting arm; an outrigger arm extending from the housing provided with a first cam follower locating in the cam channel.

Preferably a free sliding element of the linear guide is provided with a second cam follower; the second cam follower maintained in contact with the outer cam surface by a spring.

Preferably the grasping gripper of the pick and place apparatus is mounted to a rotary actuator supported from an outer end of the free sliding element; the rotary actuator adapted to rotate fingers of the grasping gripper 180 degrees as a pick and place apparatus transits between the preform pick off position and the transfer to preheating position.

Preferably the continuously rotating preheating stage includes a preform transport system; preform supporting mandrels travelling along a loop rail system; the preform supporting mandrels rotating preforms about a vertical axis of the preforms as preforms travel past banks of heating elements.

Preferably the preform supporting mandrels are provided with a heat shield; the heat shield comprising a channel projecting from a cylindrical collar.

Preferably the pick and place apparatus of the first transfer system brings a vertical axis of a perform into alignment with a vertical axis of the cylindrical collar of a preform supporting mandrel at the transfer to preheating position; the gripper of the pick and place apparatus concurrently manoeuvring the handle of the preform between side elements of the channel of the mandrel.

Preferably the preform is lowered after the neck of the preform is released by the gripper of the pick and place apparatus so that the neck of the preform is located within the cylindrical collar of the mandrel.

Preferably a preheated preform is extracted from a supporting mandrel by a pick and place apparatus of a second transfer system at a transfer from supporting mandrel position; the transfer from supporting mandrel position lying on a line joining respective centres of rotation of a proximate rotating guide wheel of the preheating transport system and the second transfer system.

Preferably the preform extracted from a preform supporting handle by a gripper of the pick and place apparatus of the second transfer system is rotated through 180 degrees by a rotary actuator of the pick and place apparatus as an arm of the second transfer system rotates the pick and place apparatus towards a die loading position.

Preferably a combination of rotation of the arm of the second transfer system and rotation and linear displacement of the gripper induced by the loci of a first and second cam follower of the pick and place apparatus, brings a vertical axis of the preform into alignment with a vertical axis of a stretch-blow-moulding die as both the pick and place apparatus and an opened stretch-blow-moulding die approach the die loading position; movements of the gripper concurrently bringing the handle of the preform into alignment with a line joining respective centres of rotation of the stretch-blow-moulding die and the second transfer system; the handle then brought into coincidence with a handle recess of the stretch blow-moulding die.

Preferably a pick and place apparatus of a third transfer system extracts a stretch-blow-moulded container from the stretch-blow-moulding die as the stretch-blow-moulding die opens at a die unloading position; the die unloading position lying on a line joining respective centres of rotation of the rotating stretch-blow-moulding die and the third transfer system.

Preferably the extracted stretch-blow-moulded containers are rotated from the die unloading position to a rotating outfeed wheel; the rotating outfeed wheel transferring the containers along a discharge channel and a container receiving conveyor.

In yet a further broad form of the machine there is provided a pick and place apparatus manipulating a non-symmetrical preform; the pick and place apparatus operating in a continuously rotating stretch-blow-moulding machine wherein a preform gripping gripper of the pick and place apparatus is urged into reciprocating rotation and linear displacement by a combination of a rotating support of the pick and place apparatus and two cam loci.

Preferably the reciprocating rotation is about a vertical axis; linear displacement being in a horizontal plane.

In yet a further broad form of the machine there is provided a method of controlling paths of grippers of pick and place apparatuses of rotating transfer systems; the rotating transfer systems operating in a continuous non-symmetric preform feed stretch-blow-moulding machine; the paths of the grippers following respective loci of non-symmetrical preforms as preforms are transferred by the rotating transfer systems from a preform pick off position, inserted into and extracted from a preform support mandrel of a preheating stage and inserted into and extracted as a stretch-blow-moulded containers from rotating stretch-blow-moulding dies; the non-symmetrical preforms comprising a body portion and an integral handle extending from the body portion; the method including the steps of:
rotationally mounting each of the pick and place apparatuses on a rotating arm of a respective rotating transfer system,
urging reciprocating rotation of the grippers about respective vertical axes of the pick and place apparatuses controlled by a locus of a first cam follower and the rotation of the rotation of the rotating arm,
urging reciprocating horizontal linear displacement controlled by a locus of a second cam follower and the rotation of the rotating arm, and,
wherein the locus of the first cam follower is determined by a cam channel of a cam plate; the locus of the second cam follower being determined by an outer cam surface of the cam plate.

Preferably a first rotating transfer system transfers a non-symmetrical preform from a rotating preform feeder wheel to a rotating preform support mandrel of the preform preheating system.

Preferably a second rotating transfer system transfers a non-symmetrical preform from a rotating perform support mandrel into a stretch-blow-moulding die.

Preferably a third rotating transfer system extracts stretch-blow-moulded containers from the stretch-blow-moulding die to a rotating outfeed wheel; the rotating outfeed reel depositing containers in a known orientation on an outfeed conveyor.

In yet a further broad form of the machine there is provided a method of transferring a non-symmetric preform between stages of a continuous non-symmetric preform feed rotating stretch-blow-moulding machine; the non-symmetric preform being transformed into a stretch-blow-moulded container by a step of stretching and blowing the non-symmetric preform in a cavity of the stretch-blow-moulding die; the method including the steps of:
orienting the non-symmetrical preform so that an integral handle of the preform has a known orientation at arrival at a pick off position in the machine,
gripping a neck of the preform in grippers of a pick and place apparatus of a rotating first rotating transfer system and rotating the preform to a preheating stage of the machine,
manoeuvring the gripper of the first pick and place apparatus so as to align the integral handle with a heat shield of a moving preform supporting mandrel and aligning an axis of a body of the preform with a neck supporting cylindrical collar of the mandrel,
removing the non-symmetric preform from the preform supporting mandrel with a gripper of a second pick and place apparatus of a rotating second rotating transfer system and rotating the preform to a rotating stretch-blow-moulding die of the machine in a second stage,
manoeuvring the gripper of the second pick and place apparatus so as to align the integral handle with a handle nesting portion of the stretch-blow-moulding die and a vertical axis of the preform with a vertical axis of the stretch-blow-moulding die in a third stage,
manoeuvring grippers of a pick and place apparatus of a rotating third rotating transfer system in position to grasp the neck of a now stretch-blow-moulded container and extracting the stretch-blow-moulded container from the stretch-blow-moulding die in a fourth stage.

Preferably the movement of the grippers of the pick and place apparatus of any one of the first, second or third rotating transfer systems is controlled by a combination of rotation of an arm of the transfer system supporting the pick and place apparatus and rotation and linear displacement controlled by loci of two cam followers.

Preferably the locus of the first cam follower is determined by a cam channel provided in a fixed cam plate of each of the first, second and third rotating transfer systems; the locus of the second cam follower determined by an outer cam surface of the fixed cam plates.

In yet a further broad form of the machine there is provided a method of manipulating a non-symmetrical injection moulded preform into a stretch-blow-moulding die of a continuous preform feed stretch-blow-moulding machine; the method including the steps of:
extracting a preform from a preform preheating stage with a pick and place apparatus of a continuously rotating transfer system such that an integral handle of the preform has a predetermined orientation, and
wherein manoeuvring of a preform supporting gripper of the pick and place apparatus is controlled by rotation of an arm of the transfer system in combination with rotation and linear extension of the gripper guided by loci of two cam followers.

Preferably the method includes the further steps of:
manoeuvring the pick and place apparatus to align the integral handle with a bisecting radial line of an open stretch-blow-moulding die as the bisecting radial line rotates into coincidence with a line extending between rotation centres of the stretch-blow-moulding machine and the transfer system,
further manoeuvring the pick and place apparatus to align a vertical axis of a body of the preform with an axis of the die and the handle of the preform with a handle nesting portion of the die when opposing halves of the die close on reaching the line between rotation centres,

In yet a further broad form of the machine there is provided a method of preventing distortion of an integral handle of a preform in a stretch-blow-moulding process in a continuous preform feed stretch-blow-moulding machine; the method including the steps of:
preparing each half of a stretch-blow-moulding die with a handle nesting cavity conforming to at least a portion of the integral handle of the preform,
manipulating the preform so that the handle is brought into coincidence with the handle nesting cavity as two halves of the stretch-blow-moulding die close on the preform.

Preferably the manipulation of the preform is by a pick and place apparatus; a gripper of the pick and place apparatus urged into rotational and linear motion by a combination of rotation of an arm of a preform transfer system to which the pick and place is mounted, and rotation and linear displacement controlled by two cam loci.

In yet a further broad form of the machine there is provided a method of controllably heating a pre-form to a die introduction temperature; the pre-form having a neck portion extending from a body portion; said pre-form further having a handle portion extending radially; said method comprising
controllably transferring an integral handle PET pre-form onto a continuously moving conveyor;
securing the preform by its neck portion to the conveyor whereby the preform is transported by the conveyor at substantially constant velocity along a reheating path from a pre-form entry location to a pre-form exit location;
at least portions of the pre-form controllably heated to the die introduction temperature by the time it reaches the pre-form exit location;
a controllable heater array distributed along the path arranged to direct heat to selected portions of the pre-form;
the pre-form controllably transferred from the preform exit location into a die for stretch blow moulding of the pre-form thereby to form a blown container.

Preferably the handle portion is solid and has a first end; the first end integrally connected at an upper location to on a body of the pre-form.

Preferably the elements are arranged in modules; the modules arrayed around the continuously rotating preform conveyer; the elements controlled as a group based on height wherein the top most elements of the modules are controlled to a predetermined temperature together whilst the next down in height elements are also controlled together to a predetermined temperature—and so on down to elements at the lowest level.

Preferably a processor controls the speed of rotation of a motor in order to control the continuous speed of advancement of the preforms.

Preferably a temperature sensor provides environment temperature sensing which is utilised by processor to modulate the degree of heating of all elements by a difference factor delta (Δ).

In yet a further broad form of the machine there is provided an orientation mechanism controlling orientation of a non-symmetric injection moulded preforms prior to entry into stages of a stretch blow-moulding machine; the non-symmetric preforms each including an integral handle extending from a junction point below a neck of the preform on a body of the preform; the mechanism including a pair of contra-rotating drive wheels disposed along opposite sides of inclined rails; one of the drive wheels inducing rotation of the body of the preform moving down the inclined rails to rotate the handle of the preform into a preferred position.

Preferably the inclined rails include a pair of upper rails between the preforms are suspended by necks of the preform and a pair of lower rails which constrain the integral handles into approximate alignment with a long axis of the inclined rails; integral handles of the preforms constrained to either a leading or a trailing orientation.

Preferably the pair of drive wheels are located at a level coincident with a lower portion of the body of the preform below the lower rails and a lowest point of the integral handles; axes of the drive wheels normal to the long axis of the inclined rails.

Preferably a gap between the pair of drive wheels is smaller than a diameter of the body of the preform; each guide wheel including at least one tyre of a sufficiently soft polymer material to allow passage of the body of the preform through the gap between the pair of drive wheels.

Preferably directions of rotation of the pair of contra-rotating drive wheels draw preforms moving down the inclined rails through the gap between the drive wheels; a first of the drive wheels rotating in an anticlockwise direction with a second opposite drive wheel rotating in a clockwise direction.

Preferably the drive wheels rotate at different rates of rotation; the ratio of rotation of the first drive wheel to the rotation of the second opposite drive wheel being of the order of 2:1.

Preferably the different rates of rotation of the drive wheels cause the second opposite drive wheel to rotate the body of the preform in an anticlockwise direction as the preform passes through the gap between the two drive wheels.

Preferably rotation of the body of the preform changes orientation of a preform with a leading handle at entry to the mechanism to a preform with a trailing handle on exit from the mechanism; a gap in the lower rail at the side of the lower rail adjacent the first drive wheel.

In yet a further broad form of the machine there is provided a method of orienting a non-symmetrical preform for entry to stages of a stretch blow-moulding machine; the none symmetrical preform including an integral handle extending from a first junction point below a neck of the preform on the body of the preform; the method including the steps of:
providing preforms to slide down inclined rails towards an orientation mechanism while supported by the necks of the preforms along upper rails of the inclined rails,
constraining integral handles of the preforms in either a leading or in a trailing position between lower rails of the inclined rails,
drawing preforms through a gap between a pair of contra rotating drive wheels of the orientation mechanism disposed along the inclined rails, and
wherein differential rates of rotation of the pair of drive wheels rotate the body of the preform from a leading orientation of the integral handle at entry to the orientation mechanism into trailing orientation of the handle at exit of the preform from the orientation mechanism.

Preferably the pair of drive wheels are located coincident with a lowermost portion of the body of the preform below lower rails of the inclined rails and below a lowermost point of the integral handle.

Preferably a first of the pair of contra rotating guide wheels at one side of the inclined rails rotates in an anticlockwise direction; the second of the pair of contra rotating drive wheels at an opposite side of the inclined rails rotating in a clockwise direction; the pair of contra rotating drive wheels acting to draw preforms through the gap between the drive wheels.

Preferably the ratio of the rate of rotation of the contra rotating drive wheel to the rate of rotation of the clockwise rotating drive wheel is in the order of 2:1.

Preferably the clockwise rotation of the clockwise rotating drive wheel rotates bodies of a preforms passing through the gap between the drive wheels in an anticlockwise direction such that a preform with an integral handle in a leading orientation is rotated so that the integral handle is in a trailing orientation.

In another broad form of the machine, there is provided an injection-moulded preform forming a stretch-blow-moulded container; the preform comprising an open neck portion and a hollow body extending from the neck portion; the preform further including an integrally injection-moulded handle; at least a portion of walls of the hollow body varying in thicknesses.

Preferably, at least a portion of an inner surface of the hollow body is non-concentric with outer surfaces of the hollow body.

Preferably, the outer surfaces of the hollow body are defined by diameters centred on a central longitudinal axis of the preform to form a substantially cylindrical body.

Preferably, the cross sections of the at least a portion of the inner surface of the hollow body are ovoid in section.

Preferably, the centres of the cross sections of ovoid shape are centred on the central longitudinal axis of the preform.

Preferably, the centres of the cross sections of ovoid shaper are offset from the longitudinal axes of the preform.

Preferably, the centres of circular cross sections of a portion of the hollow body are offset from a central longitudinal axis of the hollow body.

Preferably, a core or mandrel forming the inner surface of the hollow body in an injection moulding step, comprises at least one portion of circular cross sections to form an upper region of the inner surface of the preform; portion of the mandrel comprising ovoid cross sections depending from a transition portion between a lower end of the at least one portion of circular cross sections and the portion of ovoid cross sections.

Preferably, the mandrel comprises two portions of circular cross sections; an upper portion and a lower portion; the transition portion depending from the lower portion.

Preferably, the upper portion is of diameters equal to inner diameters of the neck portion of the preform.

Preferably, the lower portion is of diameters smaller than the diameters of the upper portion.

Preferably, the transition portion forms an asymmetrical frustum of a cone; an upper end of the transition portion having a diameter equal to that of a lower end of the lower portion with the lower end of the transition portion conforming in cross section to the ovoid cross section of an upper end of the ovoid portion.

Preferably, each of the upper portions and the ovoid portion are tapering; the cross sections decreasing in area from respective maximum areas at upper ends of the portions to minimum areas at the respective lower ends.

Preferably, the diameters defining the outer surface of the hollow body decrease in dimension from a maximum diameter at a lower end of the neck portion to the lower end of the hollow body.

Preferably, the preform includes an integral handle; the handle forming a loop of material extending vertically below the neck portion of the preform to a lower junction on the body of the preform.

Preferably, a central vertical plane of the handle passes through the central axis of the preform.

Preferably, the major axes of the cross sections of the ovoid portion of inner surface of the hollow body of the preform lie in the central vertical plane.

Preferably, the wall thicknesses of the preform in that portion of the preform in which the inner surfaces are defined by the ovoid cross sections, vary from a maximum at opposite ends of the minor axes of the ovoid cross sections to minimum thicknesses at outer ends of the major axes.

Preferably, the ratio of maximum wall thickness to minimum wall thickness of the ovoid portion lies in the range of 2:1 and 2.2:1.

Preferably, the polymer walls of the preform proximate maximum thickness are distributed predominantly to longer side walls of a rectangular cross section blown container; the polymer walls of the preform proximate minimum thickness predominantly distributed to shorter side walls of the blown container.

In another broad form of the machine, there is provided a method of optimizing wall thickness in a stretch-blow-moulded container; the method including the steps of:
injection moulding hollow preforms in which at least a lower portion of each preform has internal cross sections non-concentric with external surfaces of the lower portion,
bringing the preforms to a temperature suitable for stretch-blow-moulding,
inserting the preforms into cavities of a stretch-blow-moulding machine,
mechanically stretching the preforms and injecting air to form the container.

Preferably, the mandrels for the injection moulding of the preforms include at least one upper region of circular cross sections.

Preferably, the lower portion of the preform has cross sections of an ovoid form.

Preferably, the upper region of the mandrel includes an upper portion and a lower portion.

Preferably, a transition portion extends between a lower end of the lower portion and an upper end of the lower section.

Preferably, the external surfaces of the preform are defined by diameters centred on a central longitudinal axis of the preform.

Preferably, an integral handle is formed on the preform extending in a loop between a first junction region below a neck portion of the preform and a second junction region on a body of the preform; a central vertical plane of the integral handle coincident with the central longitudinal axis.

Preferably, the major axes of the cross sections of ovoid form of the lower section lie in the central vertical plane.

Preferably, the wall thicknesses of the preform in the lower section vary from maximum thicknesses at opposite ends of the minor axes of the ovoid cross sections to minimum thicknesses at opposite ends of the major axes.

Preferably, in stretch-blow-moulding a container of generally rectangular cross section, polymer material proximate the maximum thicknesses is distributed to longer sides of the container and polymer material proximate the minimum thicknesses is distributed to shorter sides of the container.

In another broad form of the machine, there is provided a mandrel for forming internal surfaces of an injection-moulded hollow preform; the mandrel including at least one portion with cross sections which are non-concentric with diameters defining outer surfaces of the preform.

Preferably, the non-concentric cross sections are ovoid in form; the ovoid forms defining varying wall thickness of the preform.

Preferably, the major axes of the ovoid formed cross sections lie in a vertical plane containing a vertical central longitudinal axis of the preform; the vertical plane forming a mid plane of an integral handle formed on the preform depending vertically from a first junction region below a neck portion of the preform to a second junction point on a body of the preform.

In another broad form of the machine, there is provided a method of biasing distribution of polymer material from walls of at least one portion of a preform to selected side walls of a container stretch-blow-moulded from the preform; the method including the steps of:
arranging a mandrel defining inside surfaces of the preform with cross sections of the at least one portion which are non-concentric with corresponding outer surfaces of the preform as defined by a cavity of a preform injection moulding die,
arranging the mandrel in the injection moulding die such that major axes of the cross sections of the mandrel of the at least one portion are aligned with a central vertical plane of the cavity,
injection moulding the preform,
introducing the preform into a cavity of a stretch-blow-moulding machine such that the central vertical plane of the preform is aligned with a central vertical plane of a blown container of generally rectangular cross section, and
wherein the central vertical plane of the container is parallel to opposing longer sides of the container.

Preferably, the cross sections of the mandrel in the at least one portion are ovoid in shape; major axes of the ovoid cross sections aligned with the central vertical plane; centres of the ovoid cross sections coincident with a central axis of a body of the preform.

Preferably, the outer surfaces of the body of the preform are defined by diameters centred on the central axis.

Preferably, the preform includes an integral handle forming an integral handle on the container; the integral handle of the preform extending vertically from a first junction below a neck portion of the preform to a second junction on a body of the preform; the integral handle centred on the central vertical plane of the preform.

Preferably, in a blow moulding stage polymer material of walls of the preform in the at least one portion and on opposing ends of a minor axes of the ovoid cross sections are biased to the opposing longer sides of the container; polymer material proximate to opposite ends of a major axes of the ovoid cross sections biased towards the shorter side walls of the container.

In another broad form of the machine, there is provided a method of injection moulding a preform in which at least a portion of wall thicknesses of a hollow body of the preform varies along a length of the hollow body; the method including the steps of;
forming at least one pair of opposing cavities in an injection moulding die; the cavities defining external surfaces of the preform and an integral handle,
locating a mandrel in each of the at least one opposing cavities such that a central longitudinal axis of the mandrel is coincident with an axis of the cavity as defined by a neck portion of the hollow body,
closing the injection moulding die to form a cavity about the mandrel,
injecting a polymer into the cavity to form the preform, and
wherein the injection-moulded preform includes an integral, injection-moulded handle; the handle extending from a junction point below a neck portion of the on the hollow body of the preform.

Preferably, the wall thicknesses of the hollow body of the perform increase from below the neck portion to proximate a lower end of the preform.

Preferably, the cross sections of internal surfaces of the perform are concentric with cross sections of external surfaces of the preform.

Preferably, at least a portion of cross sections of internal surfaces of the preform are non-concentric with cross sections of outer surfaces of the preform.

Preferably, the non-concentricity of the cross sections of internal surfaces of the preform with cross sections of the outer surface of the preform is from a portion of cross sections of the internal surface being of ovoid form.

Preferably, the non-concentricity of the internal surfaces with the outer surface of the hollow body is from centres of cross sections of the internal surface being of offset from a central longitudinal axis of the preform; wall thicknesses of the preform varying along sections of the preform.

In a further broad form of the machine, there is provided a preform and a container stretch-blow-moulded from the preform in a stretch-blow-moulding machine; the preform comprising a neck portion, a collar below the neck portion and a body extending from below the collar; the body including a first cylindrical portion having a first diameter and a second conical portion tapering from a diameter smaller than the diameter of the first portion to a minimum diameter proximate a bottom portion of the preform.

Preferably, the preform includes an integral handle forming a loop extending from a first junction position proximate the collar to a second junction position along the body.

Preferably, the first cylindrical portion extends from below the collar; the first portion being of a substantially constant diameter.

Preferably, wall thicknesses of the preform are variable; thickness of the second conical portion tapers from a minimum thickness proximate the first cylindrical portion to a maximum thickness proximate a tangent line between the conical portion and a bottom portion of the preform.

In a further broad form of the machine, there is provided a method of reducing material required to form a container stretch-blow-moulded from a preform; the preform comprising a neck portion, a collar below the neck portion and a generally cylindrical body below the neck portion; the preform further including a handle extending from a first junction position below the collar to a second junction position along the body of the preform; the method including the steps of:
Forming the body of the preform in at least two portions of different configuration; a first cylindrical portion and a second conical portion;
Reducing a base diameter of the conical portion relative to a diameter of the first cylindrical portion.

Preferably, wall thickness of the second portion varies from a minimum thickness proximate the base diameter of the conical portion to a maximum thickness proximate a tangent line between the second conical portion and a bottom portion of the preform.

In a further broad form of the machine, there is provided a continuously rotating stretch-blow-moulding machine; the stretch-blow-moulding machine including an orientation device orienting integral handles of injection-moulded preforms from which containers with integral handles are stretch-blow-moulded in the machine; the orientation device including a pair of side by side contra-rotating auger screws located above spaced apart main support rails of a preform infeed track and centred about a vertical mid plane of the main support rails; configuration of diameters, pitch and flutes of the auger screws arranged to capture necks of the preforms and advance preforms along the preform infeed track; sides of preforms advancing along the auger screws contacting a friction strip inducing rotation of the preforms; rotation causing all preform integral handles to rotate from any random first orientation to a second predefined orientation.

Preferably, the preforms with integral handles are fed onto a pair of side by side contra-rotating rollers centred about the vertical mid plane of the pair of spaced apart rails of the preform feed-in track; the pair of contra-rotating rollers located before the auger screws; the pair of roller space apart sufficient to allow bodies and integral handles of the preforms to slide between the rollers into a position wherein the preforms are suspended between the rollers by collars below the necks of the preforms; the bodies and integral handles of the preforms constrained between spaced apart guide rails in the random first orientation; the guide rails located at a level below the main preform support rails proximate the middle of the handles.

Preferably, in the random first orientation handles may be leading or trailing relative a direction of movement of preforms along the infeed track towards a preform pick-off position at a lower outer end of the infeed track.

Preferably, the friction strip mounted to one of the main support rails is substantially coextensive with lengths of the auger screws; the friction strip intruding into space between the pair of spaced apart main support rails sufficient to engage with the sides of bodies of preforms moved along by the auger screws.

Preferably, a section of that guide rail on the same side as the friction strip is discontinuous for a length substantially coextensive with lengths of the auger screws.

Preferably, rotation of the preforms while carried along the auger screws rotates all preform handles into a handle trailing position with the handles arrested by contact with that guide rail of the pairs of guide rails opposite to the friction strip; the handles able to rotated through the discontinuous section of the guide rail.

Preferably, the auger screws separate successive preforms according to the pitch of the auger screws; the auger screws further providing downward pressure on preforms with oriented handles between the ends of the auger screws and the preform pick-off position.

In a further broad form of the machine, there is provided a method of producing stretch-blow-moulded containers with integral handle in a continuously rotating stretch-blow-moulding machine; the containers with integral handle stretch-blow-moulded from separately injection-moulded preforms with integral handle; the preform comprising a neck portion, a body portion and a handle forming a loop of orientable material extending from a first junction point below the neck portion to a second junction point on the body portion; the method of injection-moulding including the steps of:
Forming a multicavity injection-moulding die;
In a heated fixed side of the die forming an array of cavities; the cavities formed to correspond to sections of the preforms to a point below the integral handle;
Providing a corresponding array of opposing half cavities projecting from a face of the opposite moving side of the die; the half cavities shaped to form the preform from the neck portion, body and integral handle to the point below the integral handle;
Providing cores for forming the internal shape of the preforms; the cores fixed to the moving side of the die and centred on a common axis of the cavities in the fixed heated side of the die and the opposing half cavities.

Preferably, in a mould cycle
cavities in the heated fixed side of the die and the opposing half cavities at the opposite moving side of the die are injected with orientable polymer material to form the preforms;
When filled, after a predetermined delay moving the moving side of the die away from the heated fixed side to draw the ends of the preform bodies below the handle out of the cavities in the heated fixed side of the die;
After a predetermined delay, opening the opposing half cavities to release the neck portion, the integral handle and the body portion of the preform to below the handle portion.

Preferably, further in the mould cycle
activating a robot to position an array of vacuum suction elements between the heated fixed side of the die and the moving side of the die;
positioning the array of vacuum suction elements in registration with the array of cavities;
as the opposing half cavities open apply vacuum pressure to the vacuum elements and activate the robot to drive the vacuum elements to fit over the ends of the preforms;
retract the robot to draw the preforms from the cores and withdraw the vacuum elements and retained preforms from between the heated fixed side and the moving side of the die;
rotate the array of vacuum elements into a position in which axes of the preforms are substantially vertical and cut vacuum pressure to allow preforms to fall into a receiving bin.

Preferably, each vacuum element is provided with a slot or channel at an open end of the vacuum elements; the slot or channel provided to allow each vacuum element to accommodate at least a portion of the handle of the preform.

In a further broad form of the machine, there is provided a continuously rotating, non-symmetric preform feed, stretch-blow-moulding machine in which injection-moulded preforms with integral handles are transferred from a first transfer system to a preheating stage; the transfer of a preform from a gripper of the first transfer system to a preform supporting mandrel achieved in one fluid motion as a vertical axis of the preform is brought into alignment with a vertical axis of the preform supporting mandrel and the handle of the preform is slid into a heat shield provided on the mandrel, the transfer made while accommodating each of the rotations of a loop rail of the preheating stage, the mandrel and the transfer system as well as movements of the gripper.

Preferably, the handle as injection moulded is protected by the heat shield during the preheating stage; the shape of the handle of a container stretch-blow-moulded from the injection moulded preform being identical to the as injection-moulded shape of the handle of the preform.

The following features relating to a stretch blow moulding, filling and capping system for containers with integral handles may advantageously be combined with any of the above referenced features, methods and apparatus described above.

In a broad form of the machine, there is provided a stretch blow moulding, filling and capping system for containers with integral handles; the containers blown from injection moulded preforms; each preform having the integral handle projecting from at least one junction point on a body portion of the preform; containers blown in a continuously rotating stretch blow moulding machine of the system transferred automatically to a continuous container filling and capping machine.

Preferably, a known orientation of the handle is established at an orientation mechanism prior to preforms entering the continuously rotating stretch blow moulding machine; the known orientation of the preform and the container blown from the preform controlled through all stages of the preform and the blown container passing through the stretch blow moulding machine.

Preferably, the known orientation of the blown container is controlled during transfer of the blown container from the continuously rotating stretch blow moulding machine and through the automatic container filling and capping machine.

Preferably, the stretch blow moulding machine and the container filling and capping machine are arranged so that a discharge channel of the stretch blow moulding machine is in line with and at the same level as an infeed conveyor of the container filling and capping machine.

Preferably, the cycle time of the container filling and capping machine is synchronized with the cycle time of the stretch blow moulding machine.

Preferably, an escapement mechanism disposed along the infeed conveyor of the container filling and capping machine ensures spacing of containers conforms to spacing of filling nozzles and capping mechanisms of the container filling and capping machine.

Preferably, a walking beam container transport system of the container filling and capping machine overlaps a discharge channel of the stretch blow moulding machine; a first nest of the walking beam transport system capturing each successive leading container from the discharge channel.

Preferably, an industrial robot is positioned between a discharge channel of the stretch blow moulding machine and an infeed conveyor of the container filling and capping machine; the robot taking successive leading blown containers from an end of a discharge channel of the stretch blow moulding machine for placement on the infeed conveyor; placement by the robot ensuring spacing of the blown container and orientation of the handle adapted for movement of the container through the container filling and capping machine.

Preferably, wherein preforms are in continuous motion from an initial preform pick off point through stretch blow moulding and ejection from stretch blow moulding dies as stretch blow moulded containers with integral handle.

Preferably, the integral handle retains a shape of the handle as injection moulded through all stages of the stretch blow moulding machine and through the filling and capping machine.

In another form of the machine, there is provided a continuous process from injection moulded preforms with integral handles to filled and capped containers with integral handles in which an orientation of the integral handle of the preform is controlled from entry into a stretch blow moulding machine; the orientation of the handle controlled throughout the processes of preform preparation, stretch blow moulding of the containers from the preforms and filling and capping of the blown containers.

Preferably, back pressure of blown containers at a discharge channel of the stretch blow moulding machine forces successive blown containers onto an infeed conveyor of a filling and capping machine.

Preferably, a walking beam transport system of a filling and capping machine overlaps a discharge channel of the stretch blow moulding machine; an end nest of the walking beam transport system capturing successive leading blown containers from the discharge channel for transport through the filling and capping machine.

Preferably, a robot positioned in and intermediate area between the stretch blow moulding machine and an automatic filling and capping machine picks successive leading blown containers from a discharge channel of the stretch blow moulding machine for placement on an infeed conveyor of the filling and capping machine.

In a further form of the machine, there is provided a continuous transfer system wherein containers stretch blow moulded from injection moulded preforms with integral handles in a continuously rotating stretch blow moulding machine are fed to a filling and capping machine; an orientation of the integral handle controlled from entry of a preform into the stretch blow moulding machine to the emergence of filled and capped containers from the filling and capping machine.

Preferably, a discharge channel for blown containers of the stretch blow moulding machine is in line with and at a same level as an infeed conveyor of the filling and capping machine.

Preferably, back pressure of blown containers in the discharge channel forces successive leading blown containers onto the infeed conveyor of the filling and capping machine.

Preferably, a walking beam transport system of the filling and capping machine overlaps a discharge channel of the stretch blow moulding machine; an end nest of the walking beam transport system capturing successive leading blown containers from the discharge channel for transport through the filling and capping machine.

Preferably, a robot positioned in and intermediate area between the stretch blow moulding machine and an automatic filling and capping machine picks successive leading blown containers from a discharge channel of the stretch blow moulding machine for placement on an infeed conveyor of the filling and capping machine.

In another broad form of the machine there is provided a continuous transfer system for containers with integral handles stretch blow-moulded from injection moulded preforms with integral handles; the transfer system transferring the containers with a known orientation of the integral handle from a continuously rotating stretch blow-moulding machine to an automatic continuously filling and capping machine; a re-orientation device intermediate a discharge channel of the stretch blow-moulding machine and the automatic continuously filling and capping machine adapted to optionally reorient the containers from the known orientation to another desired orientation prior to entry into the automatic continuously filling and capping machine.

The following features relating to a single connect integral handle of PET container and method of production may advantageously be combined with any of the above referenced features, methods and apparatus described above.

Accordingly, in another broad form of the machine, there is provided an integral handle of a stretch blow-moulded container and injection moulded preform; the integral handle respectively connected at a single connection region on a body portion of the preform and at a single connection region of a body of the container, wherein the wall thickness of the body portion of the preform and of the container in a region extending below the handle connection region on the body of the container is substantially equal to thickness of adjoining wall regions.

Preferably, the handle extends from the single region on the preform and on the container proximate a neck portion common to both the preform and the container.

Preferably, the handle includes an upper arcuate portion extending from the single connection region; the arcuate upper portion transitioning into a substantially straight, downwardly projecting portion.

Preferably, the handle includes a central web lying in a central plane passing through a centre line of the body portion of the preform and a plane bisecting the body portion of the container.

Preferably, the central web is bounded by an edge; the edge extending continuously around a periphery of the web from an upper junction point to a lower junction point on both the preform body portion and on the body of the container.

Preferably, a rib normal to the web extends along the edge; the rib projecting outwardly and symmetrically from both sides of the plane; the rib and central web forming an I-beam like cross section.

Preferably, the upper and lower connection cross sections of the rib meld with surfaces of both the preform body portion and the body of the container.

Preferably, inward facing sections of both the web and the rib is provided with one or more scalloped configurations; the scalloped configurations aiding in gripping the handle in use.

Preferably, a thumb support is provided projecting from an upper portion of the rib.

In another broad form of the machine, there is provided a method of reducing volume of PET polymer in a container stretch blow-moulded from an injection moulded preform with an integral handle; the handle formed as a loop extending between first and second connection points on the body of the preform; the method including the steps of:
changing the integral handle of the preform from the integral handle formed as a loop to a single connect handle extending from a single connection region on the body portion of the preform,
reducing wall thickness of the body portion of the preform in a region below the connection region of the single connect handle from a reinforced thickened wall to a thickness equal to wall thickness of adjoining regions of the preform.

Preferably, the handle extends from the single connection region on the preform and on the container proximate a neck portion common to both the preform and the container.

Preferably, the handle includes an upper arcuate portion extending from the single region; the arcuate upper portion transitioning into a substantially straight, downwardly projecting portion.

Preferably, the handle includes a central web lying in a plane passing through a centre line of the body portion of the preform and a plane bisecting the body portion of the container.

Preferably, the central web is bounded by an edge; the edge extending continuously around a periphery of the web from an upper junction point to a lower junction point on both the preform body portion and on the body of the container.

Preferably, a rib normal to the edge extends along the edge; the rib projecting outwardly and symmetrically from both sides of the web; the rib and central web forming an I-beam like cross section.

In a further broad form of the machine, there is provided a single connect handle of a stretch blow-moulded container; the container stretch blow-moulded from an injection moulded preform; the preform including an integral handle connected at a single connection region of the preform; the handle extending outward from, and generally parallel, for a section of a body portion of the preform and, wherein wall thickness of the preform in the section of the body portion is equal to wall thickness of adjacent regions of the preform.

In yet another broad form of the machine, there is provided an injection moulded preform with integral handle for stretch blow-moulding a container with an integral handle; the preform having a cylindrical body portion extending from below a neck of the preform and a curved closure at a base of the body portion; walls of the cylindrical body portion of the preform being of constant thickness.

Preferably, the integral handle is connected to the preform at a single connection region; the handle extending outwardly and generally parallel for a section of the body portion of the preform.

The following features relating to a preform distortion control and method may advantageously be combined with any of the above referenced features, methods and apparatus described above.

Accordingly, in another broad form of the machine there is provided a method of determining the form of a cavity in a stretch blow-moulding die for accommodating an integrally connected handle connected to a body portion of the preform; the method including the steps of:
designing the preform with the integrally connected handle
injection moulding the preform,
passing the preform through a preform conditioning stage under controlled parameters,
noting distortion of the handle from the design resulting from heating during the preform preconditioning stage,
repeating trial conditioning stages until a stable acceptable degree of distortion is established under recorded parameters,
forming the handle cavity in the stretch blow-moulding die according to the established distortion.

Preferably, the preform comprises a neck and a cylindrical body portion extending below the neck; the cylindrical body portion ending in a curved closure.

Preferably, the integrally connected handle forms a loop of material extending from a first upper connection point on a body portion of the preform to a second lower connection point on the body portion of the preform.

Preferably, the integrally connected handle extends from a single connection region on the body portion of the preform.

Preferably, parameters of a preheating stage of a stretch blow-moulding machines are adjusted to introduce a minimum range of distortion of the integrally connected handle.

Preferably, the design of the integrally connected handle and cavities in the injection moulding die are adjusted so that the minimum range of distortion restores the handle to approximately an original desired design configuration of the integrally connected handle.

Preferably, heat shields of a preheating stage of a stretch blow-moulding machine are designed to accommodate a maximum distortion within the minimum range.

Preferably, stretch blow-moulding cavities of stretch blow-moulding dies are prepared according to designs for stretch blown-moulded containers; pockets in the cavities for accommodating the integrally connected handle formed according to a median of the range of distortion.

Preferably, the pockets are provided with angled lead-in surfaces; outer edges of the lead-in surfaces define a maximum distortion of the range of distortions sufficient to receive a maximum distortion of the integrally connected handles.

In another broad form of the machine, there is provided a method of controlling configuration of an integrally connected handle of a container stretch blow-moulded from an injection moulded preform with the integrally connected handle; the method including the steps of:
determining a minimum range of distortions of the integrally connected handle caused by passing the preform through a preheating stage of a stretch blow-moulding machine,
providing angled lead-in surfaces around pockets for accommodating the integrally connected handle within cavities of stretch blow-moulding dies of a stretch blow-moulding machine.

Preferably, the minimum range of distortions is determined by repeated trials of the preheating stage under controlled parameter conditions.

Preferably, outer edges of the angled lead-in surfaces define an area at least coextensive with a maximum distortion of the minimum range of distortions.

In a further broad form of the machine, there are provided opposing cavities in halves of a stretch blow-moulding die of a stretch blow-moulding machine; each cavity including a pocket for accommodating an integrally connected handle of a preform inserted into the die; the pocket provided with elements adapted to constrain a distorted integrally connected handle into a desired handle configuration.

Preferably, the integrally connected handle of the preform comprises a loop of material extending from a first, upper connection region to a second, lower connection region on a cylindrical body portion of the preform.

Preferably, the integrally connected handle of the preform comprises a web bounded by a rib extending along an outer edge of the web; the handle extending from a single connection region on the cylindrical body portion of the preform.

Preferably, distortion of the integrally connected handle is caused by application of heat during a preform conditioning stage in the stretch blow-moulding machine.

Preferably, a minimum range of distortions is established by repeated conditioning test runs of the conditioning stage under controlled parameters.

Preferably, the elements adapted to constrain distorted integrally connected handles comprise angled lead-in surfaces around a perimeter of the pocket.

Preferably, outer edges of the angled lead-in surfaces define an area at least coextensive with a maximum distortion of the minimum range of distortions.

### BRIEF DESCRIPTION OF DRAWINGS

Embodiments of the present invention will now be described with reference to the accompanying drawings wherein:

FIG. 1 is a side view of a perform with integral handle for stretch blow-moulding a container by means of a continuous blow moulding machine;

FIG. 2 is a side view of a container with integral handle stretch blow-moulded from the preform of FIG. 1;

FIG. 3 is a plan view of the stretch blow-moulding machine producing the container of FIG. 2;

FIG. 4 is a side view of a preform orientation and loading section of the machine of FIG. 3;

FIG. 4A is a plan view of the preform orientation and loading section of the machine of FIG. 3;

FIG. 4B is a plan view of a further preferred embodiment of a preform orientation arrangement for the machine of FIG. 3;

FIG. 4C is a side elevation view of the orientation arrangement of FIG. 4B;

FIG. 4D is a perspective view from below of the orientation arrangement of FIGS. 4B and 4C;

FIG. 5 is a plan view of a loading end of the preform orientation and loading section of FIG. 4 and a first preform transfer system;

FIG. 6 is a side view of the first preform transfer system of FIG. 5;

FIG. 7 is a plan view of a portion of the preform transfer system of FIGS. 5 and 6 and a preform loading and unloading area of a preform preheating stage of the machine;

FIG. 8 is a perspective view of a perform of FIG. 1 inserted into a mandrel with heat shield for transport through the preform preheating stage of the machine;

FIG. 9 is an enlarged plan view of section of the machine showing a portion of the preform loading and unloading area of FIG. 7, a second transfer system and a portion of the stretch-blow-moulding dies assembly of the machine;

FIG. 10 is a front view of one half of a stretch-blow-moulding die for the production of the container shown in FIG. 2;

FIG. 11 is a plan view of a portion of the machine of FIG. 3 showing the region of transfer of blown containers from a stretch-blow-moulding die to a container receiving bin;

FIG. 12 is a schematic block diagram of control components associated with control of the heating and transport of the preforms usable with any of the above described embodiments;

FIG. 13 is a side view of typical injection-moulded preform for stretch-blow-moulding of a polymer container according to prior art.

FIG. 13A is a sectioned side view of a preform according to a preferred embodiment of the invention in which a central vertical plane passing through a central vertical axis of the preform lies in the plane of the paper,

FIG. 14 is a side view of a mandrel for injection-moulding the preform of FIG. 13A in which a central vertical plane passing through a central vertical axis of the mandrel lies in the plane of the paper;

FIG. 15 is cross section along the vertical central axis of the mandrel of FIG. 14 taken at the level of A-A;

FIG. 16 is a cross section along the vertical central axis of the mandrel of FIG. 3 taken at the level B-B;

FIG. 17 is a side view of a container stretch-blow-moulded from the preform of FIG. 2;

FIG. 18 is an end view of the container of FIG. 17;

FIG. 19 is a sectioned side view of a further preferred embodiment of a preform according to the invention;

FIGS. 19A and 19B are selected cross sections of the preform of FIG. 19;

FIG. 20 is a sectioned side view of a further preferred embodiment of a preform according to the invention;

FIGS. 20A and 20B are selected cross sections of the preform of FIG. 20;

FIG. 21 is a sectioned side view of a further preferred embodiment of a preform according to the invention;

FIGS. 21A and 21B are selected cross sections of the preform of FIG. 21;

FIG. 22 is a sectioned side view of a further preferred embodiment of a preform according to the invention;

FIGS. 22A and 22B are selected cross sections of the preform of FIG. 22;

FIG. 23 is a sectioned side view of a further preferred embodiment of a preform according to the invention;

FIGS. 23A and 23B are selected cross sections of the preform of FIG. 23;

FIG. 24 is a schematic view of an injection moulding process for producing the preforms of FIGS. 13A and 19, 20 to 23;

FIG. 25 is a container with integral handle as blow-moulded from the preform of FIG. 13 according to prior art,

FIG. 26 is a preform of reduced PET volume according to a preferred embodiment of the invention,

FIG. 27 is a cross section view of the body of the preform of FIG. 26 showing variations in wall thickness,

FIG. 28 is a side view of a container stretch-blow-moulded from the preform of FIGS. 26 and 27,

FIG. 29 is a further side view of a preform with integrally formed handle according for stretch-blow-moulding in the machine of the invention,

FIG. 30 is a sectioned, schematic side view of an injection moulding press and injection moulding die for moulding the preforms for use in the continuous rotating stretch-blow-moulding machine of the invention, with the die opened prior to an injection moulding cycle,

FIG. 31 is a front view of the face of the moving die section of the injection moulding die of FIG. 30 at the end of an injection moulding cycle (with the heated fixed die section removed)

FIG. 32 is a further view of a part of the injection moulding press showing extraction of moulded preforms by vacuum elements inserted into the opened die by a robot.

FIG. 33 is a side view of a preferred embodiment of a preform and integrally attached handle according to the invention.

FIG. 34 is an end view of the preform of FIG. 33.

FIG. 35 is a view from above of the preform and handle of FIGS. 33 and 34.

FIG. 36 is a sectioned side view of a further preferred embodiment of a preform according to the invention;

FIGS. 36A and 36B are selected cross sections of the preform of FIG. 36;

FIG. 37 is a sectioned side view of a further preferred embodiment of a preform according to the invention;

FIGS. 37A and 37B are selected cross sections of the preform of FIG. 37;

FIG. 38 is a side view of a portion of an output side of a stretch blow moulding machine and a filling and capping machine in which blown containers are transferred form on machine to the other from a discharge channel of the first to an infeed conveyor of the second;

FIG. 39 is a plan view of the portion of the stretch blow moulding machine of FIG. 38 in which blown containers are captured by a walking beam transport system of a filling and capping machine;

FIG. 40 is a plan view in which a robot is used to transfer blown containers from the discharge channel of the stretch blow moulding machine to an infeed conveyor of a filling and capping machine,

FIG. 41 is a schematic plan view of a container reorientation device located intermediate the stretch blow-moulding machine and a filling and capping machine.

FIG. 42 is a side view of a preform with an integral handle attached at two locations arranged and manufactured according to further preferred embodiments.

FIG. 43 is a side view of a container stretch blow-moulded from the preform of FIG. 42.

FIG. 44 is a side view of a preform with an integral handle attached at a single point according to the invention.

FIG. 45 is a side view of a container with a single connect integral handle for stretch blow-moulded from the preform of FIG. 44.

FIG. 46 is a side section view of a further example of a preform with a handle attached at a single point with an alternative variable wall profile.

FIG. 47 is a side section view of a further example of a preform with a handle attached at a single point with an alternative variable wall profile.

FIG. 48 is a side view of a preform for stretch blow-moulding a container with an integral, double-connected handle.

FIG. 49 is a side view of the preform of FIG. 1, distorted after passage through a preconditioning stage in a stretch blow-moulding machine.

FIG. 50 is a front view of one half of a stretch blow-moulding die adapted to correct distortion of the preform of FIG. 49.

FIG. 51 is a side view of a container with integral double-connected handle stretch blow-moulded from the preform of FIG. 49 in the die of FIG. 50.

FIG. 52 is a side view of a preform for stretch blow-moulding a container with an integral, single-connected handle distorted after preheating;

FIG. 53 is a side view of a container with integral single-connected handle stretch blow-moulded from the preform of FIG. 6 in the die of FIG. 52;

FIG. 54 is a further side view of the container of FIG. 53

### DESCRIPTION OF EMBODIMENTS

The following is a detailed description of a continuous stretch blow moulding system applied to specified integral handle PET preform and PET blown container structures stretch blown from the preforms.

The continuous stretch blow moulding system will be described first and then the specified applications will follow. In its simplest form the stretch blown moulding system may be a single stage moulding system. In an alternative form, it may be a one and a half stage system. In yet a further form, it may be a two-stage system.

The system stretch blows integral handle PET containers from integral handle PET preforms using a continuous process as will be described.

The system stretch blows integral handle PET containers from non-symmetric injection moulded preforms; the non-symmetric preforms including an integral handle extending from at least one junction point on a body of the preform; the body of the preform and the integral handle constituted from the same PET material.

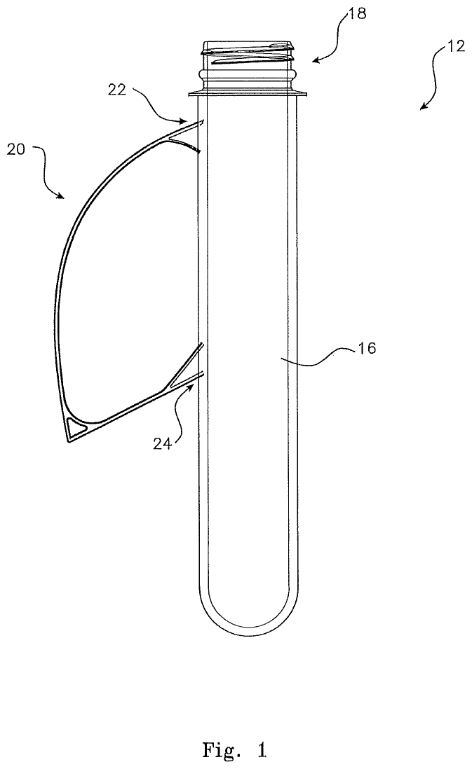

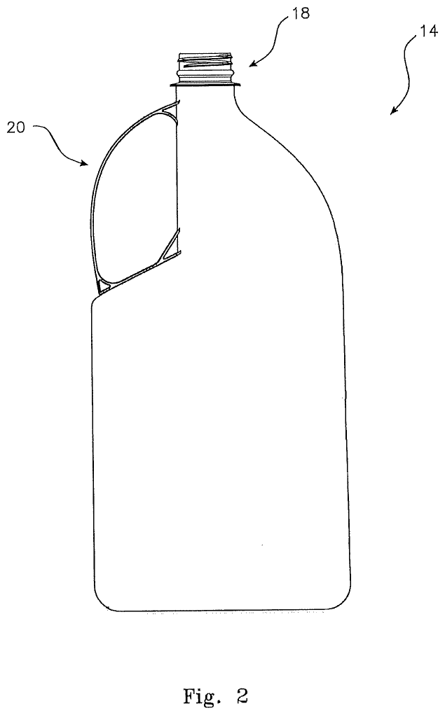

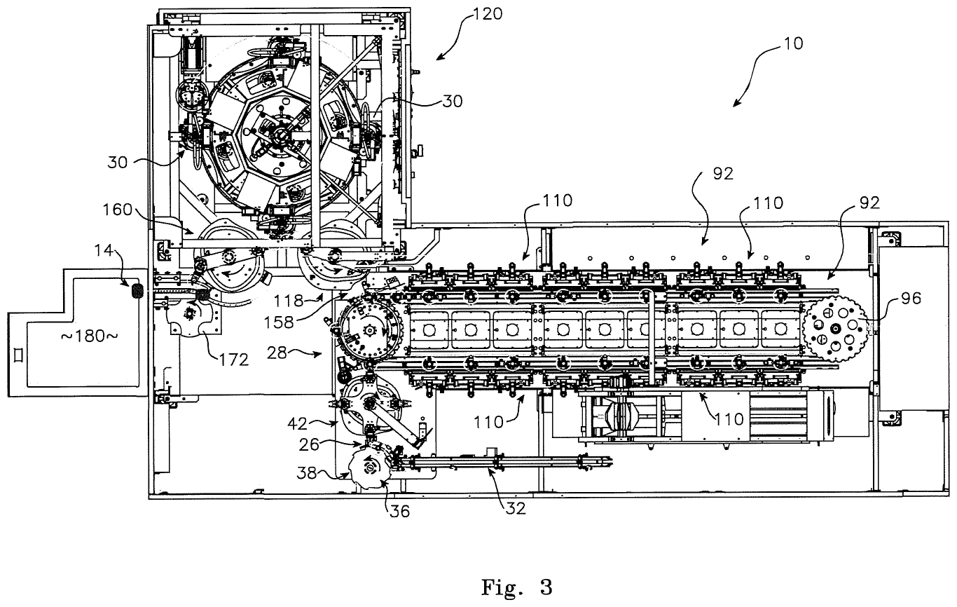

In a first preferred form, a feature of the present continuous machine 10, a preferred configuration of which is shown in FIG. 3, is that motion through the machine of a non-symmetric injection moulded preform 12 as shown in FIG. 1, from its initial intake to its emergence as a stretch blow-moulded container 14 (as shown in FIG. 2), is continuous. As shown in FIG. 1, the previously injection moulded polymer preform comprises a cylindrical elongate body 16 and neck 18. An integral handle 20 extends from a first junction point 22 just below the neck 18 to a second junction point 24 on the body 16 of the preform.

Referring again to FIG. 3, the continuous, non-incrementing process of the machine 10 includes the transfer of preforms from a loading or pick off position 26 to a preheating stage 28, through the preheating stage and transfer to a stretch-blow moulding die 30 with subsequent removal of the blown container 14 from the die and removal from the machine. These stages will now be described in detail.

### Entry of Preforms and Handle Orientation—First Preferred Embodiment

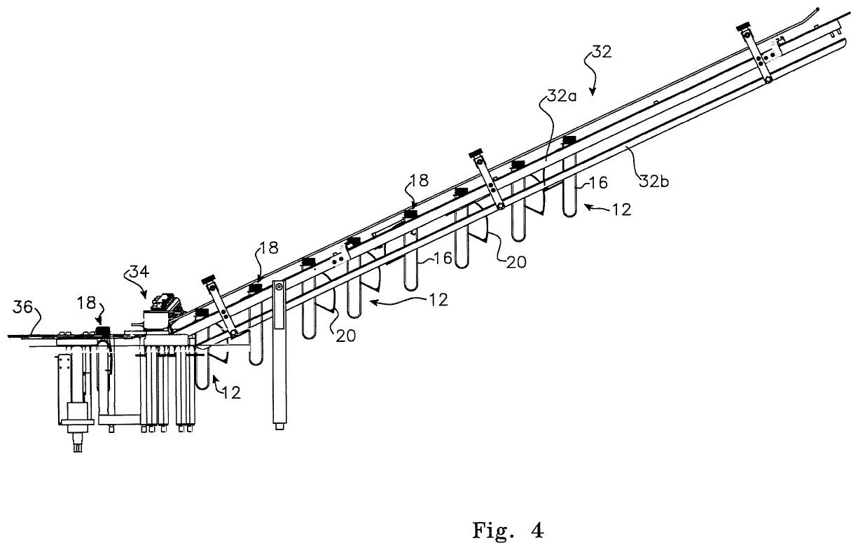

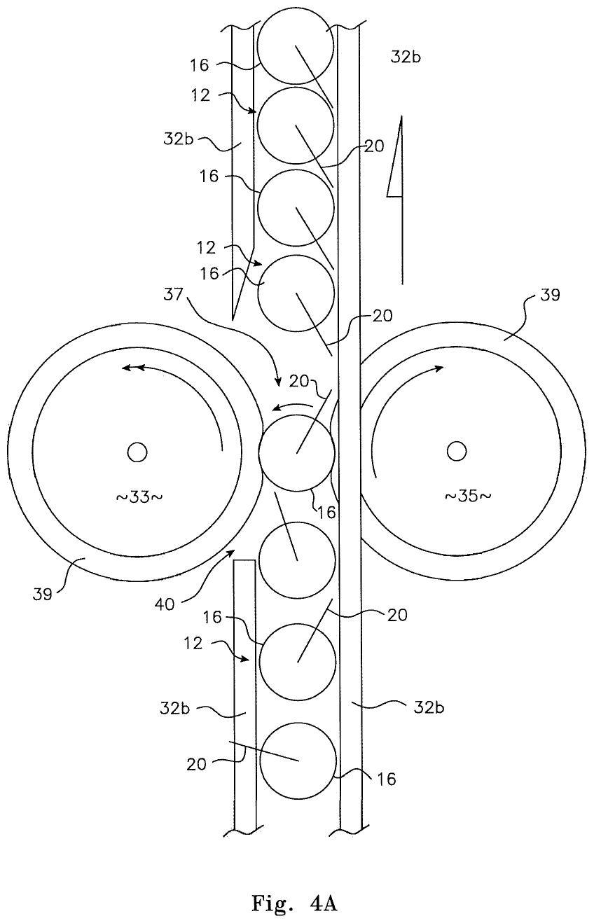

As shown in the preferred layout of the machine 10 in FIG. 3 and referring also to FIGS. 4 and 5, the previously injection moulded preforms 12 (as shown in FIG. 1) are fed, for example from a hopper (not shown but as well understood in the industry) to slide under gravity down inclined rails 32 while supported by their necks 18. The inclined rails 32 comprise a pair of upper rails 32a between which the preforms are suspended by their necks 18, and a pair of lower rails 32b which constrain the handles 20 of the preforms approximately in line with the long axis of the rails. For reasons that will become clear, it is essential however, that during the passage of preforms through the stages of the machine, the orientation of the integral handle 20 of the preform is controlled precisely.

Preforms 12 with a handle roughly oriented pass one by one through an escapement 34 to be captured by a continuously rotating feeder wheel 36 which carries the preform between the feeder wheel and a short rail 40, in such a way that friction between the body 16 of the preform and the rail 40 induces rotation of the preform and its handle. The rotating handle collides with a stop 40a under the rail 40 forcing each handle into a rearward orientation with respect to the direction of travel, to arrive at a pick off position 26.

At the instance that a preform arrives at the pick of position 26, a pair of opposing actuators (not shown) located under the pick off position 26, simultaneously briefly close on, and then release, the preform handle 20 to fix its orientation relative the gripper 58 which, also at that instant engages with the neck 18 of the preform.

### Entry of Preforms and Handle Orientation—Second Preferred Embodiment

In this second preferred embodiment, with reference now to FIG. 4A, the injection moulded preforms 12 are again fed onto inclined rails 32a, down which they slide under gravity supported by the flanges at the necks 18. Again, as described for the first preferred embodiment above, the handles are loosely constrained between lower rails 32b, with the handles either in a “leading”, that is pointing in the direction of movement of the preforms as they progress down the incline, or “trailing”, pointing rearwardly.

In this second preferred embodiment, an orientation mechanism 34A is located at a point along the rails 32 approaching the lower end of the rails. As can be seen in FIG. 4A, the mechanism includes two contra-rotating drive wheels 33 and 35, arranged at opposite sides of the rails 32, at a level coincident with the lowermost portion of the bodies of the preforms and below the lower rails 32b and the lowermost point of the handles. The axes of the wheels are normal to the slope of the inclined rails. Note only the lower rails 32b are shown in FIG. 4A.

The drive wheels 33 and 35 are separated by a gap 37 which is somewhat narrower than the diameter of the body 16 of the preforms. Each of the wheels 33 and 35 is provided with one or two tyres 39 of a sufficiently soft polymer material to allow a preform body 16 to pass through the gap but providing a degree of grip on the body.

As shown in FIG. 4A, drive wheel 33 rotates in an anticlockwise direction while drive wheel 35 rotates in a clockwise direction. The combination of these two rotations has the effect of drawing a preform through the gap 37. The two drive wheels do not however rotate at the same rate, with, in the preferred arrangement shown in FIG. 4A, drive wheel 35 rotating at a significantly lower rpm than that of guide wheel 33. A preferred ratio of rotation of drive wheel 33 to drive wheel 35 is of the order of 2:1.

The effect of this differential in rate of rotation of the two drive wheels is that drive wheel 35 exerts a considerably greater grip on the body 16 of the preform so that it acts to rotate the preform in an anticlockwise direction as the preform passes through the gap 37 between the two drive wheels. By this means a handle 20 of a preform which is in a leading position as the preform enters the gap 37, is rotated until it contacts the right hand lower rail 32b (as seen from above in FIG. 4A). To allow for this rotation of the handle a gap 40 is provide in the left hand lower rail.

It will be understood that the anticlockwise rotation induced by drive wheel 35 has no effect on those preforms entering the gap with their handles trailing, except to drive the trailing handle into contact with the right hand lower rail. Thus, all preforms downstream of the orientation mechanism 34A approach the escapement 34 in the preferred orientation with the handles in the trailing position.

The escapement 34 controls the feeding of the handle oriented preforms to the feeder wheel 36 as described above, retaining the trailing orientation of the handles as induced by the mechanism 34A. As for the first arrangement above, at the instance that a preform arrives at the pick of position 26, a pair of opposing actuators (not shown) located under the pick off position 26, simultaneously briefly close on, and then release, the preform handle 20 to fix its orientation relative the gripper 58 which, also at that instant engages with the neck 18 of the preform.

It will be understood that although the above description is specific to the rotation of the preform in an anticlockwise direction by the clockwise rotating drive wheel, orientation according to the principles of the mechanism may equally be achieved by reversing the differential rates of rotation of the two drive wheels and providing the gap in the lower guide rail on the opposite side to that illustrated in FIG. 4A. In this alternative arrangement, it is then the anticlockwise rotating drive wheel which induces clockwise rotation to the body of a preform passing between the wheels, rotating a leading oriented handle until it contacts the left hand lower rail (as seen from above in FIG. 4A), the gap allowing rotation of the handle then being provided in the right hand lower rail.

Precise orientation of the handle throughout the stages of the machine is critical to the process of preheating where the orientation must align with the alignment of heat shields, and for correctly placing the preform and the handle into the stretch-blow-moulding die.

### Entry of Preforms and Handle Orientation—Third Preferred Embodiment

With reference now to FIGS. 4B to 4D, in this further preferred arrangement of a handle orientation mechanism 34b, injection moulded preforms 12 emerge one at a time from a bulk supply via, for example, a conveyor (not shown) to be deposited centrally onto a pair of contra-rotating, downward sloping rollers 11 and 13. The rollers 11 and 13 are so spaced as to allow the body 16 and handle 20 of each preform to drop through the gap between them but retain the wider diameter of the projecting collar below the neck 18 of the preform. The rollers 11 and 13 are mounted above a pair of spaced apart guide rails 15 and 17 (as best seen in FIG. 4D) similarly spaced as the gap between the rollers. As the bodies and the handles of the preforms drop through the gap between the rollers and that between the guide rails 15 and 17, the handles 20 are constrained into approximate alignment between these rails, but at this stage handles may be “leading” or “trailing” relative to movement in the downward direction shown in FIGS. 4C and 4D. Since it is a requirement imposed by the design of the blow-moulding machine described below, that preform handles at entry of preforms into the feeder wheel 36 must be in the trailing position, those leading must be turned around.

At the downward ends of the rollers, the preforms drop to the level of main support rails 19 and 21, so that preforms are now retained between these main support rails by their collars. A combination of gravity and pressure from following preforms forces each preform against the upward outer ends of side by side, contra-rotating auger screws 23 and 25 located on either side of a median vertical plane between the support rails. The flutes 27 of the auger screws are sized so as to capture between them the necks 18 of the preforms. The pitch of the auger screws is such as to separate preforms while being driven in the downward direction by the screws' rotation.

Generally coextensive with the length of one of the auger screws, (in the arrangement shown in the drawings, auger screw 25), the main support rail 21 is provided at its underside with a friction strip 29 (as best seen in the enlargement inset of FIG. 4D). This friction strip 29 projects slightly into the gap between the main support rails 19 and 21 so that its inner edge engages with the body of a preform as it progresses between the augers. This friction contact urges rotation of the preform in an anticlockwise direction as seen from above.

Also, approximately coextensive with the length of the auger screw 25 is a gap in the guide rail 17. Any rotation of an already trailing handle, will only force the handle into engagement with the opposite guide rail 15, and remain trailing. But, as can be seen from the enlarged inset of FIG. 4D, handles of preforms with handles leading at entry between the auger screws will gradually be rotated from the position where the handle is leading to it being in the trailing position, (being free to do so by the gap in guide rail 17) until these handles also are arrested from further rotation by the opposite guide rail 15. From here as can be seen from FIGS. 4C and 4D, the preforms, all with handles trailing, proceed down the main support rails 19 and 21 with the handles constrained between the now continuous guide rails 15 and 17 until they reach the final orientation operation at the feeder wheel 36.

As well as spacing and rotating preforms as they pass between the auger screws 23 and 25, the rotation rate of the auger screws is such as to deliver a preform to the feeder wheel 36 in synchronization with the rotation of that wheel. Furthermore, the rotation of the auger screws provides pressure to ensure preforms proceed down the main support rails.

### Transfer to Preheating

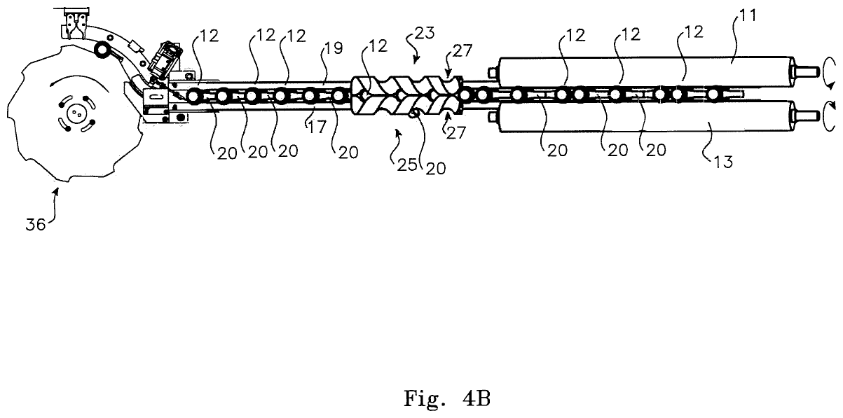

Referring now to FIG. 5 and FIG. 6, a first rotating transfer system 42 is positioned adjacent the feeder wheel 36 with a continuously rotating carrier 44 of the first rotating transfer system 42 and the feeder wheel 36 contra-rotating one to the other.

The rotating carrier 44 of the first rotating transfer system 42 includes, in this embodiment, four opposing support arms 46 extending radially from a fixed centre of rotation 48 to rotate about a vertical axis 50. Each end of the arms carries a first pick and place apparatus 52. Each first pick and place apparatus 52 includes a linear guide 54, a housing 56 which is rotatably mounted to the outer end of the support arm 46, enabling rotation of the housing 56 about a vertical axis 51. A two-fingered gripper 58 is mounted to a rotary actuator 60 supported by vertical plate 62 at an outer end of a free sliding element 64 of the linear guide 54. The gripper fingers 66 are centred on a gripper effective vertical axis 68, with the gripper able to be rotated about the horizontal axis 61 of the rotary actuator 60.

A fixed horizontal cam plate 70 is mounted at a level below the rotating carrier 44 so that its centre is coincident with the vertical axis 50 of the rotating carrier. The perimeter edge 72 of the cam plate 70 forms an outer cam surface 74 and its upper surface 76 is provided with a cam channel 78 which is inboard of the perimeter edge 72 and the outer cam surface 74.

The housing 56 of the linear guide 54 is provided with an outrigger arm 80 extending radially from the centre of rotation 82 of the linear guide 54. The outer end of the outrigger arm 80 supports a first cam follower 84 locating in the cam channel 78. The free sliding element 64, adapted to reciprocating linear motion in a horizontal plane, is provided with a second cam follower 86 with the free sliding element 64 biased by springs 88 to maintain contact between the second cam follower 86 and the outer cam surface 74.

The cam channel 78 and outer cam surface 74 are arranged so that as a first pick and place apparatus 52 rotates past the preform pick off position 26, the rotation of the rotating carrier 44, combined with the loci of the first and second cam followers 84,86 causes the gripper 58 to be both reciprocatingly extended and retracted, and rotated relative the arm 46. The gripper motion is such that at the approach to the preform pick off position 26, the free sliding element 64 and thus the gripper 58 is extended followed by rotation of the linear guide 54 and gripper 58 in retrograde or negative direction relative to the direction of rotation of the rotating carrier 44.

At the instant a preform 12 arrives at the pick off position 26 after its approximate orientation, so that the handle 20 of the preform is trailing but not yet fixed, the extending movement of the gripper 58 through the first cam follower 84 against the outer cam surface 74, brings the gripper effective axis 68 into coincidence with the central axis of the preform. At this instance also, a pair of opposing actuators located under the pick off position 26 simultaneously briefly close on, and then release, the preform handle 20 to fix its orientation relative the gripper 58 which, also at that instant engages with the neck 18 of the preform. The gripper 58 is then rotated positively to carry the preform 12 clear of the supporting short rail 40 and away from the pick off position 26.

This combination of reciprocating rotation and extension and retraction of the gripper 58 compensates for the divergence of the loci of the supporting tooth formation 38 of the feeder wheel 36 and the rotating carrier 44 as they contra rotate one relative the other. It is by the means of the reciprocating rotation and retraction movements of the gripper through a combination of a rotating linear guide and the two cam loci that a smooth continuous transfer of preforms is possible between two rotating elements; that of the feeder wheel 36 and the rotating carrier 44.

### Loading Into Mandrel Stage

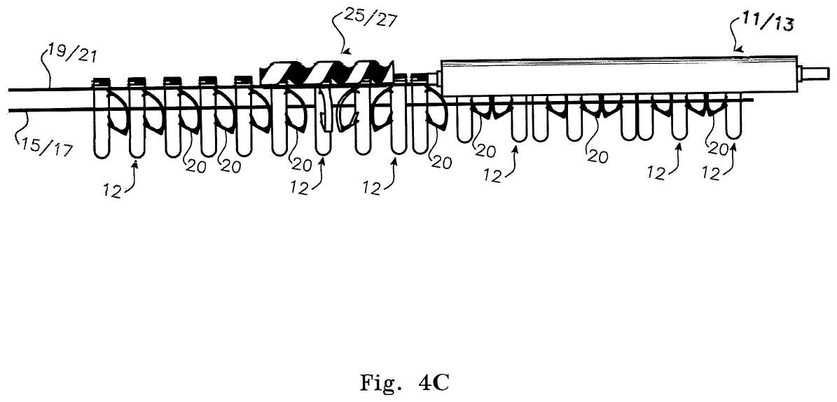

With reference now to FIG. 7, rotation of the rotating carrier 44 brings a preform 12 retained in a gripper 58 to the preheating stage 28 as was shown in FIG. 3 of the machine 10. Because the preheating of the preforms is conducted with the preforms inverted from their initial position at the pick off position 26, that is, with the neck 18 upward, the rotary actuator 60 at the end of the free sliding element 64 rotates the grippers 58 and the preforms through 180 degree during their transit between pick off position 26 and the transfer to a preheating transport system 90. The effect of this rotation is that the handle 20 of the preform is now “leading” with respect to the direction of rotation of the rotating carrier 44, instead of trailing as it was at the pick off position 26 as could be seen in FIG. 5.

The preheating transport system 90 is also in continuous movement and comprises a loop rail system 92 with proximate and distal rotating guide wheels 94 and 96 respectively at either end of the loop. A plurality of preform supporting mandrels 98 are adapted to move around the loop rail system 92, driven into motion around the straight sections of the loop by a drive chain (not shown) to which they are fixed and around the guide wheels 94,96 by nesting in niches 103 of the guide wheels. As well as travelling around the loop rail system 92, the mandrels 98 are continuously rotated about their vertical axes.

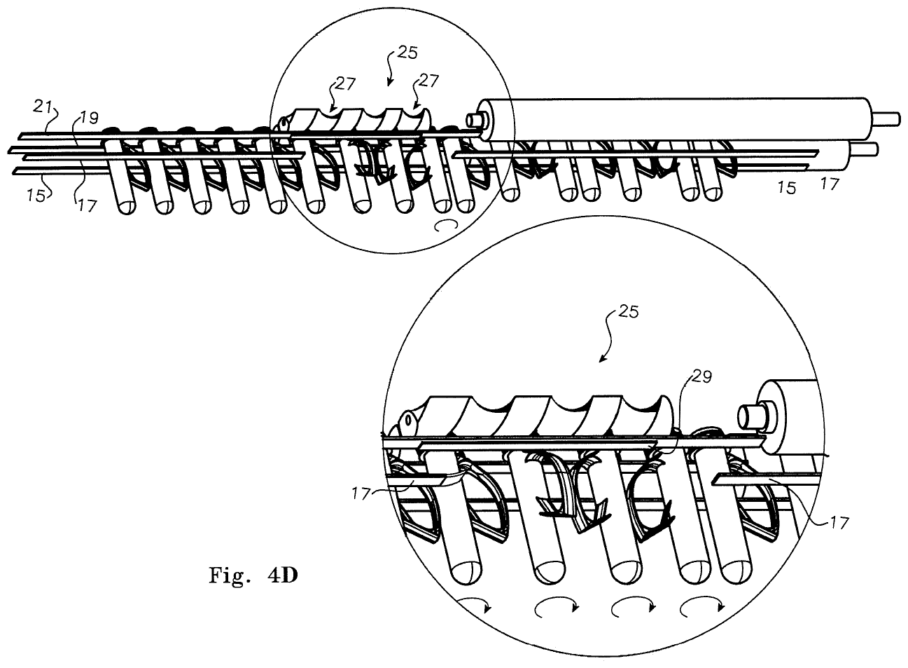

Preheating of the preform 12 is required for the body 16 of the preform, that is for that portion of the preform which will be subjected to stretching and blow-moulding, to sufficiently soften the polymer. But the handle 20 and the neck 18 which retain their as injection moulded form in the blown container shown in FIG. 3, must be protected from excessive heat as the preform moves through the preheating stage. For this reason, as shown in FIG. 8, a preform supporting mandrel 98 is provided with a heat shield 100 comprising a channel 102 rising from a cylindrical collar 104 in which the handle 20 is protected while the neck 18 is protected by its insertion into the cylindrical collar 104 of the mandrel.

It may be noted that the patterns of the outer cam surface 74 and that of the cam channel 78 of the first rotating transfer system 42 as shown in FIG. 5, near the pick off position 26 differ from those at the approach to, and following the preform transfer to preheating position 106. This reflects the difference in movements required of a gripper 58 as it steers the preform into the position in which the vertical axis of the preform becomes aligned with that of the cylindrical collar 104 of the mandrel 98 and the handle 20 is aligned with the heat shield channel 102. At the instant these axes are aligned and the handle 20 of the preform is aligned between the side elements of the channel 102, a cylindrical plunger 108 within the collar 104 rises into the neck 18, then lowers to bring the neck to an inserted position within the collar. These movements of course take place while the first rotating transfer system 42 and the proximate guide wheel 94 are in continuous contrarotation. This complex movement is again made possible by the combination of the rotation of the arm 46 and the rotation and linear movements of the free sliding element 64, and thus of the gripper fingers 66 of the first pick and place apparatus 52.

Thus the transfer of a preform from the gripper of the first transfer system 42 to a preform supporting mandrel 98 is achieved in one fluid motion as the vertical axis of the preform is brought into alignment with that of the mandrel and the oriented handle of the preform slides into the heat shield, while accommodating each of the rotations of the loop rail, the mandrel and the transfer system as well as the movements of the gripper.

### Preheating of Preforms

As best seen in FIGS. 3 and 8, banks 110 of heating elements 109 are positioned along each of the straight sections of the loop rail system 92. Graded hot air 111 is drawn across the path of the preforms 12 by extractor fans 113. To prevent excessive heat build-up of the cylindrical collar 104 and the neck 18 of the preform in the collar, a cooling air stream 115 is directed at the collars.

As a mandrel 98 and preform 12 are rotated away from the transfer-to-preheating position 106 by the proximate rotating guide wheel 94, the mandrels supported in the chain of the preheating transport system 90 travel along the first straight section 112, around the distal rotating guide wheel 96 and back along the second straight section 114 to arrive at a transfer-from-mandrel position 116. While traversing these straight sections, the mandrels are rotated about their vertical axes by a gear 105 of the mandrel engaging with chain 107 to evenly expose the bodies of the preforms to heat from the banks 110 of heating elements 109. The heating elements 109 are each arranged as a series of infra-red heating elements which are individually adjustable as to their proximity to the passing preforms.

It will be understood that the orientation of each mandrel 98 at both the transfer to preheating position 106 and at the transfer from mandrel position 116 is critical to allow the respective first and second transfer systems to insert and extract a preform handle from the channel of the mandrel's heat shield. These heat shield orientations with respect to the periphery of the proximate guide wheel 94 are not the same at these two positions so that the orientation of the mandrel and its heat shield need to be changed from that demanded at the handle extraction position to that required at the handle insertion position.

To this end, each mandrel is provided with a guide carriage 98a fixed to the mandrel. As a mandrel approaches the transfer-from-mandrel position 116, cam followers 98b and 98c engage with guide channels to rotate the mandrel into the required orientation. During transit about the periphery of proximate guide wheel 94, the cam followers 98b and 98c follow cam channels of a cam plate above the proximate guide wheel to bring the orientation of the heat shield to that required at the transfer-to-preheating position 106.

### Transfer to Mould

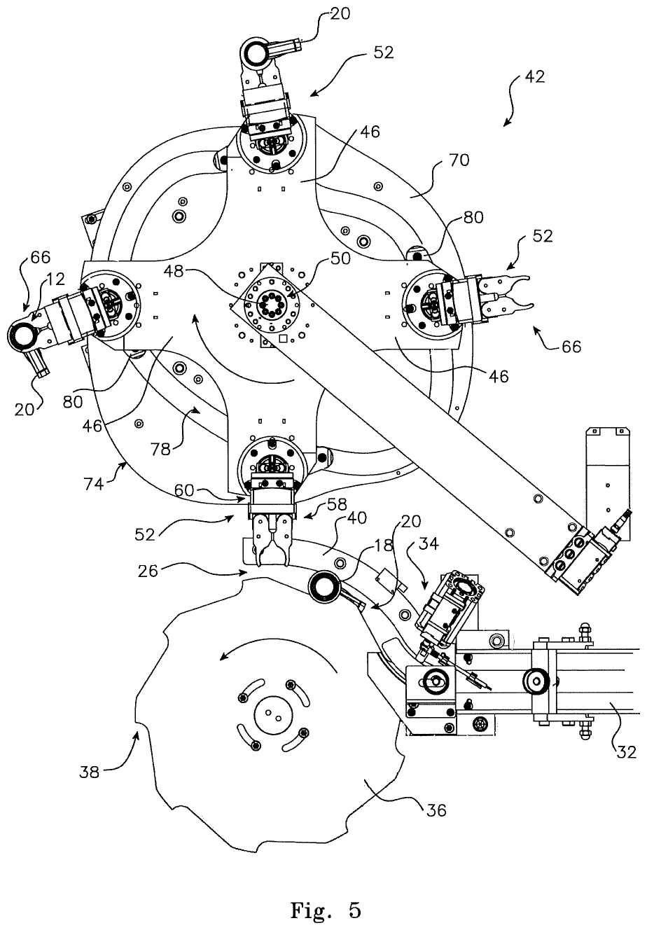

With reference now to FIG. 9, a second rotating transfer system 118 operates to transfer preforms 12 from the preheating transport system 90 to a stretch blow moulding die assembly 120. The stretch blow moulding die assembly 120 comprises of four stretch blow moulding dies 30, two of which can be seen in the truncated view of the machine in FIG. 9. In the present embodiment, four radially disposed stretch blow moulding dies 30 rotate continuously about a common centre 122.

The second rotating transfer system 118 is of similar configuration to that of the first rotating transfer system 42 described above. That is, it includes a cam plate 124, also provided with an inboard cam channel 126 and an outer cam surface 128 around its periphery.

In this instance, second rotating transfer system 118 includes two, rather than four, continuously rotating opposing radial arms 130, each of which carries a second pick and place apparatus 132. Again, similar to the first pick and place apparatuses 52 of the first rotating transfer system 42 above, each includes a linear guide rotatably mounted to the respective outer end of the radial arm 130, with the free sliding element of the linear guide supporting a rotary actuator which, in turn supports a gripper. In this arrangement also, a first cam follower of an outrigger arm attached to the housing of the linear guide, locates in the inboard cam channel 126, while a second cam follower of the free sliding element of the linear guide remains in contact with the outer cam surface 128 by means of a spring.

Preforms still retained in preform supporting mandrels 98 arrive back at the rotating proximate guide wheel 94 of the preheating system and approach the transfer-from-mandrel position 116, and are rotated into the required orientation of the heat shield as explained above. The cylindrical plunger 108 of a mandrel 98 approaching the transfer-from-mandrel position 116, lifts the preform so that the neck is clear of the cylindrical collar 104 to allow the gripper of the second rotating transfer system 118 to engage the preform by the exposed neck 18. Again, it is the motion of the gripper induced by the combination of rotation of the radial arm 130, the rotation of the linear guide and linear movements of the free sliding element supporting the gripper as controlled by the cam channel 126 and outer cam surface 128, which allows the preform and its handle to be smoothly removed from the preheating transport system 90.

As one rotating radial arm 130 of the second rotating transfer system 118 approaches and removes a preform from the preheating transport system 90, the opposite radial arm approaches the die loading position 134. During its rotation from the transfer-from-mandrel position 116 to the die loading position 134, the rotary actuator of the second pick and place apparatus 132 rotates about its horizontal axis to change the preform from its inverted position held during the preheating stage, back into an upright position. (It should be noted that FIG. 9 shows both a rotating arm 130 and a stretch blow moulding die 30 approaching the die loading position 134)

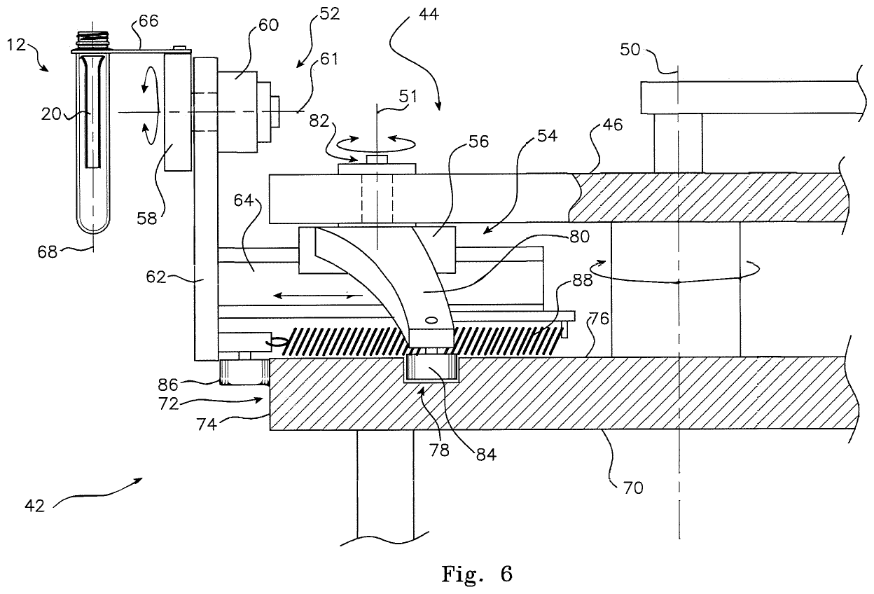

Stretch blow moulding dies of the die assembly 120, are in the form of two die halves 136, one of which is shown in FIG. 10. Die halves 136 are hinged together about a vertical axis 142 in the manner of a bivalve, and with the hinge supported from a central structure 146 of the die assembly 130 in a typical arrangement for radial stretch-blow-moulding machines. The face surface 138 of the die half shown in FIG. 10 has been shaded to highlight the die cavity 148 for the body 16 and integral handle 20 of the preform. As is common in the stretch-blow-moulding of containers, the neck 18, which remains unaltered in the stretch-blow-moulding process, projects out of the die when closed.

Referring again now to FIG. 9, as stretch-blow-moulding dies 30 approach the loading position 134 the die halves open symmetrically about a bisecting radial line 152 passing through the centre of rotation 122 and the vertical axis 142 of the die hinge 144, in preparation for receiving a preform. It may noted from FIGS. 3 and 9, that the rotation centres of the second rotating transfer system 118, the proximate rotating guide wheel 94 of the preheating stage and that of the stretch-blow-moulding die assembly 120, lie along a straight line 154.

As an opened die 30 approaches the die loading position 134 lying on the straight line 154, a radial arm 130 with a preform retained in the gripper of the second pick and place apparatus 132 also approaches the loading position. As the bisecting radial line 152 of the die halves 136 becomes coincident with the straight line 154, the movements of the second pick and place apparatus 132 has brought the gripper effective vertical axis and thus the vertical axis of the preform into coincidence with the axis 156 of the die (as defined by the centre of the preform body when held in the die) and with the handle oriented to lie in the vertical plane defined by the straight line 154. While the die halves close and the paths of the die 30 and the end of the rotating arm 130 begin to diverge, the rotation and extension of the gripper, still holding the neck 18 of the preform, ensures the orientation of the handle is maintained in that vertical plane defined by the bisecting line of the die halves until closure is complete. The gripper then disengages from the preform neck.

It can be seen from FIG. 10, that the curved section of the handle 20 of the preform is nested in a constricting cavity 150 of the die which ensures that the handle is not distorted, nor the region between the junction points 22,24 stretched. The underside of the straight section of the handle forms a surface which, in effect, determines the shape of the container under the handle.

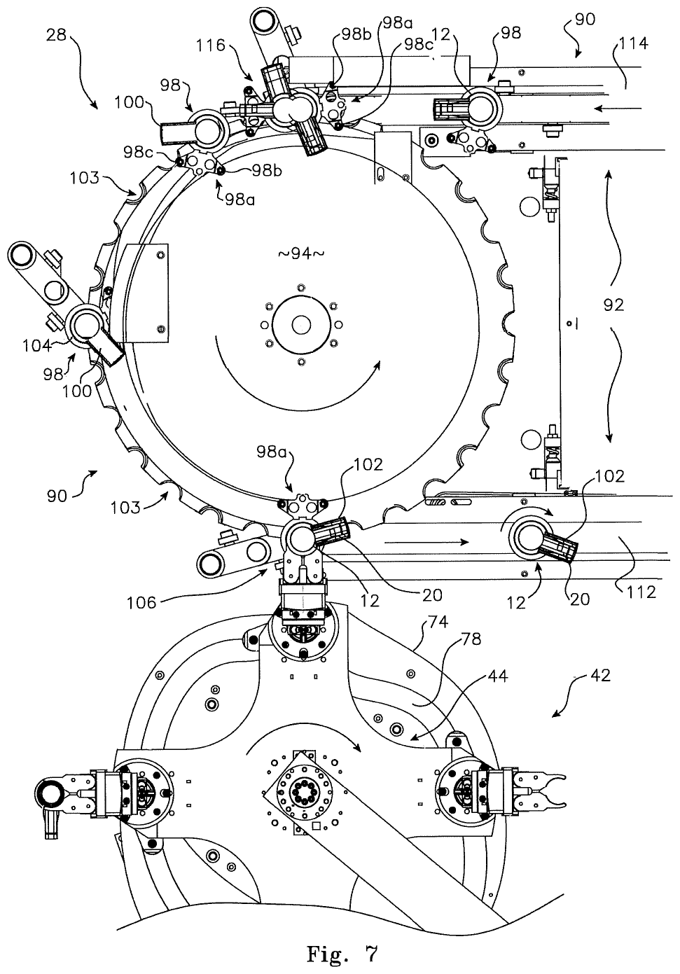

With the die halves 136 closed, stretch-blow-moulding of the container proceeds and the die 30 loaded at the die loading position 134 rotates towards the die unloading position 158 as shown in FIG. 11.

### Container Unloading

A third rotating transfer system 160 is located adjacent the stretch-blow-moulding die assembly 120, and is configured in similar manner to that of the first and second rotating transfer systems 42,132 described above. As for the second rotating transfer system 132, the third rotating transfer system 160 includes opposing radial arms 162 at the ends of each of which is a third pick and place assembly 164. It does not however include a rotary actuator since the container which emerges from the die remains in an upright position through the discharge process.

As for the first and second rotating transfer systems, movements of a gripper 166 is controlled by a combination of the rotation of the opposing radial arms 160, the linear movement of the free element of the linear guide and the two cam loci.

As the stretch-blow-moulding die 30, now containing a finished container 14, nears the die unloading position 158 lying on the line 168 joining the centres of rotation of the stretch-blow-moulding die assembly 120 and of the opposing radial arms 160 of the third transfer system, the gripper of the pick and place is maneuvered into position to grasp the neck of the container. As the die reaches the die unloading position, the die halves open and the gripper extracts the blown container 14 from the die 30.

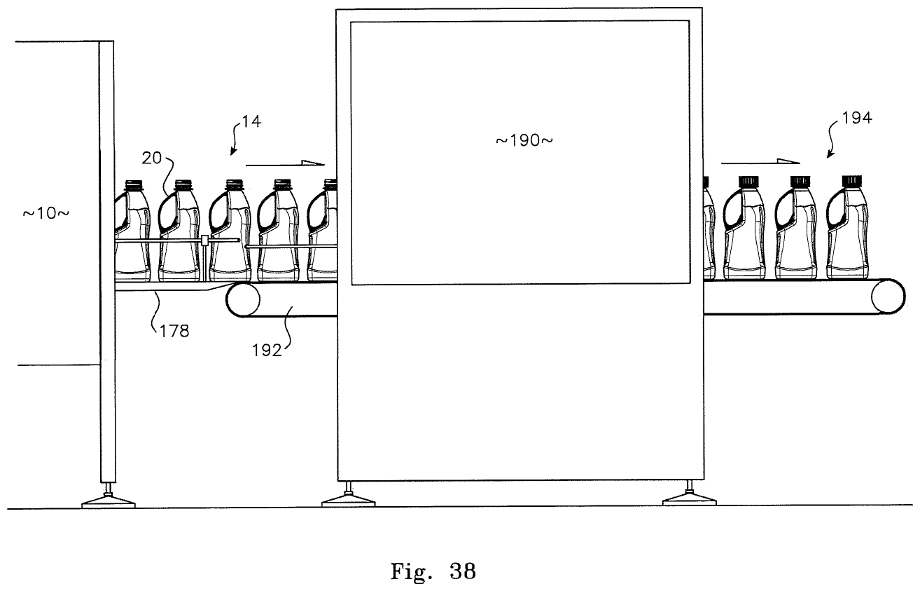

The third rotating transfer system 160 continuous to rotate, taking the container 14 held by the gripper 166 into a discharge channel 172, with the base of the container passing over a guide rail 170. Guide rail 170 transitions from concentricity with the third rotating transfer system to concentricity with a rotating two-tiered outfeed wheel 172. As the container 14, now in the discharge channel 172, reaches a release position 174 lying on the line 176 joining the centres of rotation of the third rotating transfer system 160 and that of the outfeed wheel 172, the gripper 166 releases the neck and retracts. At the same time a scalloped indentation 172a of the rotating outfeed wheel captures the body of the container feeding it into a discharge channel 178. As containers follow the path of the gripper 166 and then a path determined by the outfeed wheel 172, the base of the container receives cooling air from orifices 182 in guide rail 170, backpressure from accumulating containers in the discharge channel 172 force containers to drop into a container receiving bin 180, or in the case of containers being transferred to a filling and capping machine onto a conveyor 178 as shown in FIG. 38.

### Container Filling—First Preferred Embodiment

In each of the following embodiments, the invention provides for the continuous production of filled and capped containers with integral handles, from injection moulded preforms with integral handles, through the interconnection of two, stand-alone machines; continuous stretch-blow-moulding machine described above, and an automatic filling and capping machine.

In an alternative arrangement, blown containers 14 are extracted from a blow moulding die 30 of the stretch blow moulding machine 10 of FIGS. 1 to 12, by the third rotating transfer system 160 as described above, to be moved onto the discharge channel 178, but now discharge channel 178 is in communication with a filling and capping machine 190 as shown schematically in FIG. 38.

In this arrangement, discharge channel 178 is in line with and its surface at the same level as the surface of an infeed conveyor 192 of the filling and capping machine 190. Both the discharge channel 178 and the infeed conveyor 192 have side guides which constrain containers 14 with the known orientation of the handle 20 maintained as it was when first delivered to the discharge channel. Blown containers delivered to the discharge channel 178 by the transfer system 160 forces each leading container onto the infeed conveyor 192.

The infeed conveyor 192 rate of advance and the cycle time of the filling and capping machine 190 are synchronized with the cycle time of the stretch blow moulding machine 10. An escapement (not shown) for example, in the form of contra rotating timing screws, along the infeed conveyor may be adapted to ensure the required spacing between advancing containers for alignment with multiple filling nozzles and the capping mechanism of the filling and capping machine.

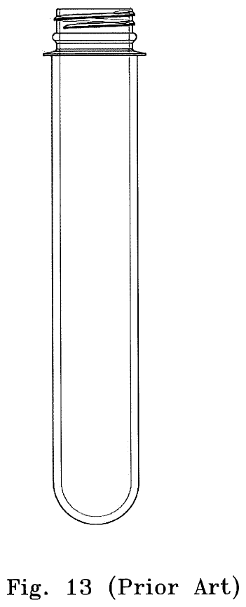

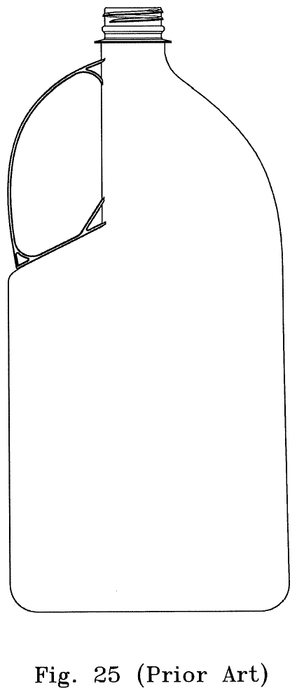

Although in the case of the particular containers shown in FIG. 17 or 28, the handle does not project significantly, if at all, beyond the footprint of the body of the container, the filling and capping machine 190 must be adapted, and the handle 20 orientation controlled, prior to entry into the filling line so that none of the filling and capping equipment interferes with the container's movements through the machine 190.

There is thus a continuous transfer of containers, stretch blow moulded from injection moulded preforms with integral handles, between the continuously rotating stretch-blow-moulding machine 10 and the filling and capping machine 190, in which an orientation of the integral handle 20 is controlled from entry of a preform into the stretch blow moulding machine to emergence of filled and capped containers 194 from the filling and capping machine.

### Container Filling—Second Preferred Embodiment

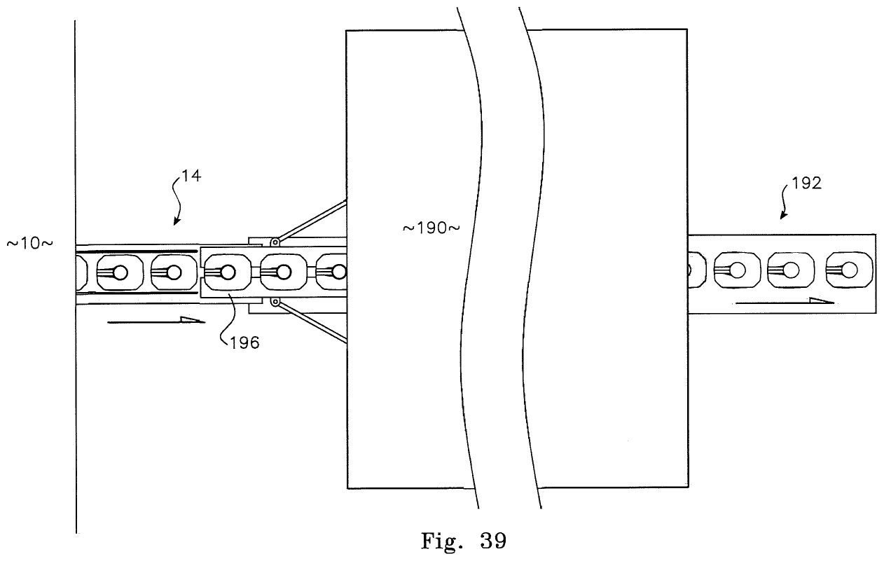

In this arrangement, as shown in FIG. 39, of blown containers 14 transferring from the continuously rotating stretch blow moulding machine 10 to an automatic filling and capping machine 190, the filling and capping machine is again arranged with its container infeed in line with, and at the same level as, the discharge channel 178 of the stretch blow moulding machine 10.

In this embodiment however the filling and capping machine 190 transports containers through the filling and capping stages by means of a “walking beam” mechanism 196. Preferably, the walking beam, (in this configuration a pair of side-by-side elements with opposing nests) projects sufficiently far from the filling and capping machine 190 to overlap an end of the discharge channel 178 allowing “capture” by a first nest of the walking beam of each successive blown container which has progressed to the end of the discharge channel 178. The nests of the walking beam are shaped to closely confine the blown containers so that, again the orientation of the handle is maintained, and the spacing of the containers conforms to the spacing between filling nozzles and the capping mechanism.

### Container Filling—Third Preferred Embodiment

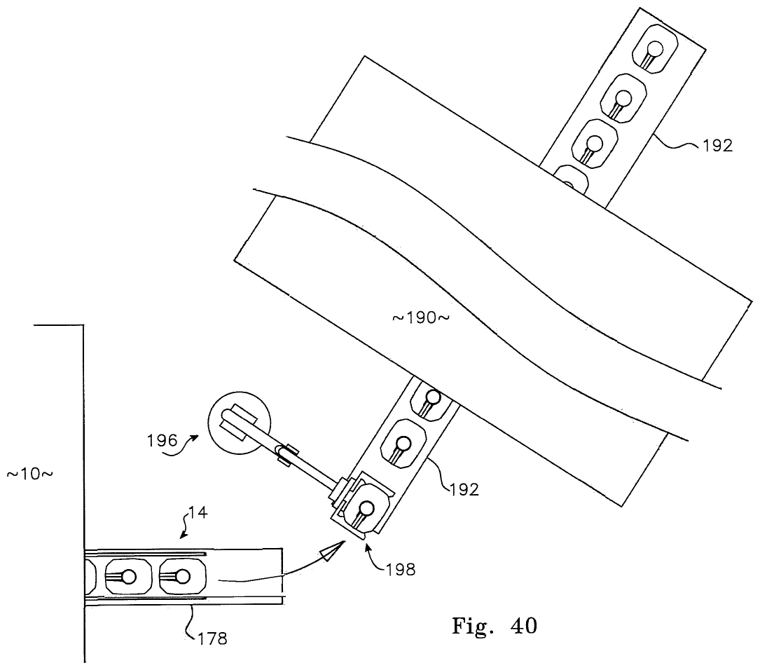

It may not feasible or practicable to have the discharge channel 178 of the stretch blow moulding machine 10 and an entry conveyor 192 of the filling and capping machine 190 at the same level and in line to allow a simple transfer from the one machine to the other. In this embodiment, as shown in FIG. 40 a relatively small industrial robot 196 is positioned at an intermediate area between the discharge channel 178 and the entry conveyor 192 of the filling and capping machine.

In this case, the discharge channel 178 and end of the entry conveyor 192 need not be in-line, nor at the same level or even in close proximity; as long as the separation is within reach of the robot 196.

Again, it may be imperative, given the internal configuration of the filling and capping machine 190, that in the transfer of a container with a known handle orientation at the end of the discharge channel, that orientation is maintained, or at least establishes an orientation reference for the robot's placing the container in a desired orientation on the entry conveyor. The robot end effector is fitted with a gripper 198 which grasps each container and is shaped to retain the container in the orientation in which it has emerged from the stretch blow moulding machine.

The accuracy of placement and timing inherent in the programming of an industrial robot ensures both the cycle time and spacing of containers on the infeed conveyor of the filling and capping machine is correct for the cycle times of both the stretch blow moulding machine and the filling and capping machine.

### Container Filling—Fourth Preferred Embodiment

In this further embodiment, there is again a transfer between the stand-alone stretch-blow-moulding machine 10 and a stand-alone filling and capping machine 190, but in this instance the orientation of the blown container as emerging from the stretch-blow-moulding machine may not be that desired for passage through, and emergence from, the filling and capping machine.

The orientation of the handle as oriented on emergence from the stretch-blow-moulding machine may interfere with internal structures of the filling and capping machine, or a particular surface of the container may need to be presented after the filling and capping for the purpose of application of a label.

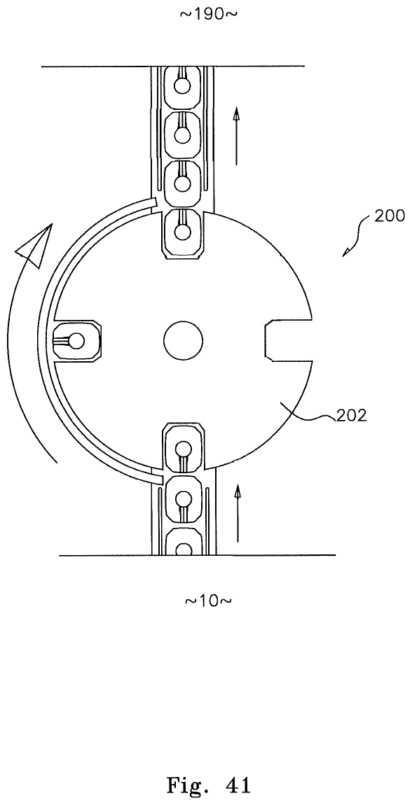

Thus, in this embodiment, a re-orientation device 200 is situated at either an intermediate position as shown in FIG. 41, or at the discharge channel of the stretch-blow-moulding machine, or again, at the infeed of the filling and capping machine.

The re-orientation device may be in the form of a number of alternative orientation mechanisms. For example, containers emerge from the stretch-blow-moulding machine with handles trailing, as shown in FIG. 38, but for either of the reasons suggested above, may need to pass through and emerge from the filling and capping machine with the handle leading. In this case, containers may be received from the stretch-blow-moulding machine into nests of a rotating star wheel 202 as shown in FIG. 41, to be rotated 180° for entry into the filling and capping machine 190.

Where it is desired to rotate the container so that the handle is at 90° to the direction of travel through the filling and capping machine, containers would remain on the star wheel (rotating either clockwise or anticlockwise) for 90° to then be extracted to enter into a guided channel and conveyor to the infeed of the filling and capping machine.

### Container Filling—Fifth Preferred Embodiment

In yet a further embodiment, the two machines are separated sufficiently to accommodate a buffering area in which blown containers may accumulate in the situation where a hold up occurs in the filling and capping machine. In this arrangement, containers emerging from the stretch-blow-moulding machine may not directly enter the filler and capper, but are pressure fed onto a broad conveyor, narrowing proximate the infeed of the filler and capper. At this point they may enter nests of a star wheel, be captured between the contra rotating helixes of a timing screw, or the trailing nest of a walking beam mechanism to be accepted into the filler and capper.

In each of the container filling embodiments described above, a bridging enclosure (not shown) is tailored to enclose the space between the two machines. Filtered and sterilized air is fed into the enclosure at sufficient volume and pressure to maintain air pressure within the enclosure at somewhat higher air pressure than ambient pressure pertaining in the environment in which the two machines operate. By this means any introduction of contaminants into the open necks of the blown containers is prevented.

### Control of the Machine

The operation of the machine 10 is under the control a programmable logic controller. As well as ensuring that all rotation drive servo motors operate synchronously, the controller provides for fully adjustability of the parameters of the preheating elements and of the parameters of the stretch-blow-moulding dies. This includes setting differential temperature gradients allowing for a gradually increasing exposure to heat as preforms progress around the preheating transport system, and automatic adjustment of heating element temperatures for changing ambient temperatures.

Control of the preheating is particularly critical in the present system because of the unique characteristics of the preform dictated by the integral handle of the preform. The preheating is thus designed to allow for lateral flow of material in the area between the two junction points of the handle while limiting longitudinal flow and extension during the stretching phase of the stretch-blow-moulding process. Instead, the manner in which heat is applied to the preform ensures that the bulk of polymer which forms the outer shell of the container of FIG. 2, is produced from that region of the preform below the lower junction point of the handle.

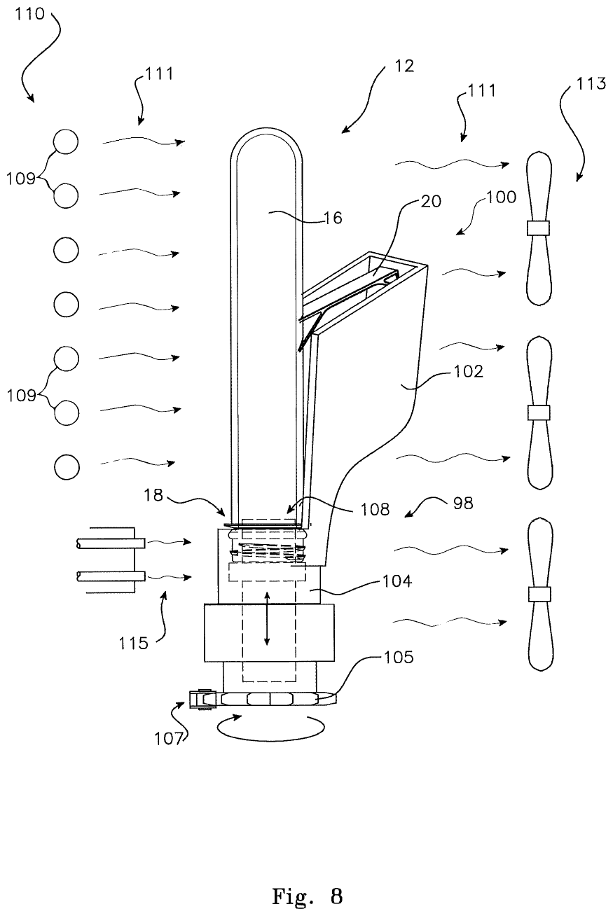

FIG. 12 is a schematic block diagram of control components associated with control of the heating and transport of the preforms usable with any of the above described embodiments.

As best seen in the inset of FIG. 12, banks 110 of heating elements 109 are positioned along each of the straight sections of the loop rail system 92. Graded hot air 111 is drawn across the path of the preforms 12 by extractor fans 113. To prevent excessive heat build up of the cylindrical collar 104 and the neck 18 of the preform in the collar, a cooling air stream 115 is directed at the collars.

In a preferred form each bank 110 comprises a module 201. The modules 201 are arranged sequentially around the conveyer 202 as illustrated in FIG. 12.

In a preferred form a processor 203 in conjunction with memory 204 executes a program for control of the heating elements 109 of the modules 201.

In a particular preferred form each element 109 of each module 201 is controlled individually by the processor 203.

In an alternative preferred form the elements 109 are controlled as a group based on height—so the top most elements 109 of the modules 201 are controlled to a predetermined temperature together whilst the next down in height elements 109B are also controlled together to a predetermined temperature—and so on down to elements 109G at the lowest level.

In addition the processor 203 controls the speed of rotation of motor 205 in order to control the continuous speed of the preforms 16.

A temperature sensor 206, in one form an infrared temperature sensor provides environment temperature sensing which is utilised by processor 203 to modulate the degree of heating of all elements 109 by a difference factor delta (4).

This allows for a global control of the system temperature in response to variations in ambient temperature.

As noted above, the stretch-blow-moulding machine is especially developed for, and adapted to, the feeding and transportation of a non-symmetrical preform with integral handle and, ultimately the stretch-blow-moulding of that preform into a container with an integral handle. The preform according to the invention may take a number of different forms described below, although common to all are the neck portion 18 and the integral handle 20 as shown in FIG. 1.

The preforms now to be described differ primarily in respect of the configuration of their internal surfaces, offering benefits of improved distribution of polymer material to the walls of the blown container as well as significant improvement in economy of manufacture due to reductions in the volume of polymer required.

### First Preferred Non-Symmetrical Preform Embodiment

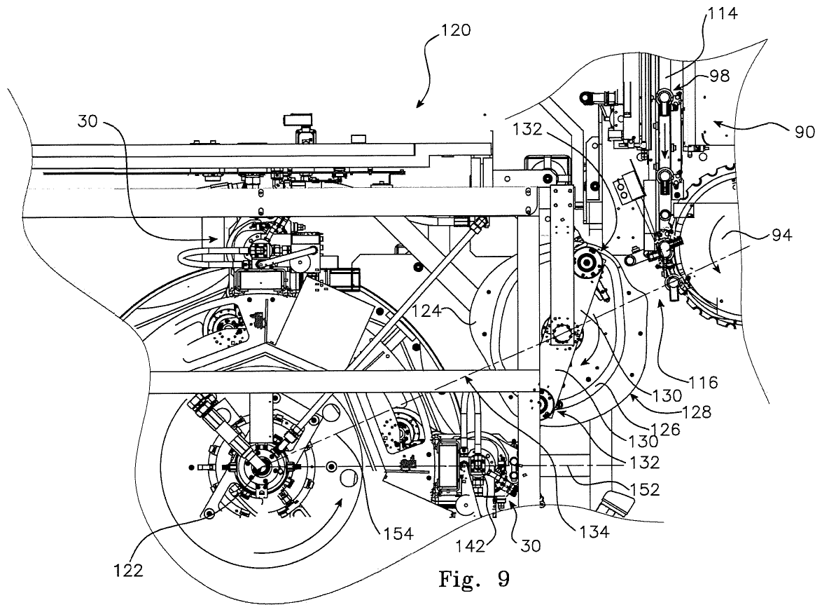

In a first preferred embodiment a preform 310 according to the invention as shown in FIG. 13A includes a finished neck portion 312 and a tubular hollow body portion 314 extending from below the neck portion. Similar to preforms of the prior art, the outer surfaces of the body portion 314 are defined by diameters centred on a central vertical axis 316, so that the body portion 314 approximates a cylinder but with a decrease in diameters from the neck portion 312 to the closed end 318 of the preform.

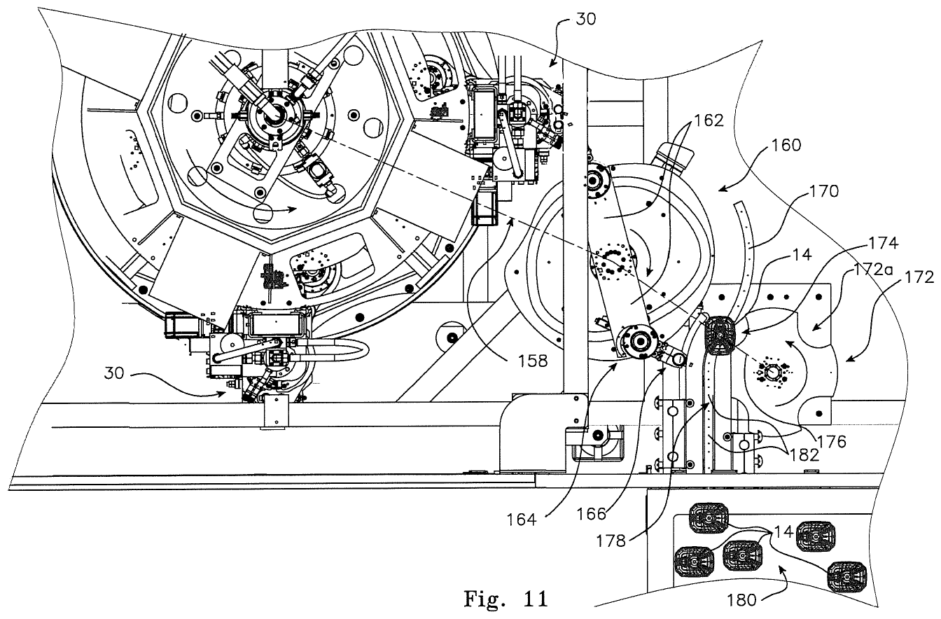

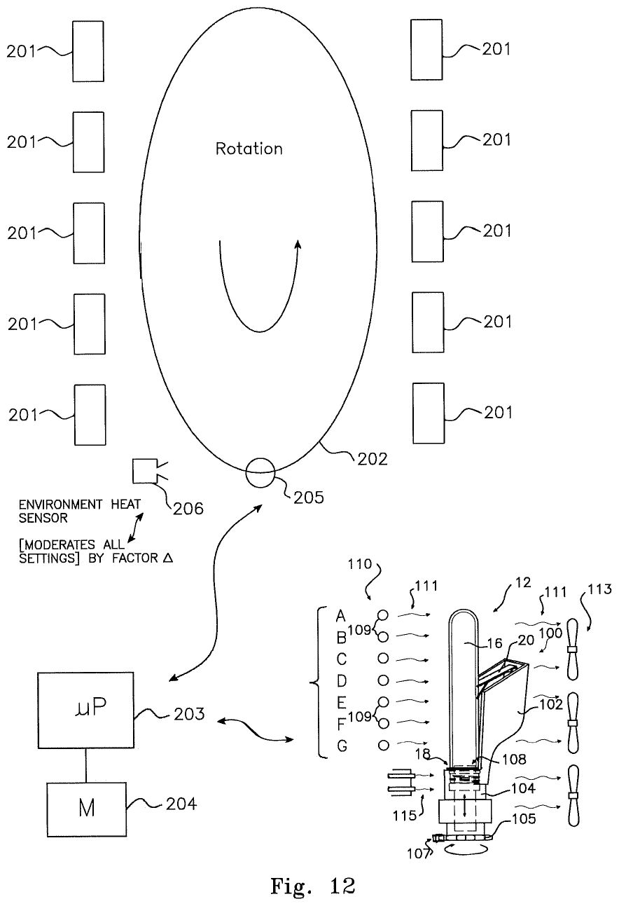

The internal surfaces of the preform 310 include surfaces of the hollow body portion 314 which are not concentric with the outer surfaces. Preferably, as shown in FIGS. 15 and 16, cross sections of the internal surfaces of the preform 310 are circular and concentric in the neck portion 312 of the preform as indicated by the cross-section A-A, but below the neck portion are of ovoid form as indicated by section B-B. All sections are however centred on the central longitudinal axis 316 of the body of the preform.

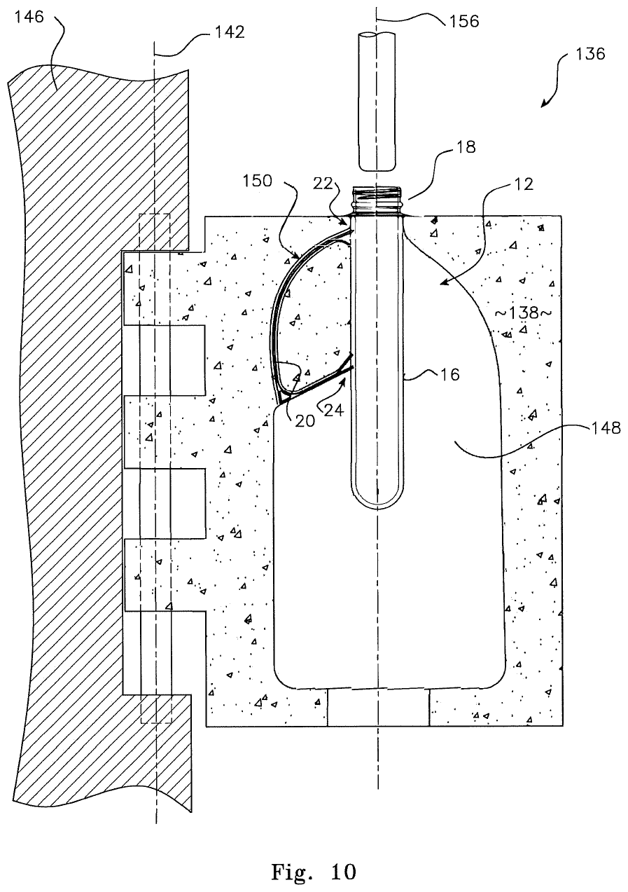

Referring now to FIG. 14, in a preferred arrangement, the mandrel 322 around which the preform 310 is injection moulded, comprises an upper region 324 of circular cross sections adapted to position and retain the mandrel in its correct position in an injection moulding cavity. A first preform-defining portion 326 of the mandrel extends from this upper region 324 to a depth equal to that of the neck portion 312 and is of circular cross section A-A as shown in FIG. 4 to form the concentric walls of the neck portion. The ovoid portion 328 of the mandrel depends from the first portion 326, extending to the tip 330 of the mandrel.

Given the ovoid shape of the cross sections of the ovoid portion 328, there is a short transition portion of the mandrel immediately below portion 326 forming the internal form of the neck portion, which transitions from the circular cross section A-A of portion 326 to the ovoid sections B-B. This transition thus takes the form an asymmetrical frustum of a cone; an upper end of which has a diameter equal to that of a lower end of the first portion 326 with the lower end of the transition portion conforming in cross section to the upper end of the ovoid cross section B-B of the remaining length of the preform.

It can be seen from FIG. 13A, that both the outer surfaces of the body portion 314 of the preform and the ovoid portion of the inside surfaces as defined by the mandrel 322, are tapering; that is, the diameters defining the external surface of the preform are decreasing from below the neck portion 312 to the bottom 318, while similarly, the major axis 344 and the minor axis 342 of the cross sections of the ovoid portion 328 also decrease accordingly.

Referring still to FIG. 13A, the preform 310 of the invention further includes, as noted above, an integral handle 334 which forms a loop of material extending vertically from an upper junction 336 below the neck portion 312 to a lower junction 338 with the outer surface of the preform. The handle 334 is centred on and defines a central vertical plane 340 (lying in the plane of the paper) which contains the central longitudinal axis 316 of the preform.

The mandrel 322, and thus the internal surfaces of the ovoid portion 328, are so oriented relative the handle 334, that major axis 344 of the ovoid cross section B-B lies in the central vertical plane 340.

It can thus be seen from FIG. 16 and cross section B-B that the wall thicknesses of the preform 310 in that portion 328 of the preform in which the inner surfaces are defined by the ovoid cross section, varies from a maximum at opposite ends of the minor axes 342 of the ovoid cross section to minimum thicknesses at outer ends of the major axis 340. Preferably, the ratio of maximum wall thickness to minimum wall thickness of the ovoid portion lies in the range of 2:1 and 2.2:1.

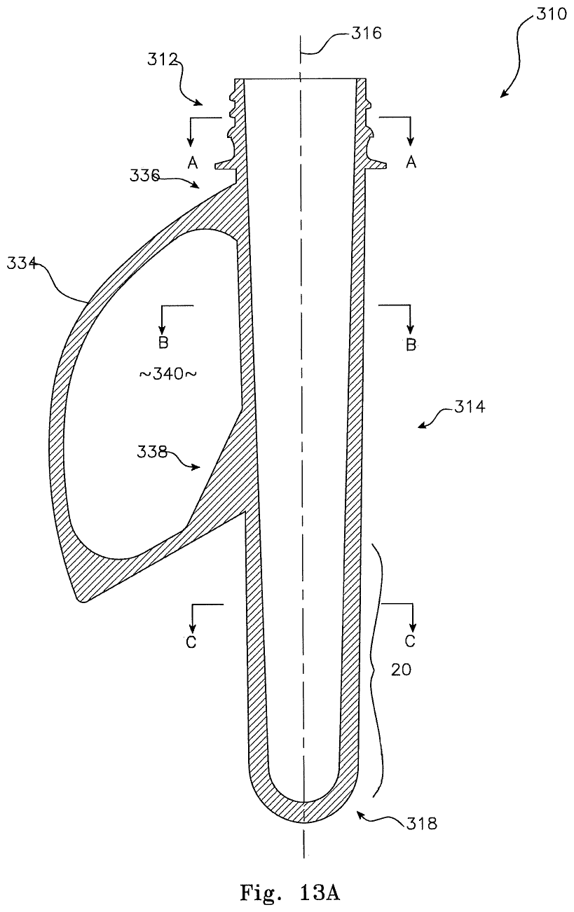

The distribution of polymer in the preform according to the invention, afforded by the non-symmetry of the ovoid portion, allows polymer walls of the preform in the region of maximum thickness to be biased predominantly towards the longer side walls 346 of a rectangular cross section blown container 348, while the polymer walls of the preform from the region of minimum thickness is predominantly distributed towards the shorter side walls 350 of the blown container such as shown in FIGS. 17 and 18. It can be seen from FIGS. 17 and 18 that the longer side walls 346 lie on either side of the central vertical plane 340 and thus the handle 334 so that the alignment of the major axis 344 with the vertical plane 340 ensures that the polymer from regions of maximum wall thickness are directed to those longer side walls. In preferred forms the preform of the first embodiment is produced by an injection moulding process as described earlier in this specification. In preferred forms the preform thus produced is reheated and blown on a continuously rotating, non-symmetric preform feed, stretch-blow-moulding machine as described earlier in this specification.

### Second Preferred Non-Symmetrical Preform Embodiment

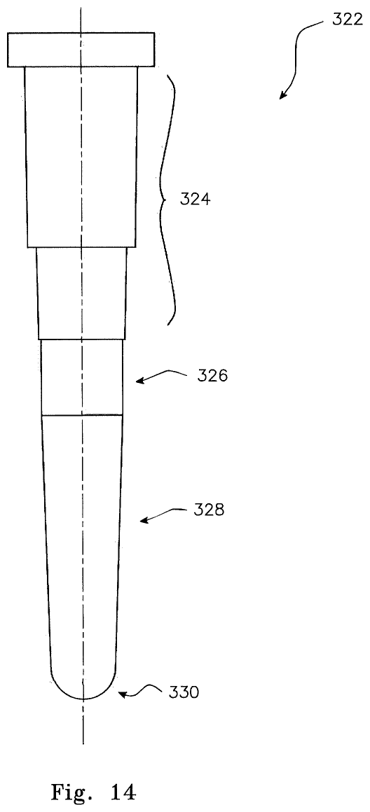

With reference now to FIG. 19, in this preferred embodiment, the exterior surface 410 of the preform 400 of this embodiment, is of substantially cylindrical form. As for the first embodiment above, it too includes an integrally injection moulded handle 434. In this embodiment, the internal surfaces 414 of the preform are consistently circular in section as shown in the two sample cross sections FIG. 17A and FIG. 17B. However, again as is clear from the two cross sections and the sectioned side view of FIG. 17, there is a tapering of the internal surface 414 so that the wall sections, though concentric to the external surface, increase from a minimum thickness at the neck portion 412 of the preform to a maximum proximate its lower end 418. In preferred forms the preform of the second embodiment is produced by an injection moulding process as described earlier in this specification. In preferred forms the preform thus produced is reheated and blown on a continuously rotating, non-symmetric preform feed, stretch-blow-moulding machine as described earlier in this specification.

### Third Preferred Non-Symmetrical Preform Embodiment

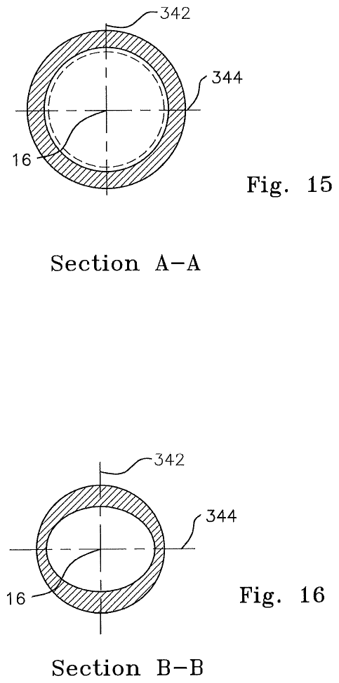

In this further preferred embodiment of the invention, a preform 500 as shown in FIG. 20, is formed to significantly reduce the volume of material required to produce the containers shown in FIGS. 17 and 18. As in the embodiments above, the preform 500 includes an injection moulded integral handle 534. Although in this embodiment, the neck portion 512 is identical in its exterior and internal forms to that of the earlier embodiments, there is a substantial reduction in the diameter of the substantially cylindrical portion of the body of the preform below the neck portion.

In this embodiment also, as in the second preferred embodiment above, the internal surfaces of the preform are consistently circular in section as shown in the two sample cross sections A and B of FIGS. 20A and 20B, but taper with the wall sections increasing from the minimum thickness obtaining in the neck portion and through the transition in diameters below the neck portion, to a maximum wall thickness proximate the lower end 518 of the preform.

As a further means of reducing the volume of material in the preform of this embodiment, the outer surface 510 below the neck portion 512, also tapers towards the lower end 518. In preferred forms the preform of the third embodiment is produced by an injection moulding process as described earlier in this specification. In preferred forms the preform thus produced is reheated and blown on a continuously rotating, non-symmetric preform feed, stretch-blow-moulding machine as described earlier in this specification.

### Fourth Preferred Non-Symmetrical Preform Embodiment

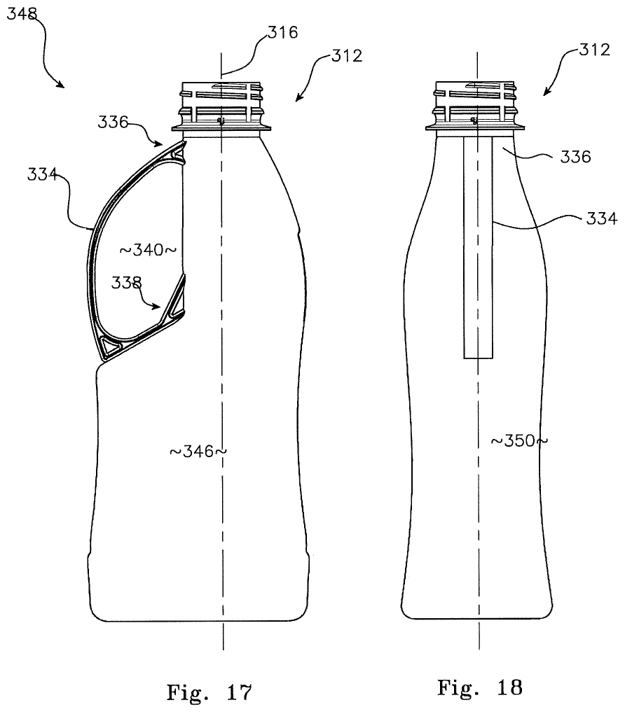

With reference now to FIG. 21, this preferred embodiment of a preform 600 according to the invention, shares a number of characteristics with that of the first and second preferred embodiments above. It has, (as have all the preform embodiments of the present invention), an integral handle 634 as previously described, and, as in the first preferred embodiment above, the internal surfaces 614 of the preform are not consistently of circular section throughout the length of the preform. However, the external surfaces 610 of the perform are substantially cylindrical in form as in the second preferred embodiment.

Thus, although the external surfaces 610 are defined by circular cross sections, the internal surface 614 varies from circular in cross section from the neck portion 612 down to section A-A in FIG. 21A, to then transition to an ovoid section B-B as shown in FIG. 21B, approaching the lower end 618.

A feature of this particular embodiment is that the wall thickness of the ovoid portion of the internal surface 614 of the perform at the ends of the major axes remains constant with the wall thicknesses of the concentric cross sections from section A-A and upwards, while there is a thickening of the walls increasing to maximum at the minor axis of the ovoid cross section. In preferred forms the preform of the fourth embodiment is produced by an injection moulding process as described earlier in this specification. In preferred forms the preform thus produced is reheated and blown on a continuously rotating, non-symmetric preform feed, stretch-blow-moulding machine as described earlier in this specification.

### Fifth Preferred Non-Symmetrical Preform Embodiment

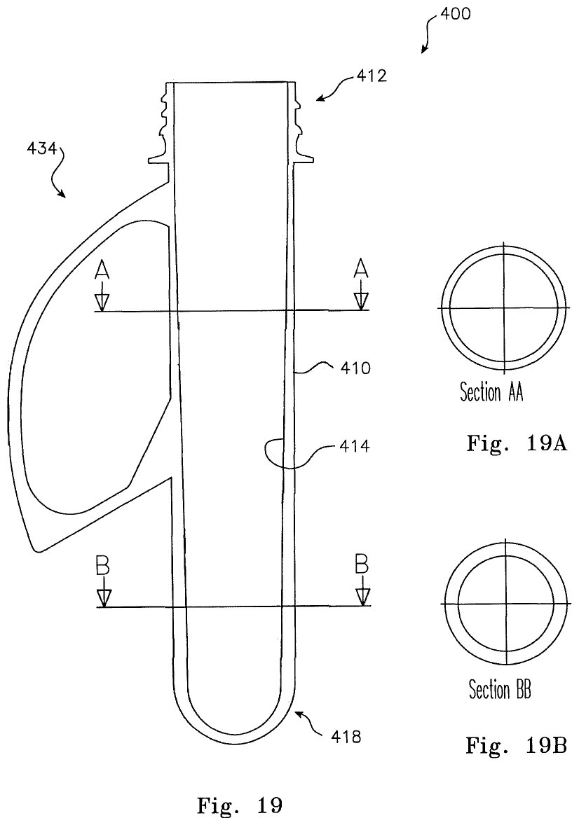

The preform of this embodiment of a preform 700 shown in FIG. 22 is similar to that of the fourth preferred embodiment above, but here, as shown in the cross section views A-A and B-B of FIGS. 22A and 22b, the wall thickness at the outer ends of the major axes of the ovoid cross section portion of the preform is not maintained equal with the wall thickness of at and below the neck portion 712. Rather the wall thickness gradually increases from below the neck portion towards the lower end 718 of the preform.

It may be noted at this point, that in those forms of the perform as in this embodiment and that of the first preferred embodiment above, shaping the internal surface in these non-concentric forms of outer and inner surfaces, introduces considerable issues for the injection-moulding of the preforms.

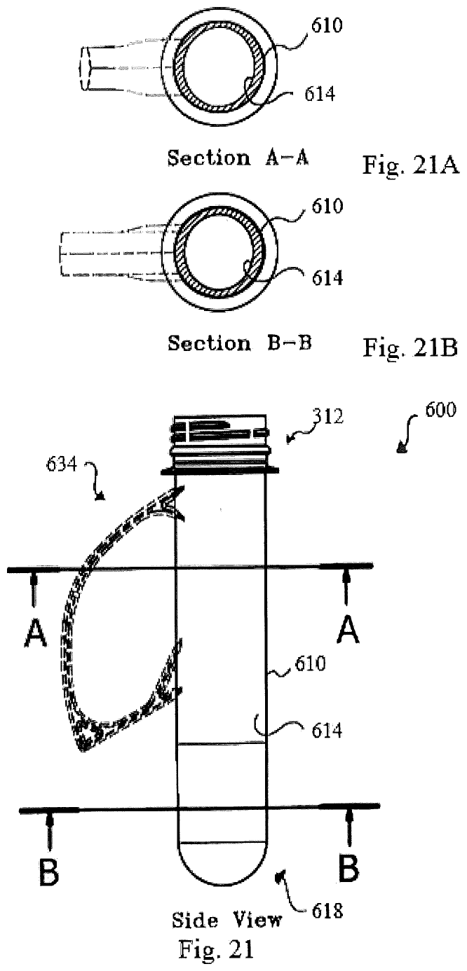

As shown in FIG. 24, preforms, including those of the present invention, are typically injection moulded in multi-cavity dies 800 in which the cavities 820 in the die conform to the outer shape of the preform, including in the present cases, the shape of the integral handle. In preforms with concentric wall thicknesses, that is, with circular cross sections, the mandrels 840 for forming the internal surfaces will also be of circular cross sections. Thus, the only requirement for positioning such a mandrel relative the injection-moulding cavity is its concentricity with the neck portion of the cavity.

A mandrel for producing an internal surface of a perform which is wholly or partially non-circular in section may firstly require, a considerably more complex machining operation and, secondly it must be specifically oriented in the injection-moulding cavity.

Mandrels for preforms with non-circular cross sections must be positioned within the cavities of an injection-moulding die 820, one half of which is shown in FIG. 24 so that the major axes of the ovoid portion are aligned relative to a vertical central plane of the cavities. For preforms according to the present invention with integral handles, that vertical plane is the plane on which the handle of the preform is centred as set out above (in effect the face 842 of the die half).

To be effective in biasing polymer material flow from different wall thickness areas of the preform towards designated regions of the blown container, the orientation of the preform must be maintained in the cavity of the stretch-blow-moulding machine. That is, the vertical plane of the preform must coincide with a defined vertical plane of the container. In the present invention the vertical plane of the preform is defined by the integral handle and is made coincident in the stretch-blow-moulding cavity with the central vertical plane of the blown container which again is central to the integral handle of the container.

In a moulding cycle, the die halves are brought together to close the die and the array of mandrels 840 driven into the cavities 820. The injection nozzle 848 is then advanced into the injection pocket 844 and molten polymer forced through the runner system 846 to fill the spaces between the external surfaces of the cavities 820 and the mandrels 840 to produce the preforms.

Although the above description has focused in some embodiments on use of ovoid or offset cross sections to vary the wall thicknesses of at least a portion of a preform at any given cross section of that portion, it will be understood that such variation can be achieved with other non-concentric shaping of the mandrel. Again, although the ovoid cross sections described for the preferred embodiment are centred on the vertical axis of the preform, other material distribution effects may be achieved by an asymmetric positioning of these cross section. In preferred forms the preform of the fifth embodiment is produced by an injection moulding process as described earlier in this specification. In preferred forms the preform thus produced is reheated and blown on a continuously rotating, non-symmetric preform feed, stretch-blow-moulding machine as described earlier in this specification.

### Sixth Preferred Non-Symmetrical Preform Embodiment

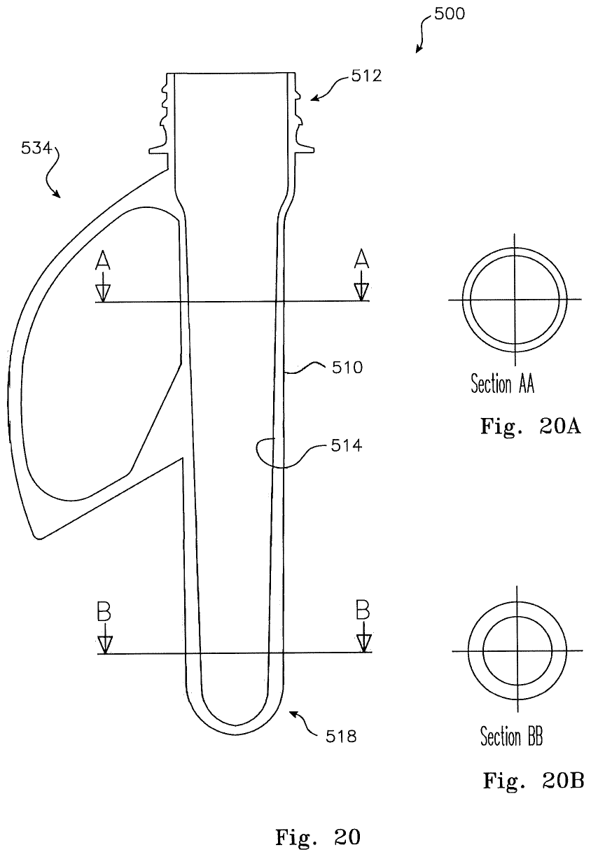

This further preferred embodiment of a preform according to the invention and shown in FIG. 23, the preform 900 is provided with a wall thickness 911 in the region between the junction points 936 and 938 of the integrally injection-moulded handle 934 specifically to optimise control of the material in this region in the stretch-blow-moulding stage of producing a container from the preform.

In this embodiment, the external surface 910 of the preform is again substantially cylindrical. The internal surface 914 of the preform is likewise formed of circular cross sections, but as can be seen in both the side sectioned view of FIG. 23A and cross section AA of FIG. 23A, the centres of a portion of the cross sections (typified by section A-A) do not lie on the central axis 930 of the body of the preform, but are offset towards the handle 934.

The effect is to “thin” the wall thickness in the region between the junction points 936 and 938 of the handle. This is possible and desirable, because firstly there is a lesser volume of material required to form the container since there is no longitudinal stretching of this region and, secondly the thinning provides a significant cost saving in material.

It will be understood that all the above embodiments of the preform seek to optimise both the distribution of the polymer material of the preform into the blown container and do so by reducing the weight and thus the volume of material for reasons of economy of production. In preferred forms the preform of the sixth embodiment is produced by an injection moulding process as described earlier in this specification. In preferred forms the preform thus produced is reheated and blown on a continuously rotating, non-symmetric preform feed, stretch-blow-moulding machine as described earlier in this specification.

### Seventh Preferred Non-Symmetrical Preform Embodiment

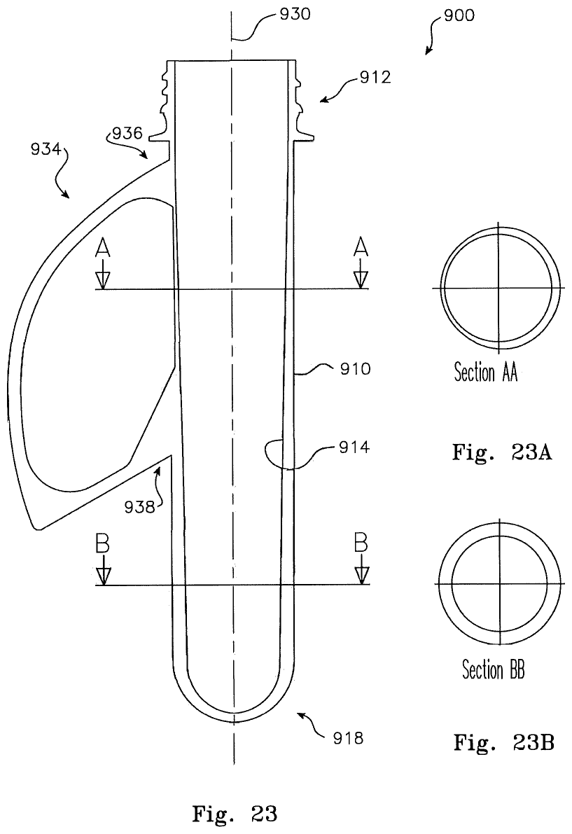

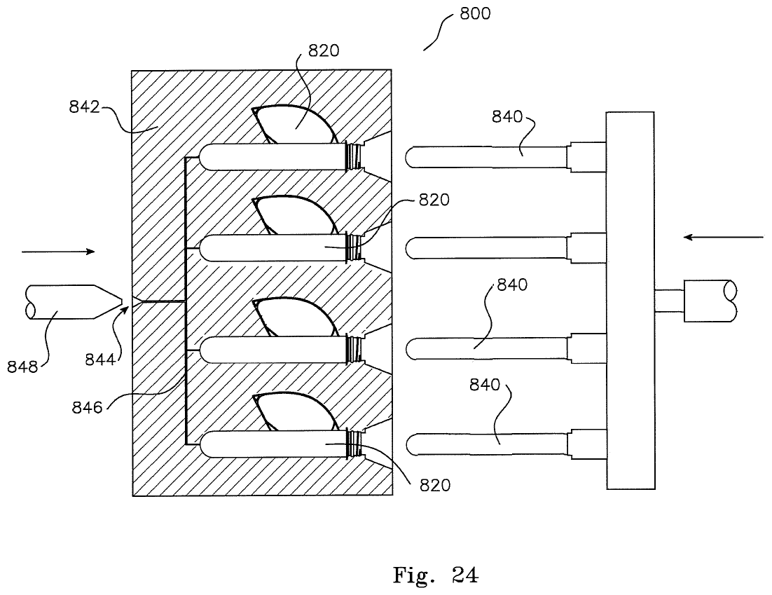

With reference to FIGS. 26 and 27, a preform 1000 for stretch-blow-moulding the container 1040 shown in FIG. 28, is comprised of a neck portion 1012, a collar 1014 and a body 1016 extending from below the collar. As in the preform according to prior art shown in FIG. 1, the preform 1000 includes an integral handle 1018 joined to the body 1016 at first junction position 1020 just below the collar 1014 and a second junction position 1022 along the length of the body.

The first cylindrical portion 1024 of the body extending below the collar 1014, is substantially of constant diameter, and in the region immediately below the collar, the diameter is substantially that of the finished container as can be seen in FIG. 28.

But it can be seen firstly from a comparison between the preform 1000 according to the present invention, and the preform of the prior art, that there is a significant reduction in diameter of the body 1016 below the first cylindrical portion 1024.

Furthermore, it is clear that this second portion 1026 of the body, between the reduction in diameter and the tangent line 1028 with the bottom portion 1030, is not cylindrical but forms a portion of a narrow cone, with the base diameter 1030 of the cone, that is its largest diameter, significantly smaller than the diameter of the first cylindrical portion 1024. Thus, this large reduction in diameter and the tapering provide a first significant reduction in the volume of PET contained in the preform of the invention.

Turning now to the cross-section view of FIG. 27, the walls of the body 1016 of the preform 1000, vary considerably in thickness. While the wall thickness of the neck portion 1012 and the first portion 1024 below the collar 1014 are substantially of a constant thickness, that of the second portion 1026 varies from a relatively thin wall section at the base diameter 1030, to a maximum thickness proximate the tangent line 1028.

The wall thickness of the bottom portion 1032 is further varied, being reduced from the maximum thickness at the tangent line 1028 to a minimum at the base of the bottom portion.

This thinning of the wall thickness in the region below the maximum diameter 1030 of the second portion 1026, augments the reduction in material volume provided by the diameter reduction and the form of the second portion 1026.

As well as providing savings in material volume, these variation in wall thicknesses are designed to evenly distribute the volume of PET material to various areas of the walls of the stretch-blow-moulded container 1040 shown in FIG. 28, to an average thickness of approximately 0.5 mm. In preferred forms the preform of the seventh embodiment is produced by an injection moulding process as described earlier in this specification. In preferred forms the preform thus produced is reheated and blown on a continuously rotating, non-symmetric preform feed, stretch-blow-moulding machine as described earlier in this specification.

### Eighth Preferred Non-Symmetrical Preform Embodiment

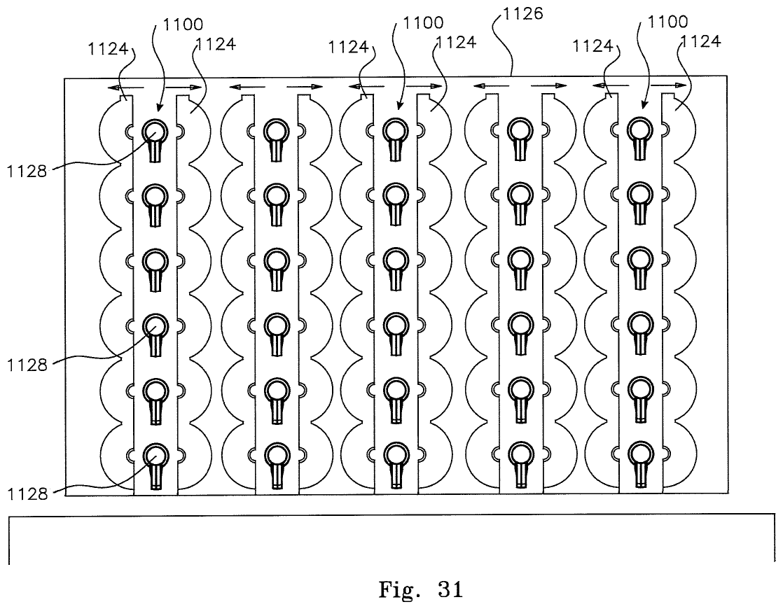

With reference to FIGS. 33, 34 and 35 there is illustrated a preform having an integral handle with a flared portion thereby to impart an ergonomic aspect to the lifting of containers blown from the preform.

Turning now to FIG. 33, in a preferred form of the preform, a preform 2100 includes a neck 2102, a body portion 2103 and a handle 2113. The neck 2102 has a threaded portion 2104 and a locating ring 2105. The preform is injection moulded from PET material in accordance with the teaching elsewhere in this specification. The handle in its configuration as injection moulded in its preform state, remains unaltered by the stretch blow-moulding process forming the resulting container from the continuous blow moulding process described elsewhere in this specification.

In order to produce the container, the preform 2100 shown in FIGS. 33 to 35, is fed into a blow moulding machine such for example as the machine 10 shown schematically in FIG. 3, and blow moulded according to bi-axial orientation blow moulding techniques. During this process the neck 2102 is held in a mandrel 322, as shown in FIG. 14 of a transport system of the machine 10 in such a way as to prevent its expansion in the stretch blow-moulding die 30.

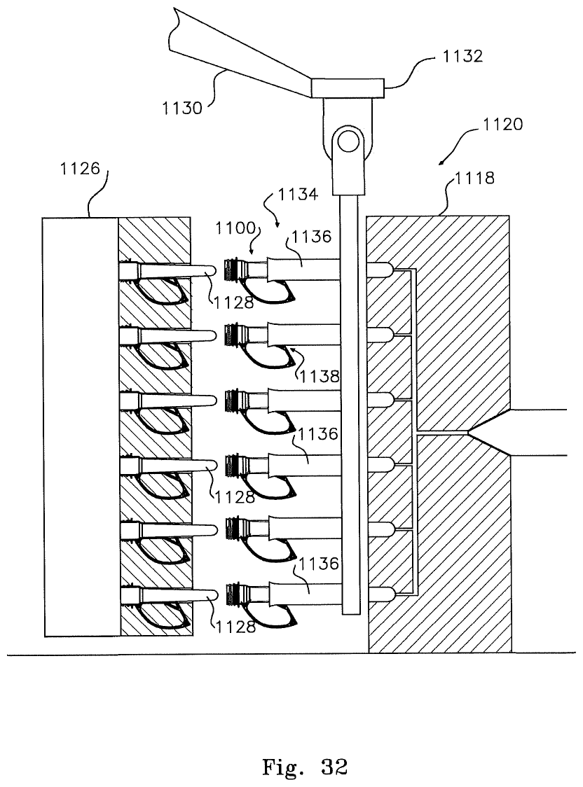

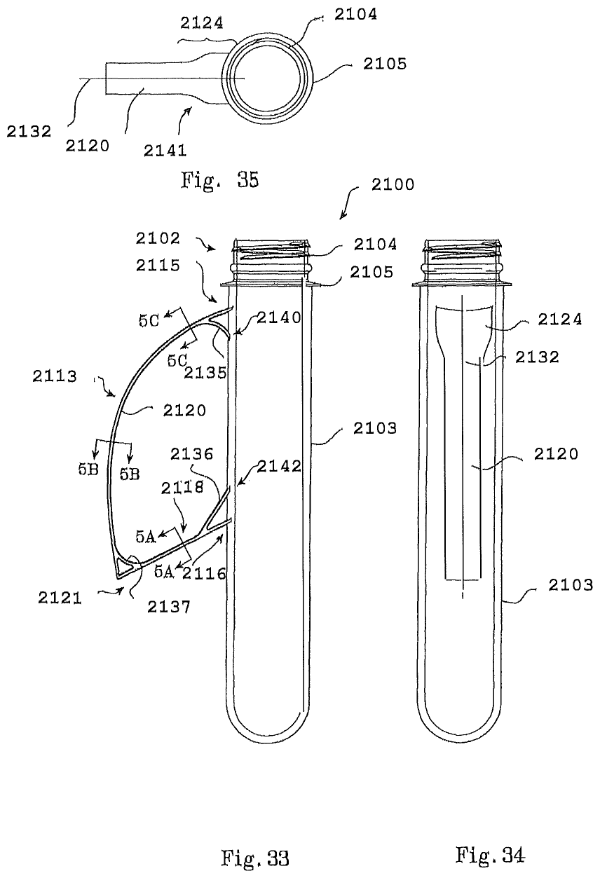

The loop of orientable material forming the handle 2113 has a generally uniform cross section from proximate the lower connection region 2116 to a gradually widening cross section 2124 approaching the upper connection region 2115 with the cross section reaching and maintaining a maximum width proximate the upper connection region 2115 as can be seen in FIGS. 34 and 35.

With reference again to FIG. 33, integrally moulded first, second and third strengthening elements 2135, 2136 and 2137 are provided respectively at each of the upper connection region 2115, the lower connection region 2116 and at the junction between the straight section 2118 and the arcuate section 2120 of the handle 2113.

The first strengthening element 2135 at the upper connection region 2115 comprises a curved strengthening element conforming generally in width and in cross section to the width and cross section of the widened portion 2124 of the handle proximate the upper connection region. The curved strengthening element extends from a first separate connection region 2140 on the body portion 2103 of the preform (and on the blown container) below the upper connection region 2115 and merges with the loop of orientable material proximate a first end 2141 of the maximum width of the handle.

The second strengthening element 2136 at the lower connection region 2116 of the handle, comprises a straight strengthening element conforming generally in width and cross section with the width and cross section of the straight section 2118. The straight strengthening element extends from a second separate connection region 2142 above the lower connection region 2116 of the straight section of the handle, to merge with the straight section of the handle proximate the lower connection region.

The third strengthening element 2137 at the junction of the straight section 2118 and the arcuate section 2120 of the handle, comprises a further curved strengthening element conforming generally in width and cross section with the width and cross section of the handle of both the straight section 2118 and the arcuate section 2120 adjacent the junction. Respective outer ends of this further curved element merge with each of the straight 2118 and arcuate 2120 sections.

It should be noted that, in this instance, the width of the first strengthening element 2135 is the same as that of the maximum width of the widened part 2124 of the handle proximate the upper connection region 2115. It is this increased width of the first strengthening element 2135 which provides for a larger area for distributing the load of a container over the index finger of a hand (not shown) lifting the container, while the curvature of the first strengthening element is selected to fit comfortably on the average index finger of a human hand.

Preferably, each strengthening element 2135, 2136 and 2137 includes a web of orientable material within boundaries formed respectively between the body portion 2112 of the preform and the first and second strengthening elements 2135 and 2136, and between the third strengthening element 2137 and the straight and arcuate sections 2118 and 2120. Each web of orientable material is aligned with and extends equally in both directions from the central line 2132 of handle. In preferred forms the preform of the eighth embodiment is produced by an injection moulding process as described earlier in this specification. In preferred forms the preform thus produced is reheated and blown on a continuously rotating, non-symmetric preform feed, stretch-blow-moulding machine as described earlier in this specification.

### Ninth Preferred Non-Symmetrical Preform Embodiment

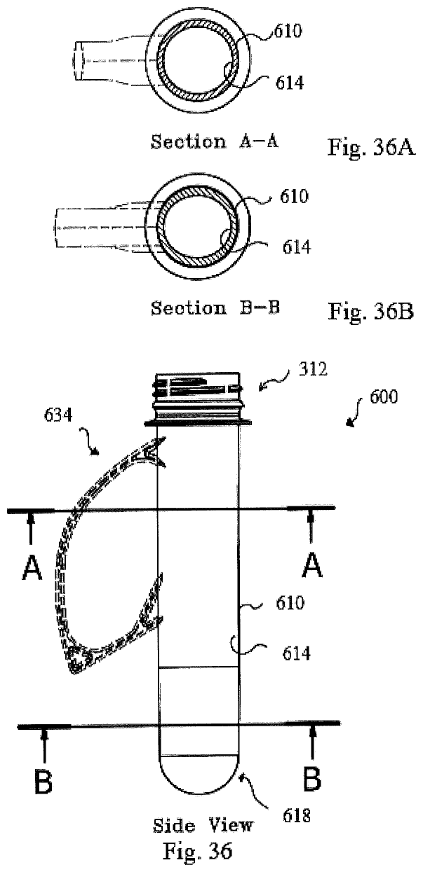

With reference to FIG. 36 there is illustrated a ninth embodiment of the preform showing alternative cross section arrangements for the purpose of reducing volume of the preform. In this instance like components are numbered as for the fourth embodiment with reference to FIG. 21. In this instance the cross section wall profile as shown in section AA and section BB is rotated 90 degrees as compared with the wall profile of FIG. 21. In preferred forms the preform of the ninth embodiment is produced by an injection moulding process as described earlier in this specification. In preferred forms the preform thus produced is reheated and blown on a continuously rotating, non-symmetric preform feed, stretch-blow-moulding machine as described earlier in this specification.

### Tenth Preferred Non-Symmetrical Preform Embodiment

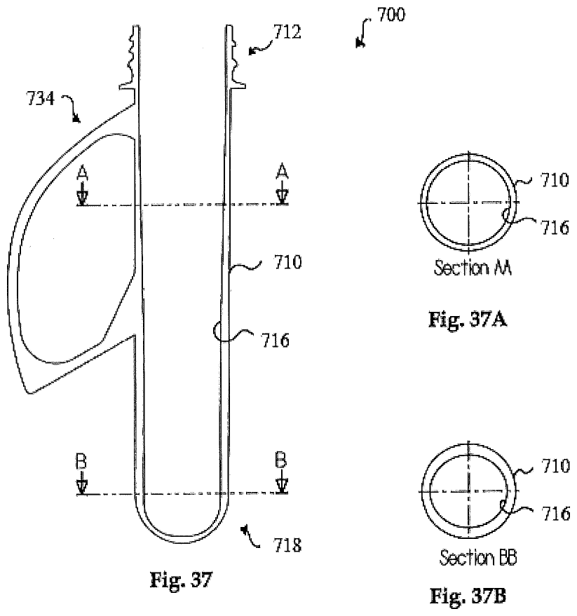

With reference to FIG. 37 there is illustrated a tenth embodiment of the preform showing alternative cross section arrangements for the purpose of reducing volume of the preform. In this instance like components are numbered as for the fifth embodiment with reference to FIG. 22. In this instance the cross section wall profile as shown in section AA and section BB is rotated 90 degrees as compared with the wall profile of FIG. 22. In preferred forms the preform of the tenth embodiment is produced by an injection moulding process as described earlier in this specification. In preferred forms the preform thus produced is reheated and blown on a continuously rotating, non-symmetric preform feed, stretch-blow-moulding machine as described earlier in this specification.

### Differential Wall Thickness System

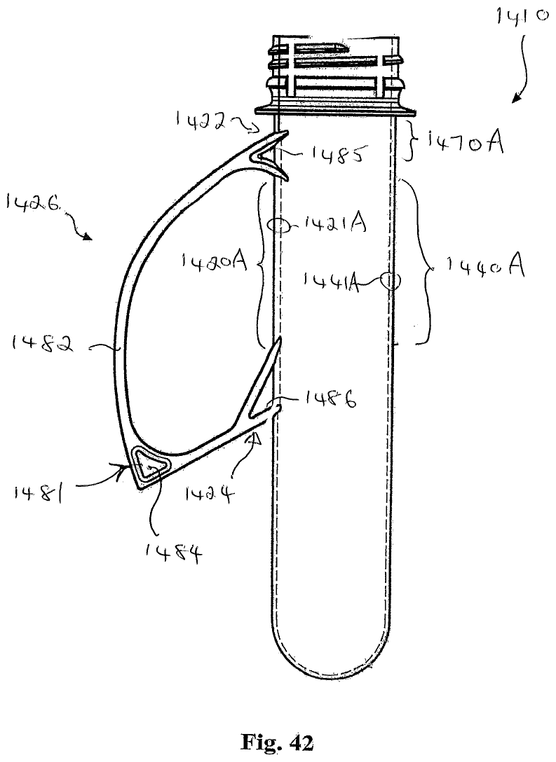

With reference to FIG. 42, there is illustrated a preform 1010 injection moulded entirely from PET plastics. In this instance, the preform includes an integral PET handle 1426 in this instance connected at least at an upper connection point 1422. In this particular instance, the handle 1426 is also connected at a lower connection point 1424.

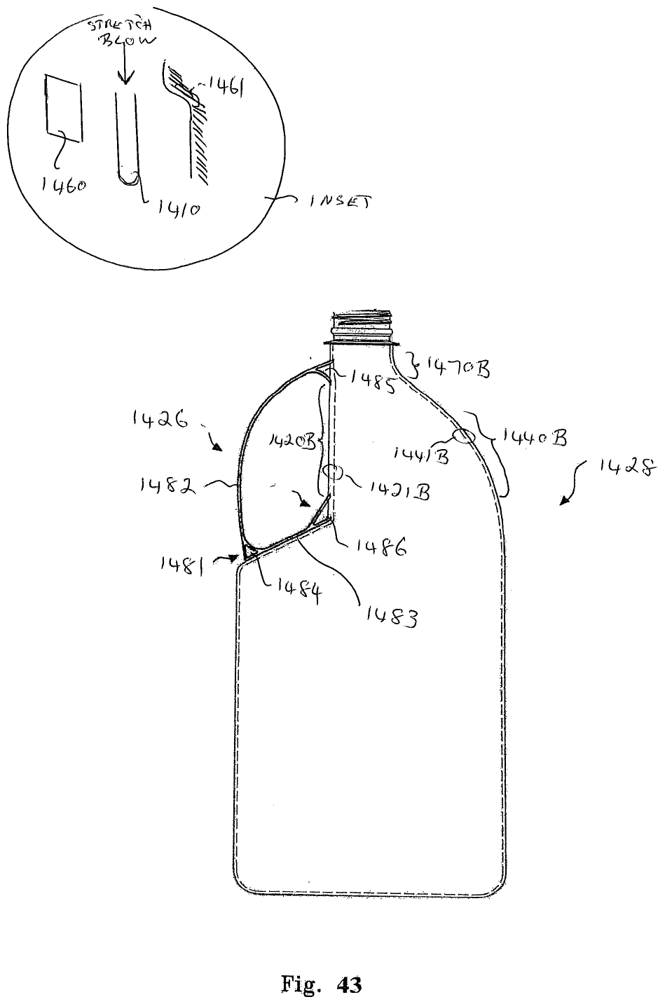

As for previous embodiments, the wall thickness of the preform may be differentiated throughout the preform in order to achieve particular end wall thicknesses of the container 1428 blown there from—see FIG. 43.

In particular, the wall thickness 1421A in the region of the preform 1420A located beneath the handle 1426 and on the side of the preform closest to the handle 1426 may be differentiated from the wall thickness 1441A in a region 1440A located on an opposite side of the perform from the region 1420A. The intention is to control preform wall thickness so that the wall thickness of corresponding locations on the blown container 1428 is such that the wall thickness 1421B in the region of the container 1420B located beneath the handle 1426 and on the side of the container closest to the handle 1426 may be differentiated from the wall thickness 1441B in a region 1440B located on an opposite side of the container 1428 from the region 1420B.

The resultant differentiated wall thicknesses in the blown container may be achieved by selection of wall thicknesses in the preform 1410. In an alternative form, the resultant differentiated wall thicknesses in the blown container may be achieved by selective movement of the PET in the walls during the stretch blow moulding process. In particular forms, both methodologies may be used together.

In a particular form, the region 1420B is blown against a substantially planar inside wall 1460 of the blow mould 1461 (see inset of FIG. 43) such that the region 1420B itself constitutes a substantially planar region.

In a particular preferred form, the upper connection point 1422 is located on a non-expanding region 1470A of the preform corresponding to a substantially non-expanding region 1470B of the resultant blow container 1428.

In a particular preferred form where the lower end of the integral handle 1426 is integrally connected to the preform at lower connection point 1424, the lower connection point is connected to the substantially planar region of the blown container 1410.

In this embodiment of the preform and container blown there from with reference to FIGS. 42 and 43 a region of the wall of the blown container is differentiated in thickness by an increased loading of material in the region from the reduced wall thickness diametrically opposite the handle. The region 1420B may be substantially planar.

In a particular form, the rigid handle 1426 and the substantially planar region form an interconnected rigid structure whereby flex of the handle 1426 in use relative to the container 1428 is resisted. This feature may be particularly advantageous for larger volume containers 1428—for example four litre containers where the weight of the liquid in the container may be substantial.

In one form during the stretch blow moulding operation the region 1420A/1420B remains substantially stable, with regions laterally on either side of the region subjected to bilateral stretching.

A PET container stretch blow-moulded from a preform; the preform and the container having a neck portion and a body portion to which is integrally connected a PET handle; the PET handle comprising an elongate portion of PET material integrally connected at least at a first connection point on a body portion of the preform and on the container; wherein a region in the form of a planar region is located on the container opposite the handle; the planar region differentiated in thickness from thickness of a wall of the container on a side opposite from that of the handle.

Preferably the handle and the planar region form a solid mass thereby to maintain the integral connection between the handle and the blown container.

Preferably the integral handle comprises a stem.

Preferably the PET handle is connected at a second connection point to the container.

Preferably the first connection point is an upper connection point.

Preferably the second connection point is a lower connection point.

Preferably the preform has an expandable portion located below the neck portion.

Preferably the region of the preform body defined by the substantially planar region between the two attachment points remains substantially stable during the stretching and blowing of the container.

Preferably the PET handle is formed in the same mould as and at the same time as the preform is moulded.

Preferably loading of plastics material in the region of the wall 1420A/1420B subtended between the upper connect point and lower connection point is differentially controlled as a function of location on the circumference of the wall in this region; the region designated the differential loading region.

Preferably there is an increased loading of material in the region immediately between the first location and the second location points whilst, an opposite region located diametrically opposite the differential loading region is reduced in material thickness.

Preferably differential material loading as a function of circumferential position on walls of the preform aids in providing control over the wall thickness of the blown container.

Preferably the stretch blow molding process is a two stage stretch blow molding process.

Preferably the differential loading region subtended between the first location and the second location remains substantially unchanged during the blowing process.

Preferably the differential loading region is an extension of and part of the neck portion of the preform.

### Bifurcated Strengthening System

With reference to FIGS. 42 and 43 and the differential wall thickness system embodiment described above a further feature may be added to the integral handle of that embodiment to further strengthen its connection to the body of the container 1428.

In this embodiment as shown in FIGS. 42 and 43, the handle 1426 includes a curved strengthening element 1481 at a lower end of the handle. In one instance, the strengthening element 1481 is located at the junction between the arcuate section 1482 and the straight sections of the handle 1483. In this region the orientable plastic material is bifurcated to form an enclosing, generally triangular element 1484 which may include a central web of conforming generally triangular shape.

Similar bifurcated and preferably webbed strengthening elements 1485 and 1486 may be provided at each of the upper and lower connection regions.

The combination of the connection to the substantially planar region 1420A, 1420B with the strengthening elements 1485 and 1486 provides a closed rigid structure imparting confidence to the user, particularly when the container is of relatively large volume.

### Notes on the Handle

In preferred forms the integral handle of the preform is not substantially deformed or substantially changed in shape during the stretch-blow-moulding process but substantially retains its as-injection-moulded shape. The blow-moulding cavity shown in FIG. 10 includes a recess specifically shaped to the form of the handle as injection moulded. This it will be understood is also a primary function of the heat shield to protect the handle from heat which could cause distortion of the handle while the preform is transported around the preheating stage of the machine.

### Injection Moulding of Preforms

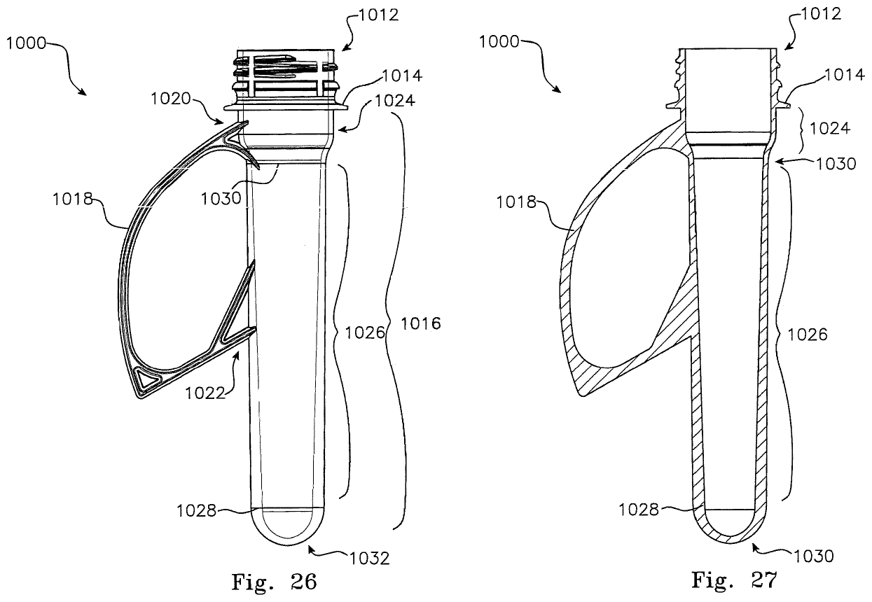

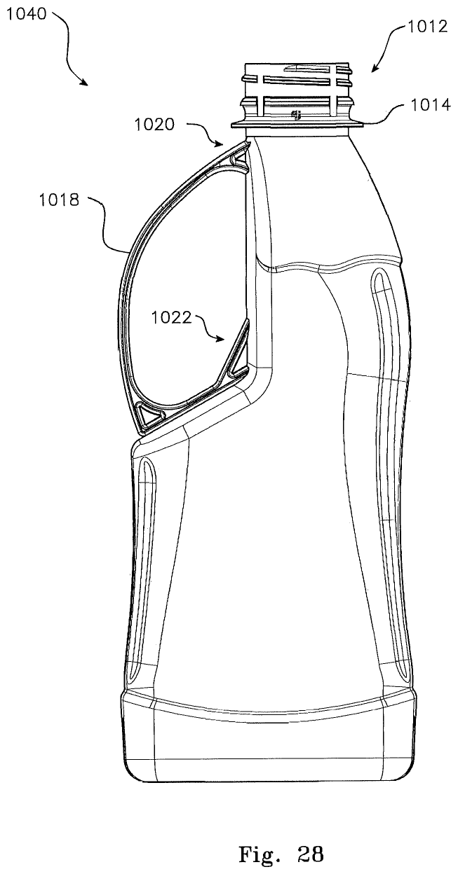

A preferred system of injection moulding any one of the above described preforms will now be described with reference to FIGS. 29 to 31. As noted elsewhere, the integral, double connect handles of the containers which are stretch-blow-moulded from the preforms, introduce considerable complexity in the design and operation of the injection moulding tooling.

Typically, in the injection moulding of preforms for symmetrical or non-handled containers, the bodies of the preforms below the neck are formed in cavities in the “hot”, fixed section of the injection moulding die, with the threaded neck portions formed in opposing half cavities carried on the face of the moving die section. After a mould cycle, when the die opens, the bodies of the preforms are drawn out of their cavities by the necks which, at this first opening stage, are retained in the still closed opposing half cavities and move with the opening die section. The opposing half cavities now part to release the necks and a stripper plate is activated to force the preforms off the cores (which are fixed to the moving die section).

With reference now to FIGS. 29 to 31, for preforms 1100 with handles 1112, only that section 1114 below the handle can be formed in cavities 1116 in the heated, fixed section 1118 of the die 1120, with the neck 1122 and handle 1112 formed in much longer and more complex opposing half cavities 1124 carried on the moving die section 1126. Again, the cores 1128 to form the internal shape of the preforms 1100 are fixed to the moving die section 1126 and are located on the common axis of the cavities 1116 in the heated fixed side of the die and the opposing half cavities.

In contrast to the demoulding of symmetrical preforms, the bodies of which are exposed to air immediately the die opens, a much larger section of the preforms of the present invention is retained in the opposing half cavities 1124 and therefore require a longer delay before preforms have cooled and are sufficiently stable for stripping off the cores 1128. This adds considerably to the mould cycle time for preforms with handles.

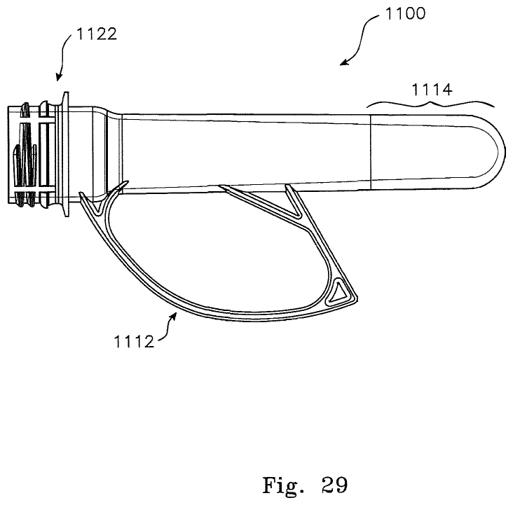

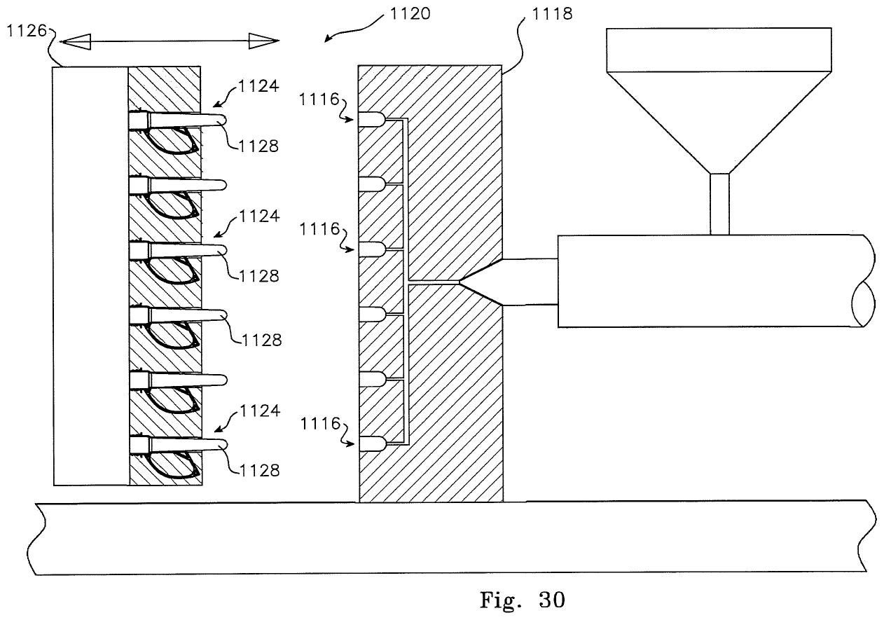

In order to reduce cycle time and thus increase production, in the system of the present invention referring now to FIG. 32, a robot 1130 (only a portion of the arm of which is shown in FIG. 32) is employed in the demoulding of the preforms 1100. The robot arm end effector 1132 is fitted with an array 1134 of vacuum cups 1136, equal in number and spaced according to the number and spacing of the cavities in the injection moulding die as shown in FIG. 31. Towards the end of a mould cycle this array 1134 of vacuum cups is poised above (or to the side of) the injection moulding die 1120 and as soon as the die opens sufficiently to allow insertion of the array, the robot brings the array into registered position between the parted sections 1118 and 1126 of the die, and advances the vacuum cups 1136 to fit over the lower ends of the preforms.

It is important for correct extraction of the preforms that the handles remain aligned in their as-moulded orientation to prevent rotation of the handles into positions at which they may be caught on edges of the opposing cavity halves. For this reason the vacuum cups are provided with a slot or channel 138 at their outer ends which slides around the lower end of the handle. By this means also a larger portion of the preform is covered by the vacuum cup. Vacuum is now applied to the cups 1136 and the robot retracts the array 1134, and the preforms 1100 now secured by vacuum pressure in the cups, to draw the preforms off the cores. Once free of the cores the array of vacuum cups and retained preforms are withdrawn from between the heated fixed section 1118 and the moving side 1126 of the die, and rotated so that the axes of the preforms are in a substantially vertical orientation. Vacuum pressure is then cut allowing the preforms to fall from the vacuum cups into a receiving bin.

The advantage of the use of vacuum in the demoulding process rather than a conventional stripper plate, is that the application of vacuum aids significantly to the cooling of the preforms, thus allowing their extraction at an earlier point in the mould cycle and shortening that cycle. This is particularly beneficial for the preforms of the present invention in which the end below the handle, being the last part of the preform to be formed (injection proceeding from the tip of the closed end of the preform), is at the highest temperature when the die opens. Additionally the slot or channel which accommodates the lower part of the handle, provides for a greater portion of the preform to be subjected to the cooling provided by air flow into the suction cups when vacuum is applied just before suction cups fully envelop the lower and mid portions of the preforms.

The cooling proceeds further as the robot draws the array of vacuum cups and preforms away from the die and over a receiving bin. The array is then rotated from the initial as-removed from the die position, that is with the axes of the preforms horizontal, to the vertical allowing the preforms to fall out of the cups when vacuum pressure is cut, and into the receiving bin.

### Single Connect Integral Handle of PET Container and Method of Production

PET polymer is an expensive material from which to produce what are in the main, single use bottles. There are of course well-known advantages of PET; firstly in the clarity of the material allowing clear viewing of a container's contents and, secondly, that the material lends itself to recycling. However, it is not possible, or at least very complicated to provide an integral handle in a PET stretch blow-moulded container such as the handle provided by forming around a hole in the side of the bottle as commonly provided in HDPE containers.

As well as its aesthetic appeal, PET containers provided with an integral handle would add a desirable feature in ease of manipulating the container. Some solutions are known in which a separately injection moulded handle is positioned in the stretch blow-moulding cavity and the container blown so that the ends of the handle are captured by material flowing around them, such as disclosed in JP2010-274967. But these arrangements are complicated and difficult in practice.

As best seen in FIG. 1, to provide the strength needed for a secure connection of the loop of the handle 26 to the container 28 of FIG. 43, a considerable volume of polymer is expended in the bracing structures at the upper and lower connection areas 22, 24 and at the intersection 30 of the arcuate portion 32 of the handle with the straight lower part 34.

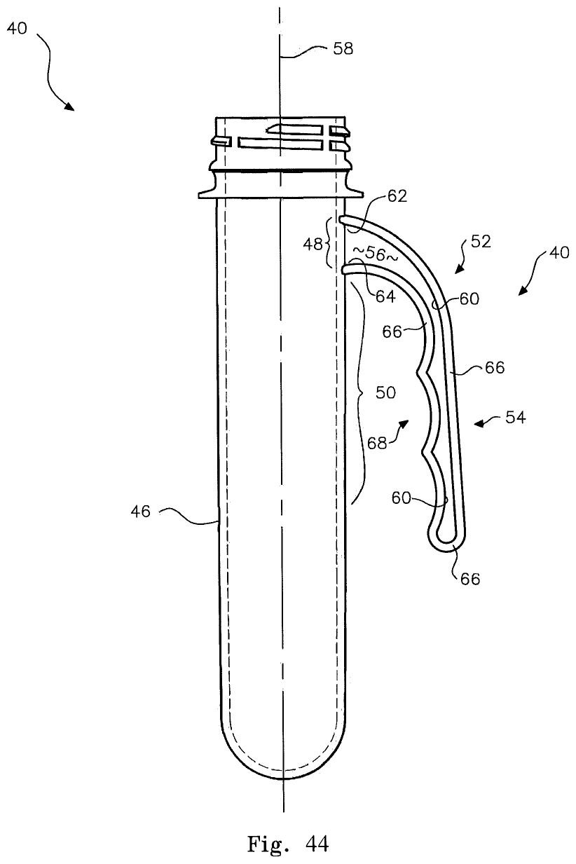

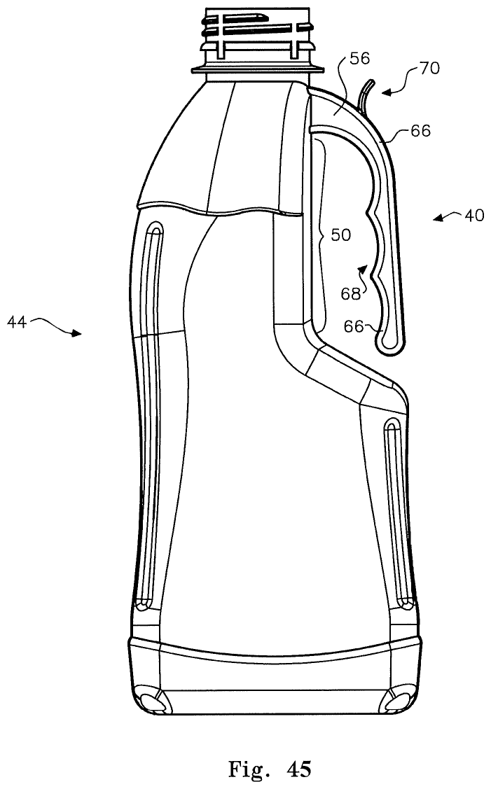

Turning now to FIGS. 44 and 45, the integral handle 40 of the preform 42 and of the container 44 of the present invention, is connected to the cylindrical body portion 46 of the preform. It will be noted that, in this form of the handle 40, it has been found there is no need for an increased thickness of the wall in the connection region 48 or in the region 50 extending below the connection region, so that in effect the wall thickness of the cylindrical body portion 46 of the preform, is uniform. Again, that uniform wall thickness is carried over into the container 44 of FIG. 4, blown from the preform of FIG. 44.

In this instance, the handle 40 includes and upper arcuate portion 52 extending from the single connection region 48 which transitions into a substantially straight, downwardly projecting portion 54. The handle 40 comprises of a central web 56 lying in a plane passing through the centreline 58 of the body portion of the preform. The web 56 is bounded by a continuous edge 60 around the periphery of the web from an upper junction point 62 to a lower junction point 64 on the body portion 46 of the preform.

The handle 40 is further comprised of a rib 66, normal to the web 56 which extends along the edge 60. The rib 66 projects outwardly and symmetrically from both sides of the plane so that in effect the web 56 and the rib 66 form an I-beam like cross section. The upper and lower cross sections of the rib 66 extend to meld with the surfaces of both the preform and of the container. These areas of the rib and of the central web combine to provide the strength of connection of the handle with the container required for manipulating a filled container.

In some preferred embodiments, the inward facing sections 68 of both the web 56 and the rib 66 are provided with one or more scallops configured to aid the gripping of the handle by a user. Also preferably in some embodiments, the handle may additionally be provided with a thumb support 70 as that shown on the container of FIG. 45, projecting from an upper portion of the rib.

By means of the handle 40 connected at a single connection region on both the body portion of the preform and on the body of the container stretch blow-moulded from the preform, significant savings in PET polymer are achieved over the double connect handle of the prior art. This has allowed the reduction in wall thickness in the region of connection of the handle so that in both the preform and the container, the wall thickness in the region of the handle connection is substantially equal to the wall thicknesses of adjacent regions.

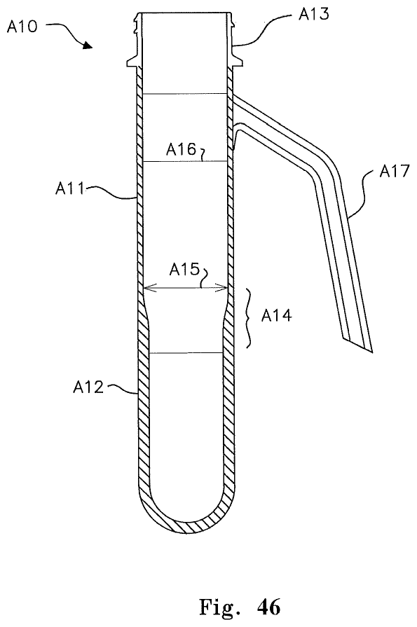

FIG. 46 is a side section view of a further example of a preform with a handle attached at a single point with an alternative variable wall profile.

In this instance the preform A10 has side walls having a first relatively thin thickness A11 near the neck end of the preform and having a second relatively thick thickness A12 near a lower end of the preform furthest from the neck A13.

In this instance the first relatively thin thickness wall transitions to the relatively thick thickness wall by way of a transition zone A14 as illustrated in FIG. 46.

In this instance the inside wall diameter A15 reduces as a function of the length of the preform, reducing progressively away from the neck A13 thereby to create the wall thickness of the transition zone A14 and the relatively thick thickness wall A12.

In this instance the outside wall diameter A16 either remains relatively constant as a function of the length of the preform or, in alternative version, increases slightly as a function of length away the neck A13.

The end result is a preform having a relatively thick wall thickness furthest away from the neck. In a preferred form, this provides increased material for stretch blowing to form a relatively enlarged volume of a blown container blown from the preform A10. The rationale for the location of wall thickening in a preform intended for stretch blowing as part of a two stage stretch blowing process or system is described in the technical literature—see for example Plastic Blow Molding Handbook by N.C. Lee published Springer Netherlands 31 May 1990—in particular pages 101 to 107 thereof.

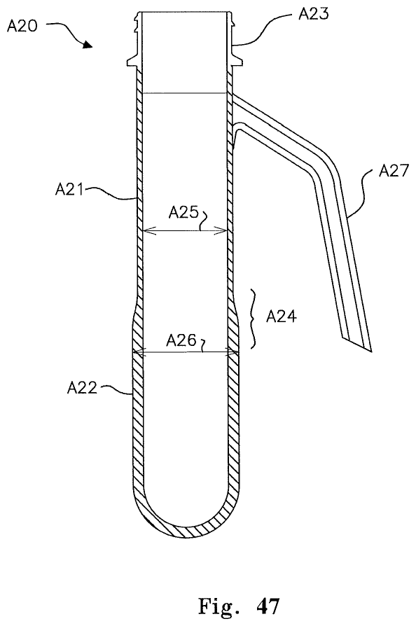

FIG. 47 is a side section view of a further example of a preform with a handle attached at a single point with an alternative variable wall profile.

In this instance the preform A20 has side walls having a first relatively thin thickness A21 near the neck end of the preform and having a second relatively thick thickness A22 near a lower end of the preform furthest from the neck A23.

In this instance the first relatively thin thickness wall transitions to the relatively thick thickness wall by way of a transition zone A24 as illustrated in FIG. 47.

In this instance the inside wall diameter A25 either remains relatively constant as a function of the length of the preform or, in alternative version, increases slightly as a function of length away the neck A23.

In this instance the outside wall diameter A26 increases as a function of the length of the preform, increasing progressively away from the neck A23 thereby to create the wall thickness of the transition zone A24 and the relatively thick thickness wall A22.

The end result is a preform having a relatively thick wall thickness furthest away from the neck. In a preferred form, this provides increased material for stretch blowing to form a relatively enlarged volume of a blown container blown from the preform A10. The rationale for the location of wall thickening in a preform intended for stretch blowing as part of a two stage stretch blowing process or system is described in the technical literature—see for example Plastic Blow Molding Handbook by N.C. Lee published Springer Netherlands 31 May 1990—in particular pages 101 to 107 thereof.

In the instance of single connect handle A17, A27 illustrated in FIGS. 46 and 47 the single connect located higher up on the preform near the neck A13, A23 allows for more flexibility in wall thickness design and optimum use of PET material as described earlier.

### Preform Distortion Control and Method

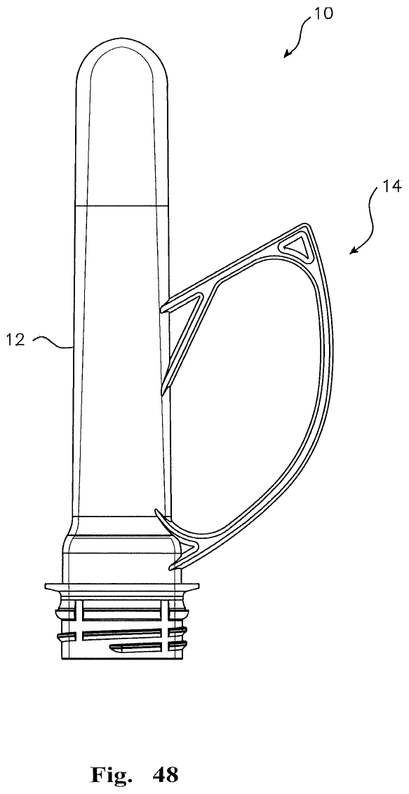

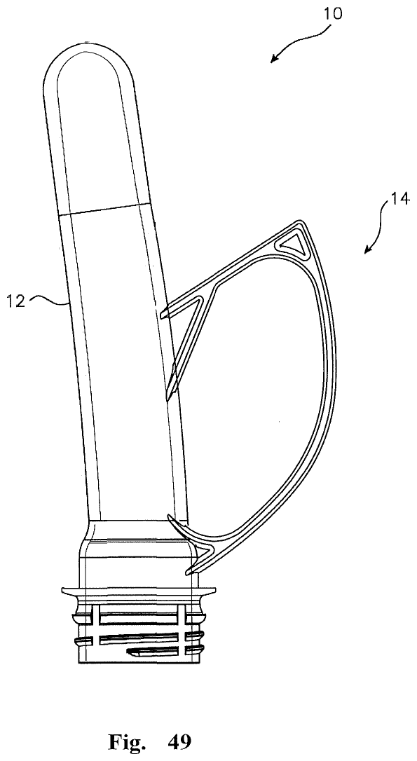

FIGS. 48 and 49 show an injection moulded preform 10 with an integrally connected, in this instance a double-connected handle 12, as initially injection moulded and distorted subsequent to passage through a preheating conditioning stage of a stretch blow-moulding machine. As can be seen in FIG. 49, substantial distortion of the preform may occur due to the asymmetry of the preform introduced by the integrally connected handle. The bending of the body portion 14 of the preform pulls the handle out of its as injection moulded position.

Within limits, the distortion of the cylindrical body 12 of the preform is not of major concern, as long as the stretch rod's movement is not impaired. However, in the stretch blow-moulding of preforms with integral handles, the handles must not be distorted to an extent where they cannot be properly inserted into the pockets in the stretch blow-moulding die intended to maintain their configuration during the stretch blow-moulding cycle.

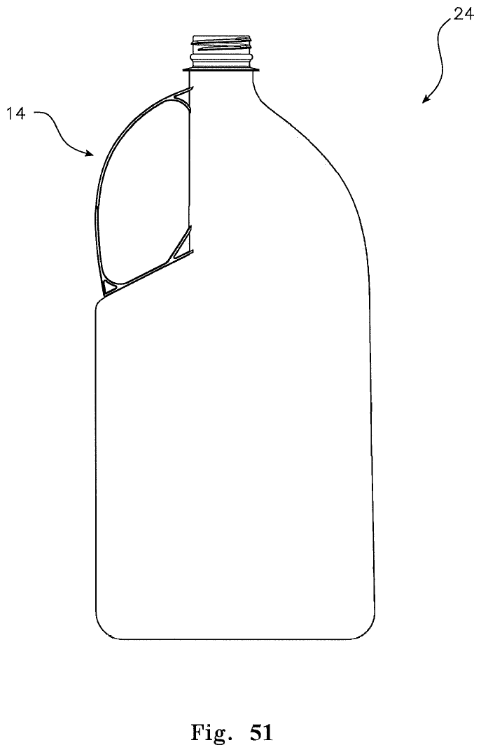

To produce a stretch blow-moulded container such as shown in FIG. 51, in which the handle has a desired configuration, it is necessary to firstly reduce the distortion to within a manageable minimum range, and secondly, to adapt the stretch blow-moulding die to accommodate distortions within this minimum range.

In a preferred embodiment of the invention, a minimum range of distortions is established by repeated test runs of passing injection moulded preforms 10 through the conditioning stage of the machine with carefully controlled and adjusted parameters. These parameters may include the settings and disposition of heating elements, the temperature gradients at various locations, time of passage and rotation of preforms etc. These test runs will establish a repeatable minimum range of distortions for a given set of parameters around which strategies for controlling the distortion of the handle can be devised.

Heat shields which protect the handle from excessive heat as a preform passes through the preheating stage must be designed to accommodate a maximum distortion within the minimum distortion range.

In one arrangement, the design of the integrally connected handle of the injection moulded preform and the cavity of the preform injection moulding die may be adjusted so that, at least to some extent, the distortion induced by the conditioning stage will tend to bring the handle back towards the desired configuration for entry into the handle pockets in opposing cavities of a stretch blow-moulding die.

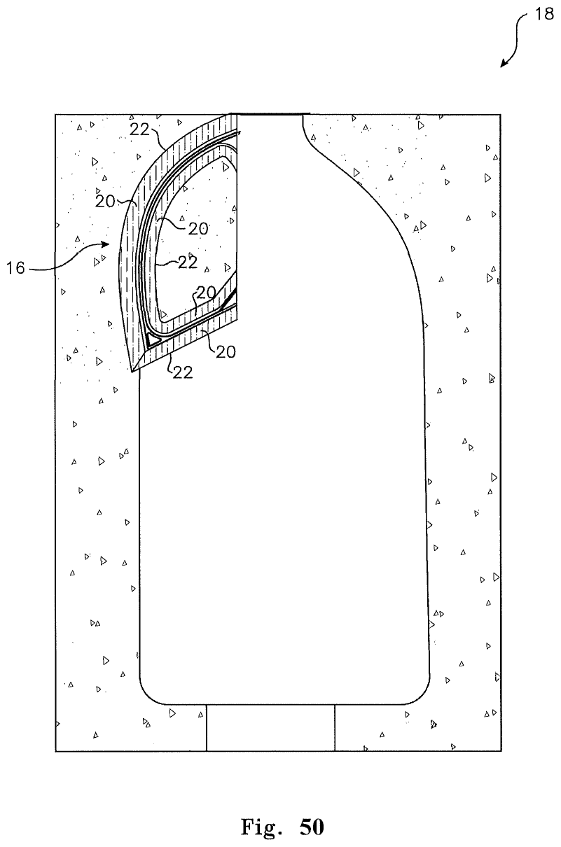

The distortion may further be accommodated by a particular shaping of the periphery of the handle accommodating pocket. As shown in FIG. 50 the handle nesting pocket 16 in each die half 18 are provided with angled lead-in surfaces 20 to guide and force a distorted handle into a proper seated position within the pocket 16. In this arrangement, the outer edges 22 of the lead-in surfaces 20 is such as to define at least a maximum distortion of the range of distortions. By these means, a container as shown in FIG. 51 can be produced with the integral handle in its correct designed disposition on the blown container.

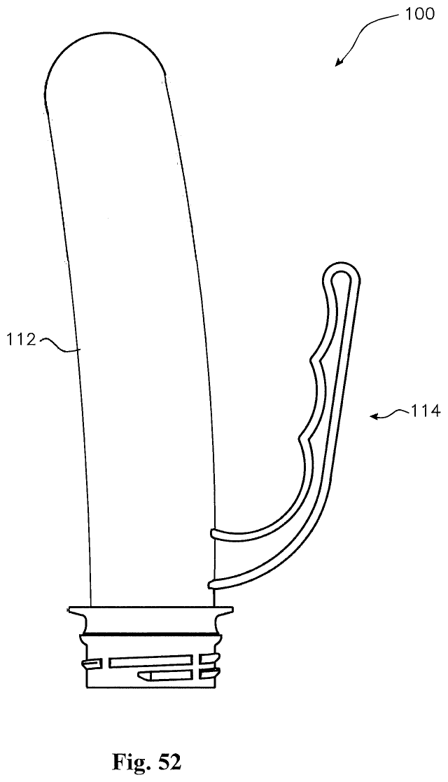

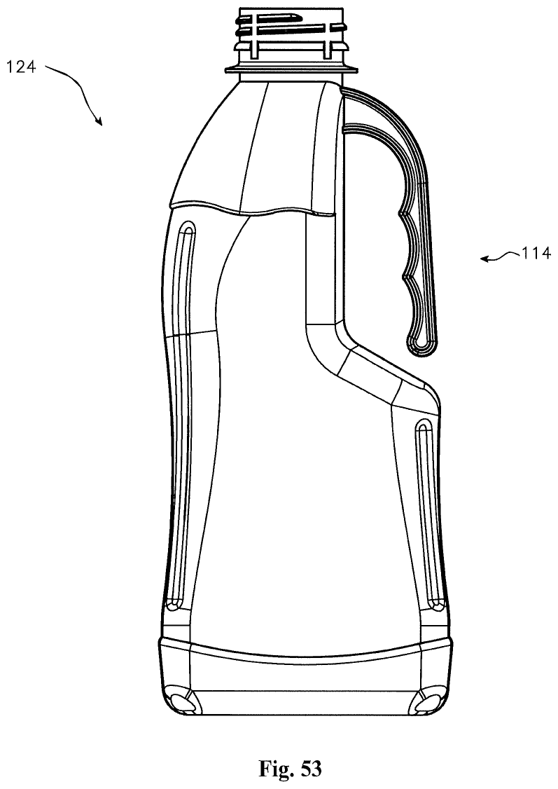

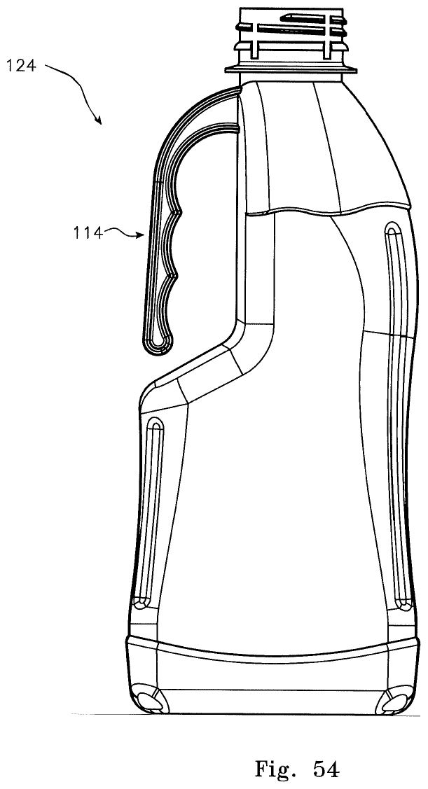

The same strategies for correcting a single-connected integral handle can be adopted as shown in FIGS. 52 and 53. As for the double-connected handle, the single-connected handle 114 of the preform 100 is distorted from its as injection moulded position by the distortion of the body 112 of the preform.

As described above, strategies for establishing a minimum range of distortions, possibly adjusting the design of the preform as well as providing special lead-in surfaces 120 for the handle nesting pocket 116 in the die halves 118 may be deployed to produce the final stretch blow-moulded container of FIG. 53.

### INDUSTRIAL APPLICABILITY

The continuous movement of previously injection moulded, non-symmetrical preforms from their initial feeding into the machine 10 through the various continuously rotating stages described above, provides a marked improvement in output and quality of containers stretch-blow-moulded from such preforms. This continuous flow from preform infeed to the outfeed of container is made possible by the unique features of the transfer systems of the machine and the control of orientation of the preform handles at each transfer, and that of the preform supporting mandrels at transfers into and away from the preheating stage.

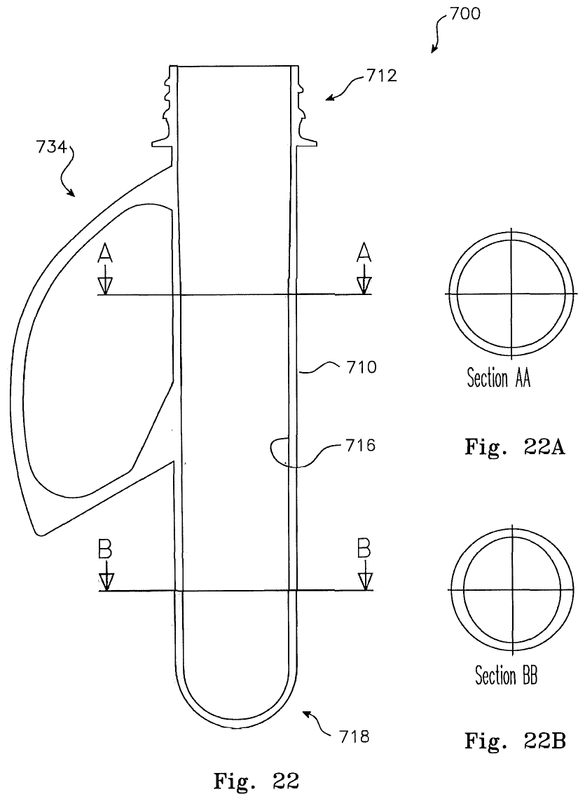

The preforms of the above described embodiments, provide for the stretch-blow-moulding of a container in the stretch-blow-moulding machine, which is equal in capacity to that of the container of the prior art shown in FIG. 25, but with a significant reduction in the volume of PET and conferring an optimum distribution of material from the preform to form the containers shown in FIGS. 17 and 18. Thus, the preforms of the invention provides for a considerable reduction in raw material costs in the production of PET containers with integral handle.

1-230. (canceled)

231. A continuous transfer system comprising containers stretch blow molded from injection molded preforms with integral handles in a continuously rotating stretch blow molding machine are fed to a filling and capping machine; and an orientation of the integral handle controlled from entry of a preform into the stretch blow molding machine to the emergence of filled and capped containers from the filling and capping machine.

232. The continuous transfer system of claim 231 further comprising a discharge channel for blown containers of the stretch blow molding machine in line with and at a same level as an infeed conveyor of the filling and capping machine.

233. The continuous transfer system of claim 231 wherein a cycle time of the filling and capping machine is synchronized with a cycle time of the stretch blow molding machine.

234. The continuous transfer system of claim 231 wherein a walking beam transport system of the filling and capping machine overlaps a discharge channel of the stretch blow molding machine; an end nest of the walking beam transport system capturing successive leading blown containers from the discharge channel for transport through the filling and capping machine.

235. The continuous transfer system of claim 231 wherein an escapement mechanism disposed along an infeed conveyor of the filling and capping machine ensures spacing of containers conforms to spacing of filling nozzles and capping mechanisms of the filling and capping machine.

236. A continuous transfer system for containers with integral handles stretch blow-molded from injection molded preforms with integral handles, comprising: the transfer system transferring the containers with a known orientation of the integral handle from a continuously rotating stretch blow-molding machine to an automatic continuously filling and capping machine; a re-orientation device intermediate a discharge channel of the stretch blow-molding machine and the automatic continuously filling and capping machine adapted to optionally reorient the containers from the known orientation to another desired orientation prior to entry into the automatic continuously filling and capping machine.

237. The system of claim 236 wherein an orientation of the integral handle is controlled from entry of a preform into the stretch blow molding machine to the emergence of filled and capped containers from the filling and capping machine.

238. The continuous transfer system of claim 236 further comprising a discharge channel for blown containers of the stretch blow molding machine in line with and at a same level as an infeed conveyor of the filling and capping machine.

239. The continuous transfer system of claim 236 wherein a cycle time of the filling and capping machine is synchronized with a cycle time of the stretch blow molding machine.

240. The continuous transfer system of claim 236 wherein a walking beam transport system of the filling and capping machine overlaps a discharge channel of the stretch blow molding machine; an end nest of the walking beam transport system capturing successive leading blown containers from the discharge channel for transport through the filling and capping machine.

241. The continuous transfer system of claim 236 further comprising an escapement mechanism disposed along an infeed conveyor of the filling and capping machine thereby ensuring spacing of containers conforms to spacing of filling nozzles and capping mechanisms of the filling and capping machine.
